(19) United States
(12) Patent Application Publication
(10) Pub. No.: US 2016/0372835 A1
(43) Pub. Date: Dec. 22, 2016

(54) IMAGING ANTENNA SYSTEMS WITH COMPENSATED OPTICAL ABERRATIONS BASED ON UNSHAPED SURFACE REFLECTORS

(71) Applicant: AGENCE SPATIALE EUROPEENNE, Paris (FR)

(72) Inventors: Giovanni Toso, Haarlem (NL); Christian Sciannella, Noordwijk (NL)

(73) Assignee: AGENCE SPATIALE EUROPEENNE, Paris (FR)

(21) Appl. No.: 15/122,257

(22) PCT Filed: Mar. 5, 2014
(86) PCT No.: PCT/IB2014/001850

§ 371 Date: Aug. 29, 2016

(51) Int. Cl. H01Q 15/16; H01Q 3/14

(52) U.S. Cl. CPC H01Q 15/16; H01Q 3/14

(57) ABSTRACT

An offset imaging antenna system with compensated optical aberrations comprises a main a paraboloid reflector, a first paraboloid sub reflector, and a first feeding array as an arrangement of first feed array elements to illuminate or to be illuminated by the first sub reflector. The main reflector and the first sub reflector are confocal by sharing a common focal point. The first feeding array has a curved shape that corresponds to a first equivalent array of magnified image feed elements lying on a plane crossing the main optical centre and perpendicular to the main bore-sight axis, all the first feed array elements being positioned as to provide a planar distribution of the positions of the image feed elements onto the first equivalent array after a second reflection by the main reflector with a central image point coinciding with the main reflector optical centre under a maximum illumination condition.

The invention relates to offset imaging antenna systems with compensated optical aberrations, able to scan a beam electronically in a limited field of view or to generate a multi-beam coverage in a limited field of view, and relates to methods for designing and manufacturing such offset imaging antenna systems.

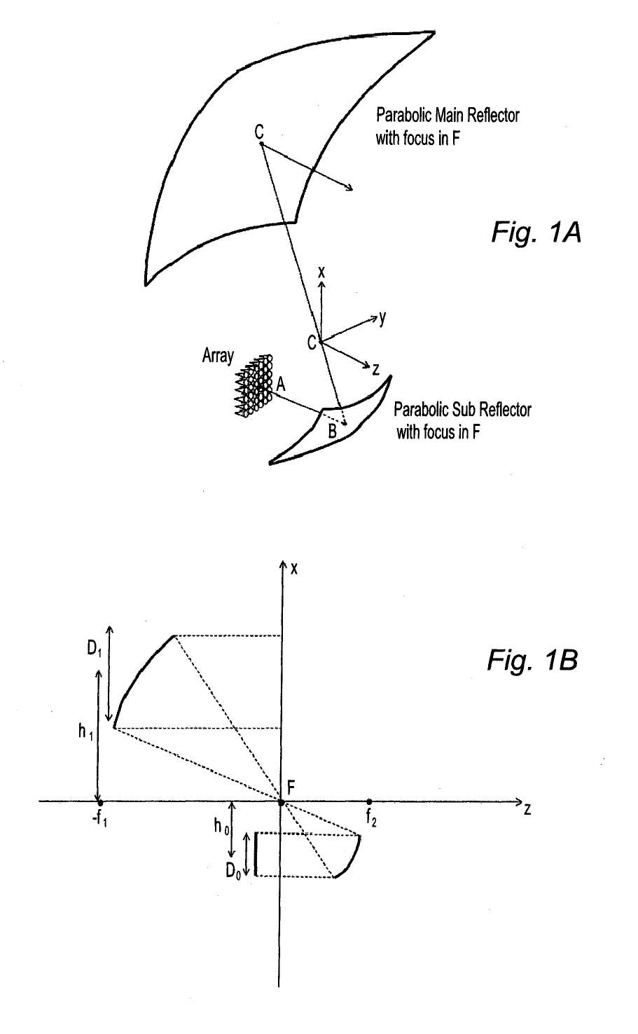

A conventional imaging system as shown in FIGS. 1 A-B has two confocal and coaxial offset parabolic reflectors fed by a planar array, and is defined in respect with a cartesian reference system. It is well known that the parabolic reflectors have the property of converting plane waves into spherical waves and vice-versa. A windowed plane wave emerging from the feeding array and intercepting the first offset paraboloid reflector is transformed into a spherical wave converging into the sub reflector focus. Since both the sub reflector and the main reflector share the same focal point, the main offset paraboloid reflector transforms a spherical wave emerging from the main reflector focus again into a magnified plane wave. C. Dragone showed in [3] that for a Gregorian dual-reflector arrangement with both reflectors being large enough to intercept all incident rays, the transversal portion of plane wave emerging from the main reflector corresponds to the transversal portion of plane wave emerging from feed array magnified M times. The magnification ratio M can be defined both as the ratio between the focal lengths of the main and sub reflectors or the ratio between the equivalent apertures, as described in FIG. 1B.

$$M = \frac{{f}_{1}}{{f}_{2}} = \frac{{D}_{1}}{{D}_{2}} \qquad ( 0.1 )$$

By choosing f₁>f₂ an enlarged image of a small phased array is produced on the main reflector aperture. As shown in [2] by Fitzgerald, in case of scanning in a limited Field Of View (FOV), the following linear expressions represent a first order approximation of the scan behaviour of the system:

$$\begin{matrix}θ = \frac{{θ}^{′}}{M} & ( 0.2 ) \\ ϕ = {ϕ}^{′} + π & ( 0.3 )\end{matrix}$$

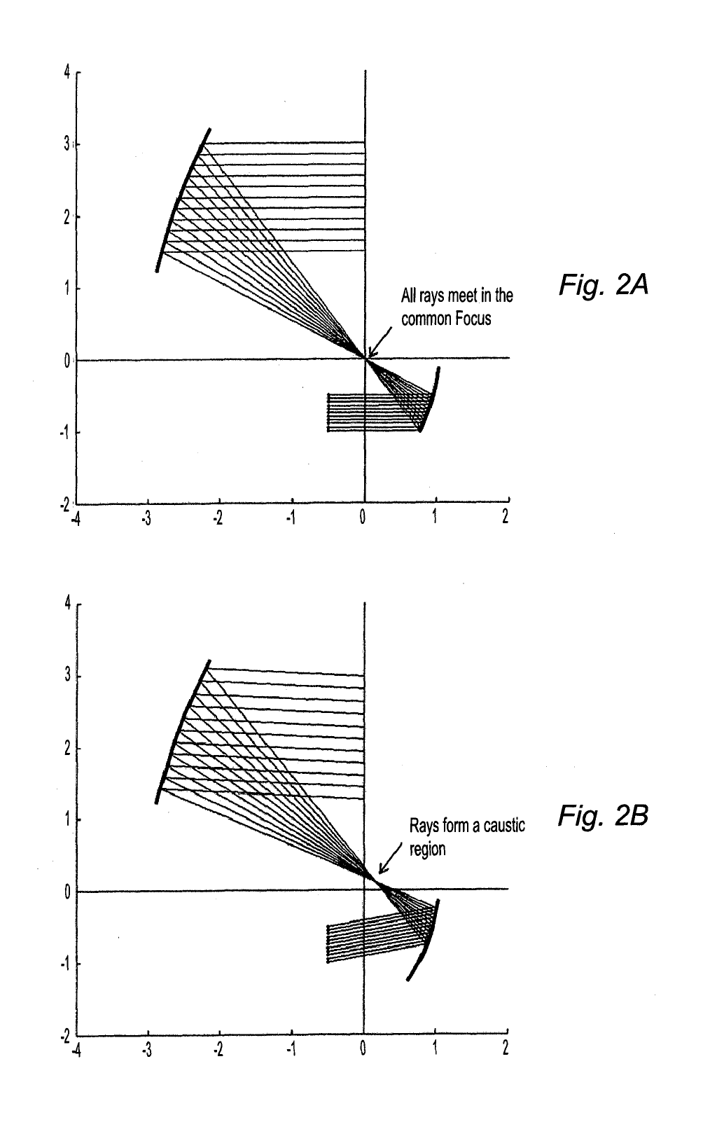

being θ′ and φ′, respectively, the elevation and azimuth angles of the beam scanned by the feeding array with respect to the boresight direction and θ and φ, respectively, the elevation and azimuth angles of the main beam radiated by the main reflector aperture towards the far field zone. In addition the produced beams result being M times narrower as compared to the beams produced by the feeding array. According to the previous equations, the entire antenna system (comprising a feeding array, a sub and a main reflector) can be approximately replaced by only one equivalent array, lying on the aperture plane of the main reflector and having all its dimensions magnified by a factor equal to M, including the feed element sizes and inter-element spacing: this is the so-called Scaled Array Analysis (SCA). The equivalent magnified array produces a pattern with a significantly increased directivity with respect to the one generated by the feeding array, while the scanning behaviour of the system can be approximately described by equations (0.2) and (0.3). The ideal magnification of the array is exact only in the limit case when the feeding array is generating a beam exactly in the boresight direction parallel to the sub reflector axis. By adopting a Geometrical Optics (GO) approximation, the quasi-planar wave produced by the feeding array can be represented in terms of linear rays, crossing the system, as show in FIGS. 2 A-B. Only the boresight condition guarantees that all rays cross the common focal point and emerge again from the main reflector towards far zone along a direction parallel to the main reflector axis as shown in FIG. 2A. An optical system satisfying this condition is called anastigmatic [4]. When scanning the system, the rays reflected by the sub reflector towards the main reflector do not perfectly focus in the focal point but generate distributed caustic curves as shown in FIG. 2B; larger the angular deviation of the ray emerging from the array plane and the boresight direction, larger the spreading of the corresponding distributed caustic and its separation from the common focus.

The main advantages offered by the offset dual-reflector geometry as compared to a symmetric (or onset) Cassegrainian architecture are:
blockage effects elimination;
forward spillover reduction.

Both of these advantages are crucial when the dual reflector feed is an extended source as a phased array. At the same time an offset fed imaging system is characterized by system asymmetries leading to aberrations. Larger scan angles lead to a strong deviation of the system scan behaviour with respect to the linear relations presented in (0.2) and (0.3).

Since the radiative performance of a magnified array antenna system deviates during the scanning from those predicted by Dragone and the SCA approach, degradation in terms of directivity, beamwidth, polarization purity and pattern shape are expected when increasing the scanning angles from the boresight direction. It has been shown in [2] that the sub reflector parabolic shape approximately compensates the phase distortions introduced by scanning the system. However a quadratic phase aberration can be revealed on the main reflector aperture when scanning the system which increases for higher scanning angles and is maximum on the dual-reflector's offset plane. This aberration leads to an asymmetric variation of the beam deviation factor (BDF) when the beam is scanned away from the boresight pointing direction. To identify the system aberrations Albertsen [1], Fitzgerald [2] and Dragone [3] have studied the system in terms of GO. Fitzgerald concludes, that the system maintains good radiative performances despite to the previously introduced phase aberrations, provided that:
the sub reflector is sufficiently oversized;
sufficient f/D ratio is maintained, fixing the magnification ratio M;
it is preferred to use an increased magnification ratio obtained by augmenting the main reflector focal length f₁ with respect to the sub reflector focal length f₂;
the system performances are nearly frequency insensitive, allowing to use a GO approximation for obtaining good performance estimations;
the optimum array feeding position is as far as possible with respect to the sub reflector and as near as possible with respect to the common reflectors' axes, as long scanning and blockage requirements are met and forward spillover is minimized.

In the past, different solutions for overcoming and compensating the scan aberrations deriving from the system geometrical asymmetry have been studied: Dragone discusses in [5] the problem of array grating lobes producing focal spots in the main reflector plane. To overcome this problem he has proposed to remove grating lobes by introducing a spatial filter between the reflected ray path between sub reflector and main reflector. Shaping both the reflectors and adjusting the amplitude and phase distributions of the feeding array can improve the scan performance of the array. Rao [6] proposes to shape both reflectors using a bi-collimated condition for producing an optimal illumination at the extremities of the antenna scan range. Pearson [7] points out the variation of the illumination function within scanning, by doing a receive mode analysis of the dual reflector antenna. Based on this analysis he has derived a sub reflector surface composed by two elliptical arcs aimed to maintain a full illumination of the main reflector throughout the entire field of view of the antenna.

Martinez-Lorenzo et al. [8] have proposed a mechanically deformable sub reflector surface of the dual-reflector imaging arrangement, where a mechanism introducing translation, rotation and focal length adjustment defines an approximate optimal surface for overcoming the quadratic aberrations which arise when the antenna beam is scanned. Pearson et al. have shown in [9] that the non-linear scan behaviour can be compensated by adjusting the phase excitations of the feed elements on the array.

Recently, Gatti et al. [10] have exploited the possibility of using one confocal dual-reflector antenna system fed by two different array configurations for realizing both transmission and receive functionalities and for using the same system at two different frequency bands. Besides, in [10], the scanning performances of an imaging system have been significantly improved by shaping both the sub and the main reflector.

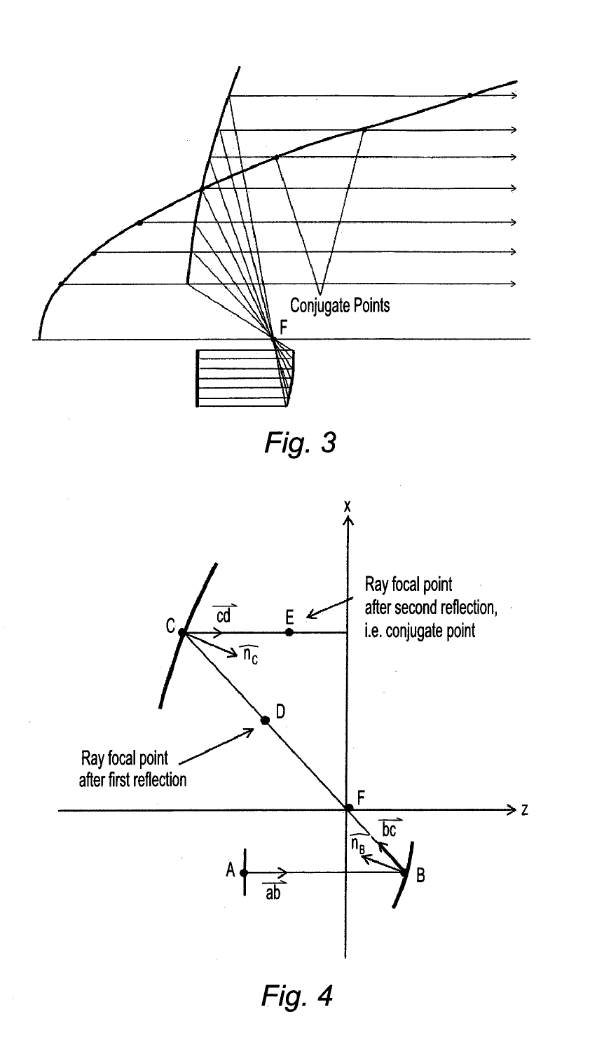

In the work done by Albertsen et al. [1] a more careful investigation with respect to the SCA analysis done by Dragone [3] has demonstrated that a planar array feeding an offset confocal dual-reflector imaging antenna is characterised by an “imaged” magnified virtual array whose elements are not located on a plane perpendicular to the axes of the two reflectors (like the SCA analysis shows) but on a parabolic surface. Adopting a GO analysis, it is possible to show that the “conjugate points” of the feed elements of a planar array lie on the parabolic surface described by the equation:

$$z = 2 ( M + 1 ) \frac{{x}^{2} + {y}^{2} - {( Md )}^{2}}{4 {f}_{1}} + \frac{{( Md )}^{2}}{4 {f}_{1}} \qquad ( 0.4 )$$

where M=f₁/f₂ is the magnification factor, d the offset distance between the centre of the array to the axis according to FIG. 3. The described parabola intersects the main reflector in its central point. A necessary condition for the validity of this equation is that the distance between the array plane and the sub reflector is selected to have the image point of the central feed element of the array coinciding with the main reflector central point (for an offset parabolic reflector characterized by a circular rim). This condition has been derived by Dragone [3] stating that ‘the centre of the main reflector and the centre of the array must be conjugate points’ to achieve maximum efficiency of illumination for the imaging system. Referring to FIG. 3, the following relation holds:

$$\overline{AB} = \overline{FB} \frac{M + 1}{M} \qquad ( 0.5 )$$

where A̅B̅ is the distance between the array centre element and the sub reflector, F̅B̅ is the radius of curvature of the sub reflector in the reflection point B and M the previously defined magnification ratio.

The fundamental RF characteristics as well as an approximation of the quadratic aberrations affecting the system during the scanning may be deduced using the theory of conjugate points by Albertsen et al. [1]. Conjugate points represent equivalent virtual feed elements relative to the real feed elements of the array illuminating the system. All phases of the virtual feeds are such to generate a beam in the axial direction if all the elements of the feeding array are in phase. In addition, the variability of the beam deviation factor during the scanning may be explained by the fact that the conjugate points are not lying on a plane orthogonal to the antenna axis but on a paraboloid.

Two additional properties can be explained by analysing the system in terms of conjugate points:

1) the absence of Grating Lobes in the directions which would be expected if the system's equivalent array would be exactly a magnified image of the feed array;
2) the quadratic aberrations affecting the imaging system when scanning a beam.

As pointed out by Albertsen et al. [1] a planar array of large elements produces Grating Lobes of high level relatively close to the on-axis beam. Vice-versa, the Grating Lobes of the imaging antenna system appear to be smeared out, so they are drastically less critical, essentially for two reasons. The first reason is linked to the fact that the magnified array is not planar but conformal. The second reason is linked to the fact that the sub reflector intercepts only a part of the grating lobes generated by the feeding array. Also quadratic beam aberrations are well justified considering a virtual magnified array whose shape is not planar but parabolic.

The main attractive features of an imaging antenna system are:
the possibility of combining a small array together with large reflecting surfaces (exploiting both the flexibility assets of a phased array and the simplicity and high gain typical of large reflectors) to replace an equivalent expensive Direct Radiating Array (DRA);
the ability of an imaging antenna to compensate for beam depointing and beam shape degradation acting at the level of the Beam Forming Network (BFN) of the small feeding array;
the possibility of mounting the antenna on a satellite's Earth Facing Panel (EFP) or side (east/west) panels providing different coverages by means of the same optics.

The technical problem solved by the invention is to propose an antenna system, able to scan a beam electronically in a limited field of view or generating a multibeam coverage in a limited field of view, together with an associated deterministic design procedure, wherein the imaging antenna system is an offset antenna where the asymmetries and the drawbacks associated to the offset configuration, and in particular the optical aberrations and asymmetries in the beamwidth in the different pointing directions, have been minimized and compensated keeping unchanged the surface of the reflectors.

To that end, the invention relates to an offset imaging antenna system with compensated optical aberrations able to scan a beam electronically in a limited field of view or to generate a multi-beam coverage in a limited field of view, and comprising
a main reflector having a paraboloid shape, a main aperture, a main optical centre, and a main bore-sight axis,
a first sub reflector having a paraboloid shape, a first sub reflector optical centre and a first sub reflector bore-sight axis,
a first feeding array to illuminate or to be illuminated by the first sub reflector comprising an arrangement of first feed array elements,
the main reflector and the first sub reflector being offset in an offset plane and confocal by sharing a common focal point (F),
characterized in that
the first feeding array has a curved shape that corresponds to a first equivalent array of first magnified image feed elements lying on a plane crossing the main optical centre and perpendicular to the main bore-sight axis,
all the first feed array elements being positioned as to provide a first planar distribution of the positions of the image feed elements onto the first equivalent array after a second reflection by the main reflector with a first central image point coinciding with the main reflector optical centre under a maximum illumination condition.

According to specific embodiments, the offset imaging antenna system comprises one or more of the following features:
the planar distribution of the positions of the image feed elements onto the first equivalent array is periodic;
the planar distribution of the positions of the image feed elements onto the first equivalent array is a distribution of a sparse array;
the main bore-sight axis and the first sub reflector bore-sight axis are parallel and opposite, and

the main focal axis, defined as the axis passing through the main optical centre point and the common focal point, and the first sub reflector focal axis, defined as the axis passing through the first sub reflector optical centre point and the common focal point, are parallel and opposite;
the main reflector has a main reference frame centered on the common focal point with

a first main axis z defined by the main bore-sight axis,

a second main axis x, contained in the plane including the main focal axis passing through the main optical centre and the common focal point, and directly perpendicular to the first main axis z,

a third main axis y defined so as the first, second, third main axis (x,y,z) form a directly oriented frame;

the first sub reflector has a first sub reflector frame centered on the common focal point with

a first sub reflector axis z′ defined by the opposite of the first sub reflector bore-sight axis,

a second first sub reflector axis x′, contained in the plane including the first sub reflector axis passing through the first sub reflector optical centre and the common focal point, and directly perpendicular to the first first sub reflector axis z′,

a third first sub reflector axis y′ defined so as the first, second, third axis first sub reflector (x′,y′,z′) form a directly oriented frame, and

while keeping the confocality between the main reflector and the first sub reflector, the main frame and the first sub reflector frame have different orientations, and the reciprocal relative orientation of the main and first sub reflector frames is determined so that the performance of the antenna is improved in terms of

increasing the symmetry of the beam gain distribution while limiting an additional scan loss over a scan range, and/or,

increasing the beam shapes stability, and/or

reducing the beam mispointing without applying phase taper on the feeding array; and/or

decrease the degree of curvature of the feeding array,

in view of a reference configuration wherein the first, second, third main axis of the main reference frame and the first, second, third first sub reflector axis of the first sub reflector frame are respectively the same;
either, departing from the reference configuration, the first sub reflector has been tilted around the third main axis y by a first elevation tilt angle φᵣ, defined as the relative angle between the first main reflector axis z and the first first sub reflector axis z′, and between the second main reflector axis x and the second first sub reflector axis x′, so that the reciprocal relative orientation of the frames is defined only by the first elevation tilt angle φᵣ; or

departing from the reference configuration, the first sub reflector (6) has been tilted around the second main axis x by a second azimuth angle σᵣ, defined as the relative angle between the first main reflector axis z and the first first sub reflector axis z′, and between the third main reflector axis y and the third first sub reflector axis y′, so that the reciprocal relative orientation of the main and first sub reflector frames is defined only by the second azimuth angle σᵣ;
either, for an assigned main reflector aperture characterized by its main aperture size, main reflector focal length and main reflector clearance, the first sub reflector is dimensioned in terms of first sub reflector focal length, first sub reflector clearance, or first sub reflector aperture size by varying the first elevation tilt angle φᵣ or the second azimuth angle σᵣ; or

for an assigned first sub reflector aperture characterized by its first sub reflector main aperture size, first sub reflector focal length and first sub reflector clearance, the main reflector is dimensioned in terms of main reflector focal length, main reflector clearance, or main reflector aperture size by varying the first elevation tilt angle φᵣ or the second azimuth angle σᵣ;
departing from the reference configuration the first sub reflector has been firstly tilted around the third main axis y by a third elevation angle φᵣ defined as the relative angle between the second main reflector axis x and the second first sub reflector axis x′, and

successively tilted around the second main axis x by a fourth azimuth angle σᵣ, defined as the relative angle between the third main reflector axis y and the third first sub reflector axis y′,

so that the reciprocal relative orientation of the main reflector frame and the first sub reflector frame is defined by the third elevation angle φᵣ and the fourth azimuth angle σᵣ;
the offset Imaging antenna system defined here above comprises further at least

one second feeding array to illuminate or to be illuminated by the first sub reflector comprising an arrangement of second feed array elements,

the main reflector, the first sub reflector being offset and confocal by sharing a common focal point F,

the second feeding array having a curved shape that corresponds to a second equivalent array of a second magnified image feed elements lying on a plane crossing the main optical centre and perpendicular to the main bore-sight axis,

all the second feed array elements being positioned as to provide a second planar distribution of the positions of the second image feed elements onto the second equivalent array after a second reflection by the main reflector with a second central image point coinciding with the main reflector optical centre under a maximum illumination condition;
the first sub reflector and the first feed array are configured for transmitting at a first frequency, and

the first sub reflector and the second feed array are configured for receiving at a second frequency.
the offset Imaging antenna system defined here above comprises further at least

one second sub reflector having a paraboloid shape, a second sub reflector optical centre and a second sub reflector bore-sight axis,

one second feeding array to illuminate or to be illuminated by the second sub reflector comprising an arrangement of second feed array elements,

the main reflector, the first sub reflector, the at least one second sub-reflector being offset and confocal by sharing a common focal point F,

the second feeding array having a curved shape that corresponds to a second equivalent array of a second magnified image feed elements lying on a plane crossing the main optical centre and perpendicular to the main bore-sight axis,

all the second feed array elements being positioned as to provide a second planar distribution of the positions of the second image feed elements onto the second equivalent array after a second reflection by the main reflector with a second central image point coinciding with the main reflector optical centre under a maximum illumination condition;
the second planar distribution of the positions of the second image feed elements onto the second equivalent array is periodic, or

the second planar distribution of the positions of the second image feed elements onto the second equivalent array is a distribution of a sparse array;
the second sub reflector has a second sub reflector frame centered on the common focal point with

a first second sub reflector axis z′₂ defined by the opposite of the second sub reflector bore-sight axis,

a second second sub reflector axis x′₂, contained in the plane including the second sub reflector axis passing through the second sub reflector optical centre and the common focal point, and directly perpendicular to the first second sub reflector axis z′₂,

a third second sub reflector axis y′₂ defined so as the first, second, third second sub reflector axis (x′₂,y′₂,z′₂) form a directly oriented frame, and

while keeping the confocality between the main reflector, the first sub reflector and the second sub reflector, the main frame, the first sub reflector frame, the second sub reflector frame have different orientations, and the reciprocal relative orientation of the main frame and the second sub-frame is determined so that the performance of the antenna is improved in terms of

increasing the symmetry of the beam gain distribution while limiting an additional scan loss over a same scan range, and/or,

increasing the beam shapes stability, and/or

reducing the beam mispointing without applying phase taper on the feeding array; and/or

decrease the degree of curvature of the second feeding array,

in view of the reference configuration wherein the first, second, third main axis of the main reference frame and the first, second, third second sub reflector axis of the second sub reflector frame are respectively the same;
either departing from the reference configuration the second sub reflector has been tilted around the second main axis x by a fifth elevation tilt angle φᵣ₂, defined as the relative angle between the first main reflector axis z and the first second sub reflector axis z′₂, and between the second main reflector axis x and the second second sub reflector axis x′₂, so that the reciprocal relative orientation of the main frame and the second sub reflector frame is defined only by the fifth elevation tilt angle φᵣ₂; or

departing from the reference configuration, the second sub reflector has been tilted around the second main axis x by a sixth azimuth tilt angle σᵣ₂, defined as the relative angle between the first main reflector axis z and the first second sub reflector axis z′₂, and between the third main reflector axis y and the third second sub reflector axis y′₂, so that the reciprocal relative orientation of the main reflector frame and the second sub reflector frame is defined only by the sixth azimuth tilt angle σᵣ₂;
departing from the reference configuration, the second sub reflector has been firstly tilted around the third main axis y by a seventh elevation tilt angle φᵣₑ, defined as the relative angle between the second main reflector axis x and the second second sub reflector axis x′₂, and

successively tilted around the second main axis x by an eighth azimuth tilt angle σᵣ₂, defined as the relative angle between the third main reflector axis y and the third second sub reflector axis y′₂, so that the reciprocal relative orientation of the main reflector frame and the second sub reflector frame is defined by the seventh elevation tilt angle φᵣ₂ and the eighth azimuth tilt angle σᵣ₂;
the first sub reflector and the first feed array are configured for transmitting at a first frequency, and

the second sub reflector and the second feed array are configured for receiving at a second frequency.

The invention also relates to a method for designing and manufacturing an offset imaging antenna system with compensated optical aberrations able to scan a beam electronically in a limited field of view or to generate a multi-beam coverage in a limited field of view,

the offset imaging antenna system comprising

a main reflector having a paraboloid shape, a main aperture, a main optical centre, and a main bore-sight axis,

a first sub reflector having a paraboloid shape, a first sub reflector optical centre and a first sub reflector bore-sight axis,

a first feeding array with a conformal curved shape to illuminate or to be illuminated by the first sub reflector comprising an arrangement of first feed array elements,

the main reflector and the first sub reflector being offset and confocal by sharing a common focal point,

characterized in that the method comprises

a first step of determining a general law for calculating conjugate points as a function of first feed array elements, and

a second step of determining the exact positions of the first feed array elements by reversing the determined function and setting as a boundary condition to have all the conjugate points lying on a plane crossing the main reflector centre.

According to specific embodiments, the method for designing and manufacturing an offset imaging antenna system as described here above comprises one or more of the following features:
the method as defined here above comprises further a third step carried out between the first step and the second step wherein a target imaging array is defined as a planar sparse array on the aperture plane of the main reflector, and

wherein in the second step the exact positions of the first feed array elements are determined so that the conjugate points of the first feed array elements coincide with the points of the planar sparse array forming the target imaging array;
the method as defined here above comprises a fourth step carried out, either before the first step, or after the second step wherein while keeping the confocality between the main reflector and the first sub reflector, the first sub reflector bore-sight axis of the first sub reflector is tilted in respect of the main bore-sight axis of the main reflector according to a rotation that improve the performance of the antenna in terms of

increasing the symmetry of the beam gain distribution while limiting an additional scan loss over a scan range, and/or,

increasing the beam shapes stability, and/or

reducing the beam mispointing without applying phase taper on the feeding array; and/or

decreasing the degree of curvature of the first conformal feeding array,

in view of a reference confocal configuration wherein the main bore-sight axis and the first sub reflector bore-sight axis are parallel and opposite.

The antenna configuration according to the invention, comprising one or two confocal paraboloid reflectors and a feeding array, is derived using two main properties:

a) by properly shaping the feeding array in such a way that the corresponding magnified array, constituted by the conjugated points [1], results being as flat as possible, the radiative performance of the antenna within an assigned field of view may be controlled and improved without shaping the surfaces of the reflectors;
b) by keeping the confocality between the main and the sub reflector but optimizing the reciprocal orientation of their axes (adopting an appropriate rotation of one axis respect to the other one), an additional dimension to the design space may be added maintaining at the same time the favourable properties of the confocality between the reflectors. It will be shown that rotating one axis with respect to the other one helps in keeping the magnified array of the conjugated points as flat as possible and, at the same time, the feeding array as perpendicular as possible to the axis of the sub reflector and as parallel as possible with respect to the surface of the sub reflector. These changes are reflected in an improvement in the radiative performance.

The invention will be better understood from a reading of the description of several embodiments below, given purely by way of example and with reference to the drawings, in which:

FIGS. 1A and 1B are respectively a perspective view of a conventional imaging antenna system with two confocal offset parabolic reflectors with coinciding axes with opposite directions and a common focal point;

FIGS. 2A and 2B are GO study of the imaging system: rays are traced through the system showing anastigmatism (FIG. 2A) and distributed caustics due to scanning (FIG. 2B);

FIG. 3 is a view of a conventional offset imaging antenna system fed by a planar array and of the corresponding conjugate points crossing the main reflector aperture in its centre point;

FIG. 4 is a view illustrating the ray tracing method for studying an imaging antenna system;

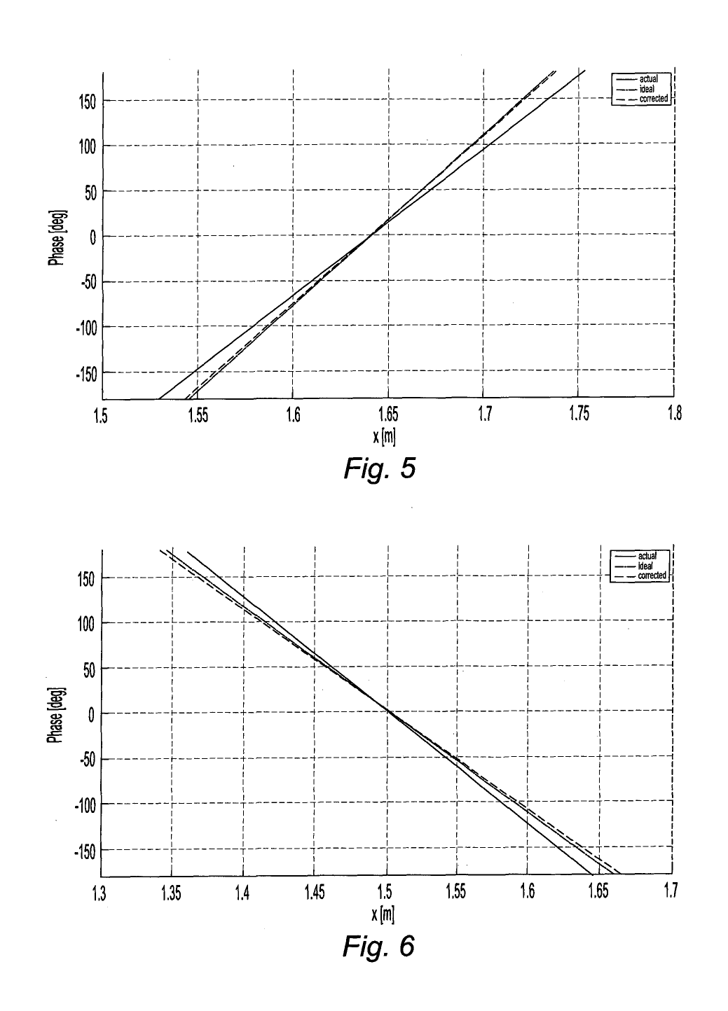

FIG. 5 illustrates the actual, ideal and compensated phases distribution for a scan angle θ_{sc}=−10°;

FIG. 6 illustrates the actual, ideal and compensated phases distribution for a scan angle θ_{sc}=10°;

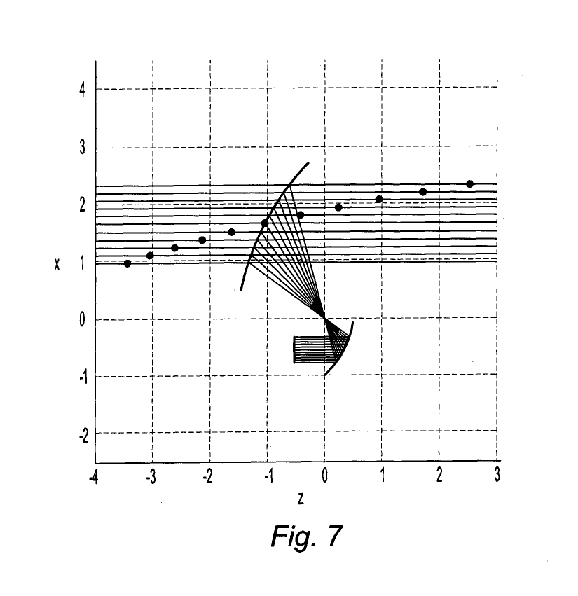

FIG. 7 is a view of a conventional imaging antenna system represented in the offset plane with θ_{sc}=0° and ‘best-fit’ points interpolation;

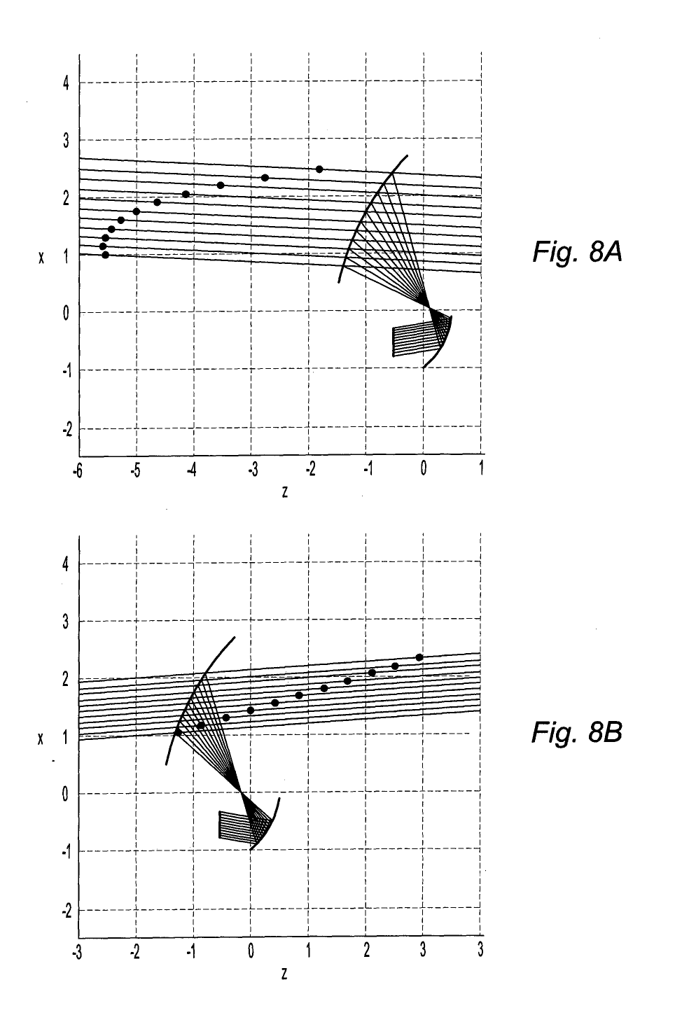

FIGS. 8 A-B are the respective views of a conventional imaging antenna system represented in the offset plane in the up-scan case (θ_{sc}=10°) and in the down-scan case (θ_{sc}=−10° and ‘best-fit’ points interpolation;

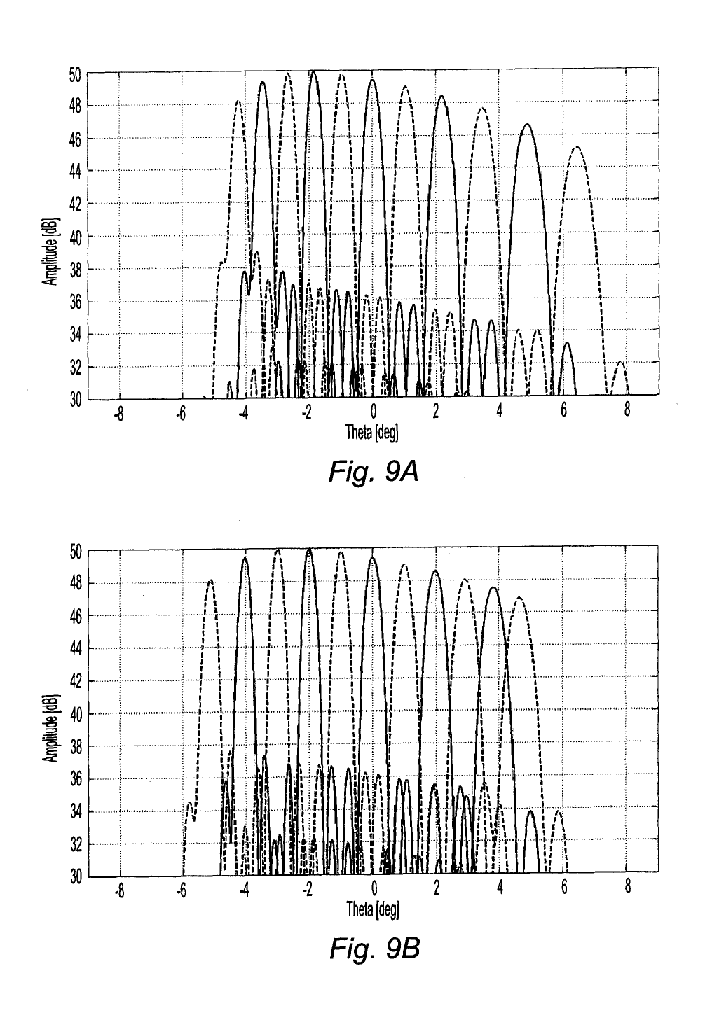

FIGS. 9A and 9B illustrate the power patterns obtained respectively without (9A) and with (9B) the application of the ISCA phase compensation;

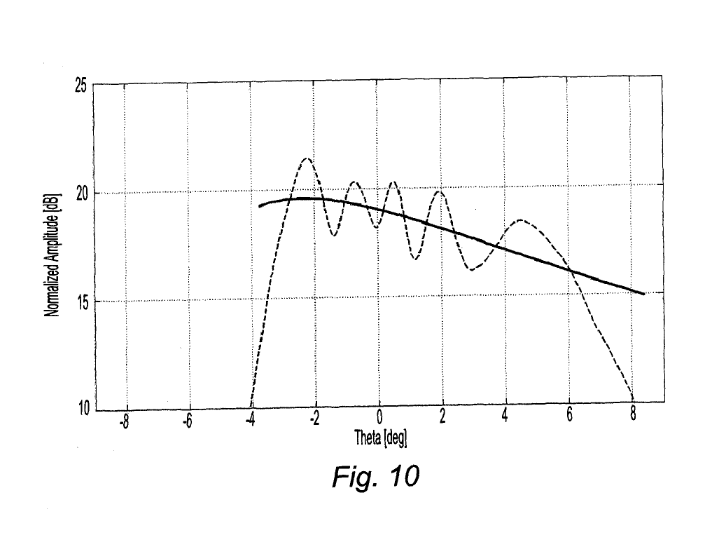

FIG. 10 is a view of a SFE pattern simulated in Physical Optic (PO) (dotted line) and GO (straight line) when used in the configuration of FIG. 9;

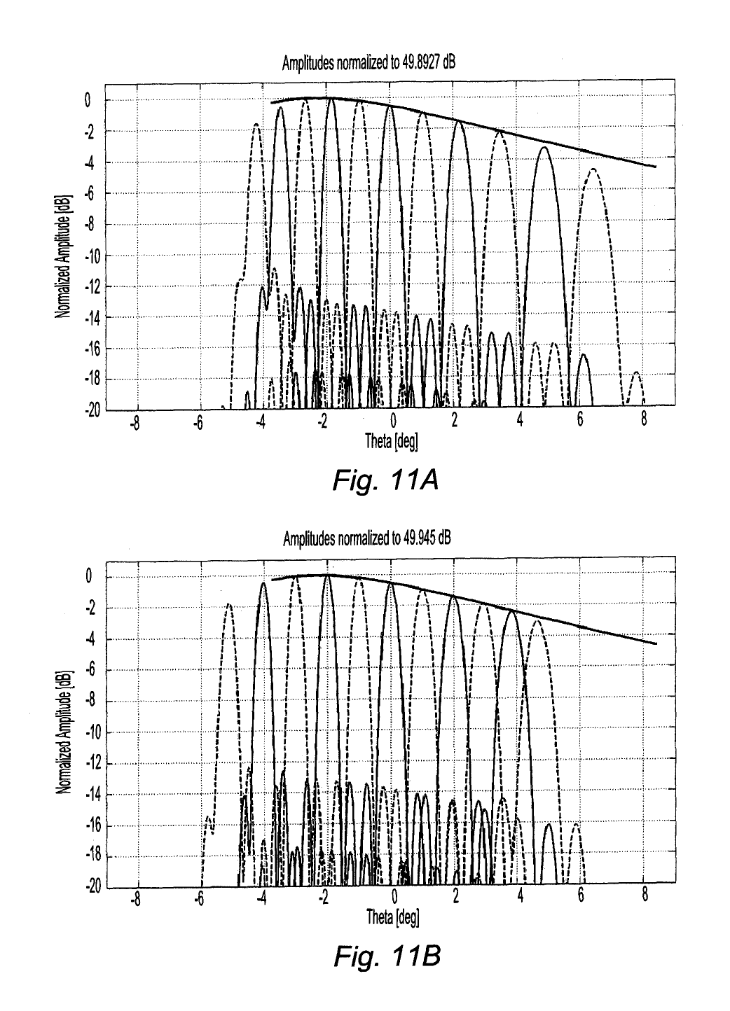

FIGS. 11A and 11B are views of normalised PO simulated beams and GO simulated SFE pattern respectively without phase correction (11A) and with phase correction (11B);

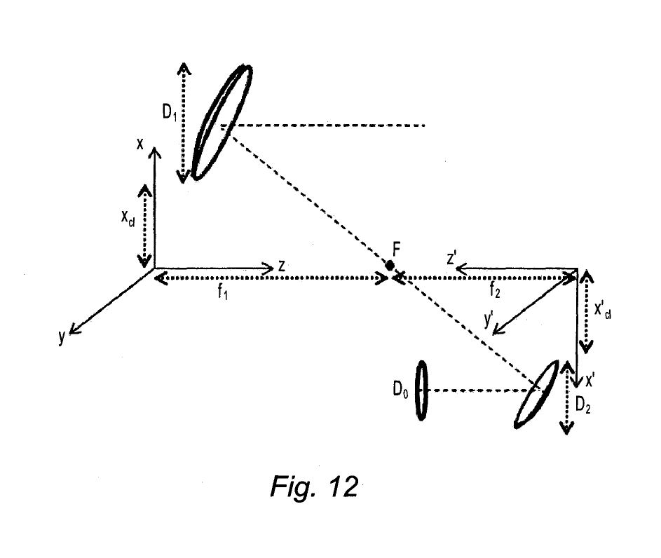

FIG. 12 is a view of an offset imaging antenna system, each reflector among a main reflector and a sub reflector being defined with respect to an own reference system;

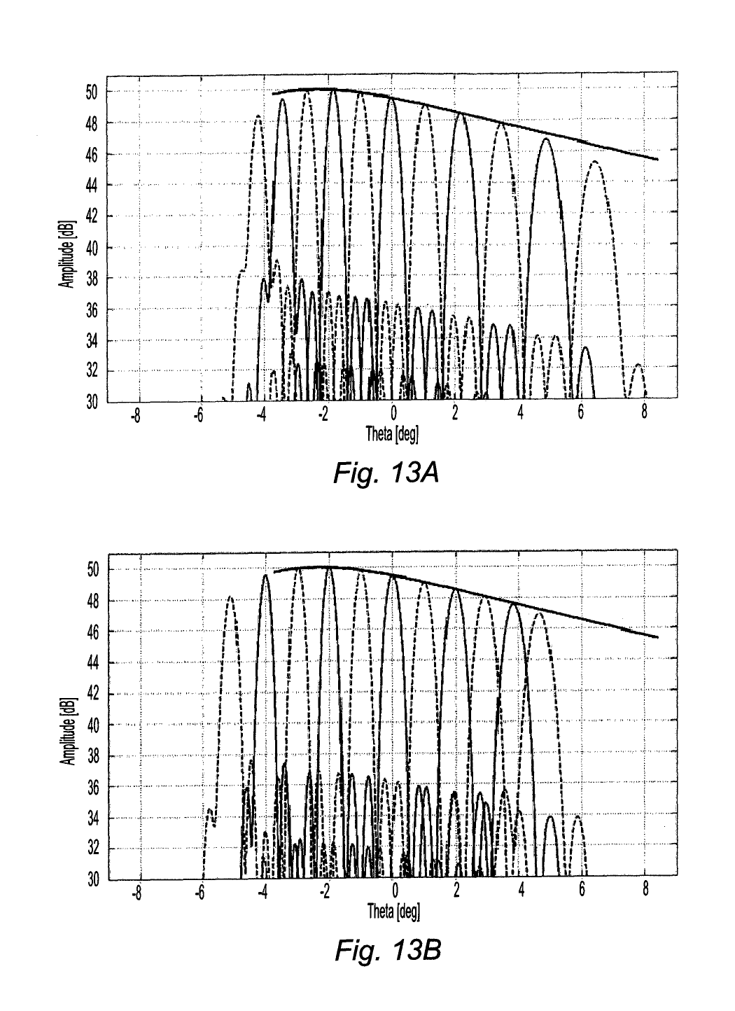

FIGS. 13A, 13B are views of the simulated beams obtained respectively with a conventional offset imaging antenna system fed by planar array (13A) and with an offset imaging antenna system according to the invention fed by a conformal array (13B);

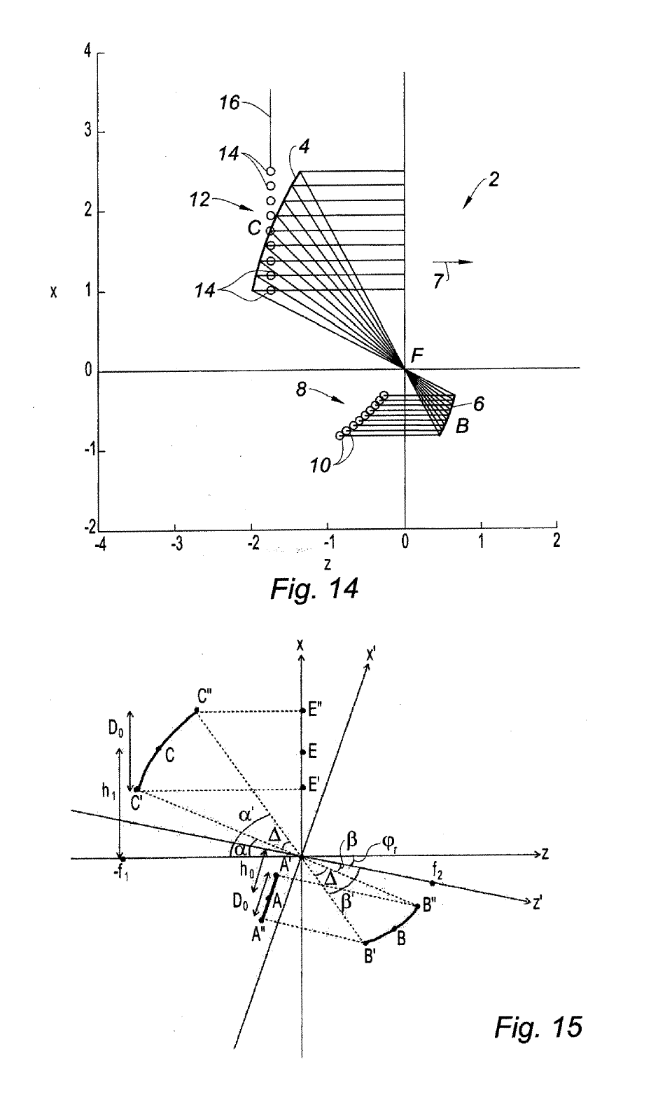

FIG. 14 is a view of an offset imaging antenna system according to a first embodiment of the invention;

FIG. 15 is a geometrical view of design parameters of a confocal imaging antenna system with tilted axes, both reference systems being centred in the common focal point;

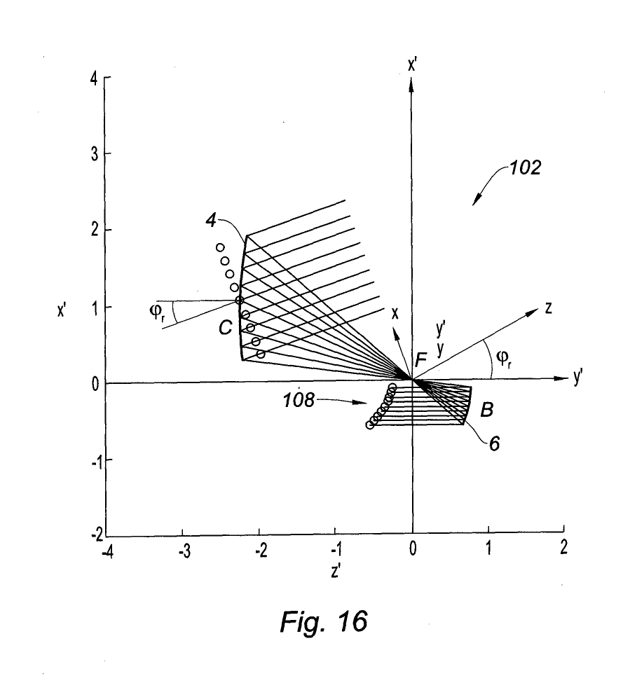

FIG. 16 is a view of an offset imaging antenna system according to a second embodiment of the invention;

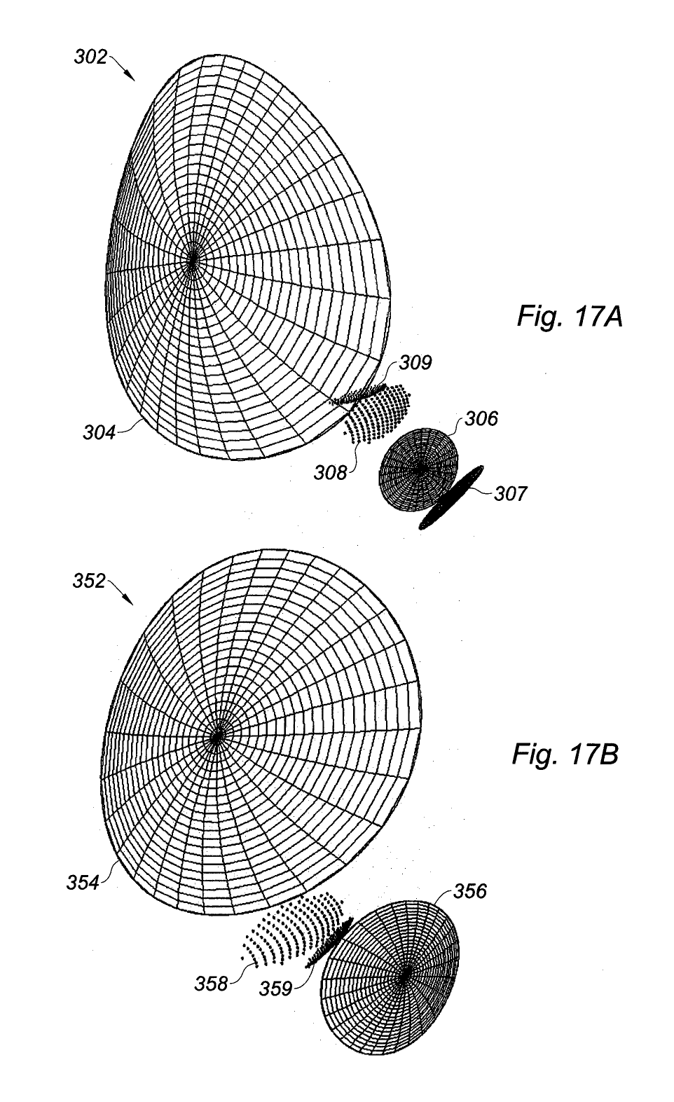

FIG. 17A is a view of an offset imaging antenna system according to a third embodiment of the invention with a first feeding array and a first sub reflector operating in Tx, and a second feeding array and a second sub reflector operating in Rx;

FIG. 17B is a view of an offset imaging antenna system according to a variant of the third embodiment wherein the first sub reflector and the second sub reflector are replaced by a single shared sub reflector;

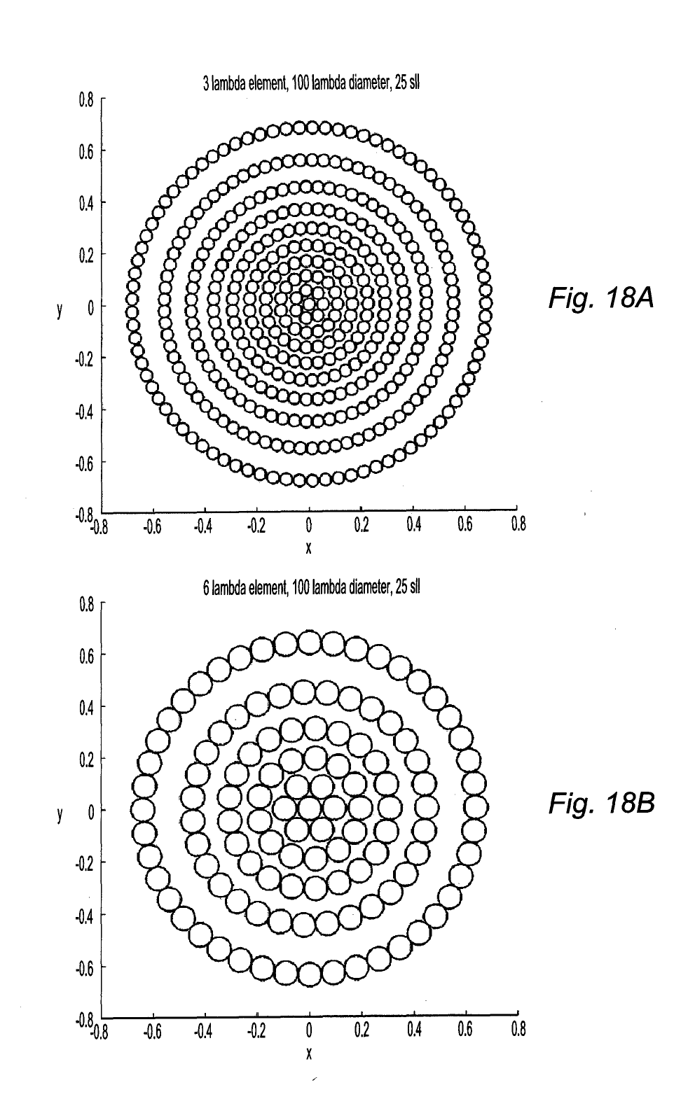

FIGS. 18A and 18B are respective views of sparse feeding arrays having same 100λ aperture with 3) diameter feeds (17A) and 6λ diameter feeds (17B);

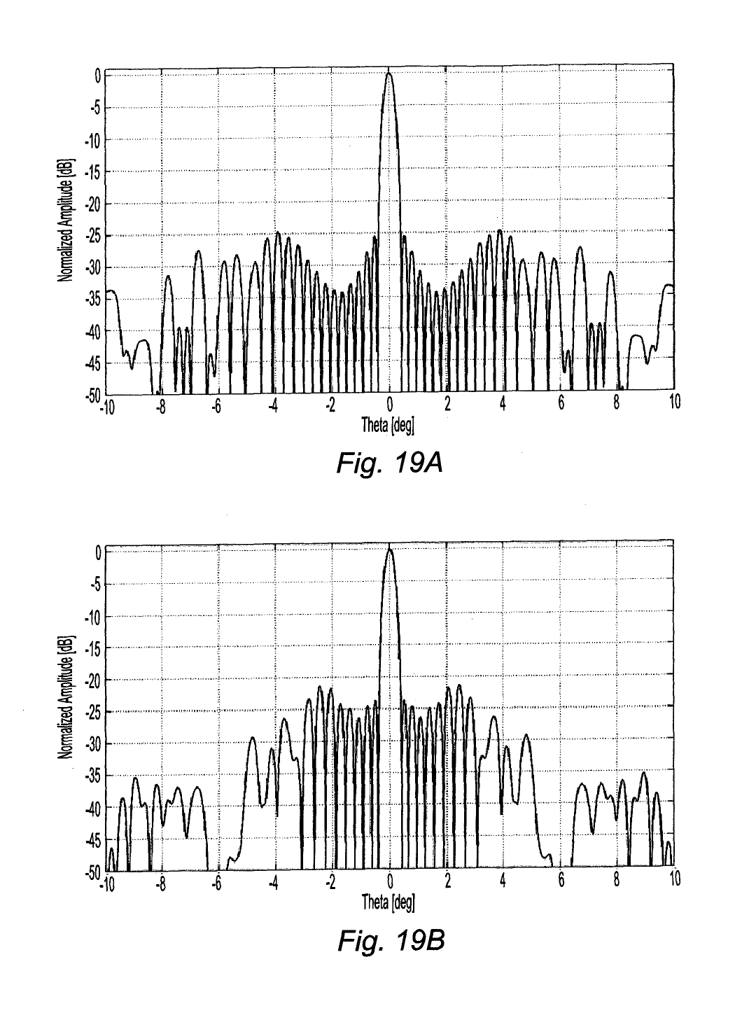

FIGS. 19A and 19B illustrate respective bore-sight patterns for the direct radiating sparse arrays with 394 elements (19A) and 116 elements (19B);

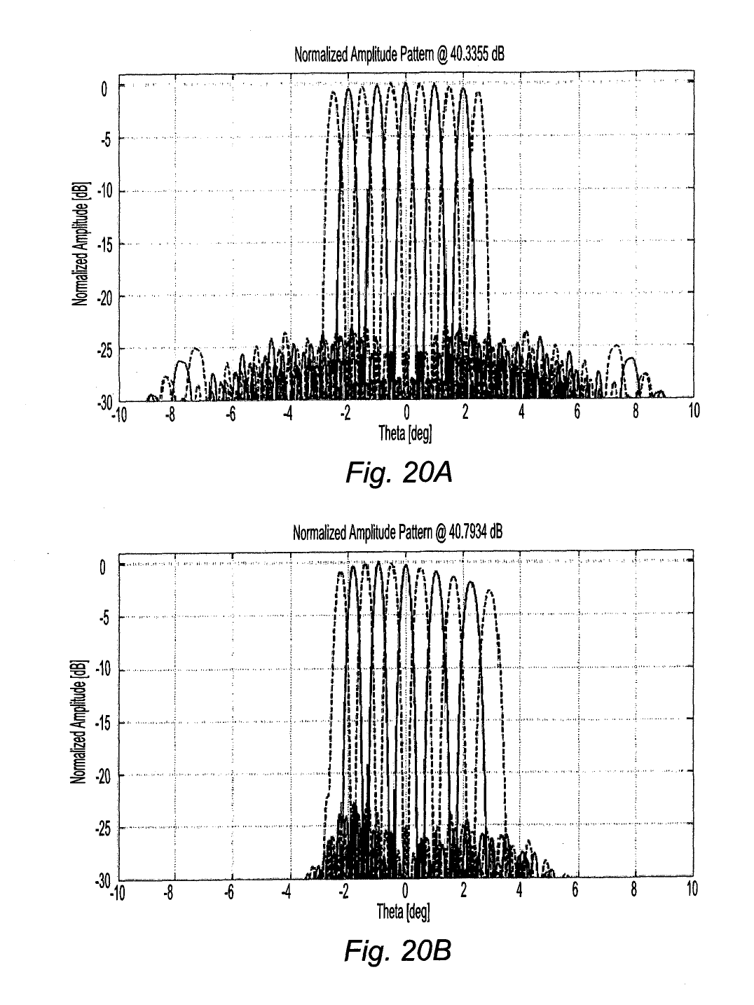

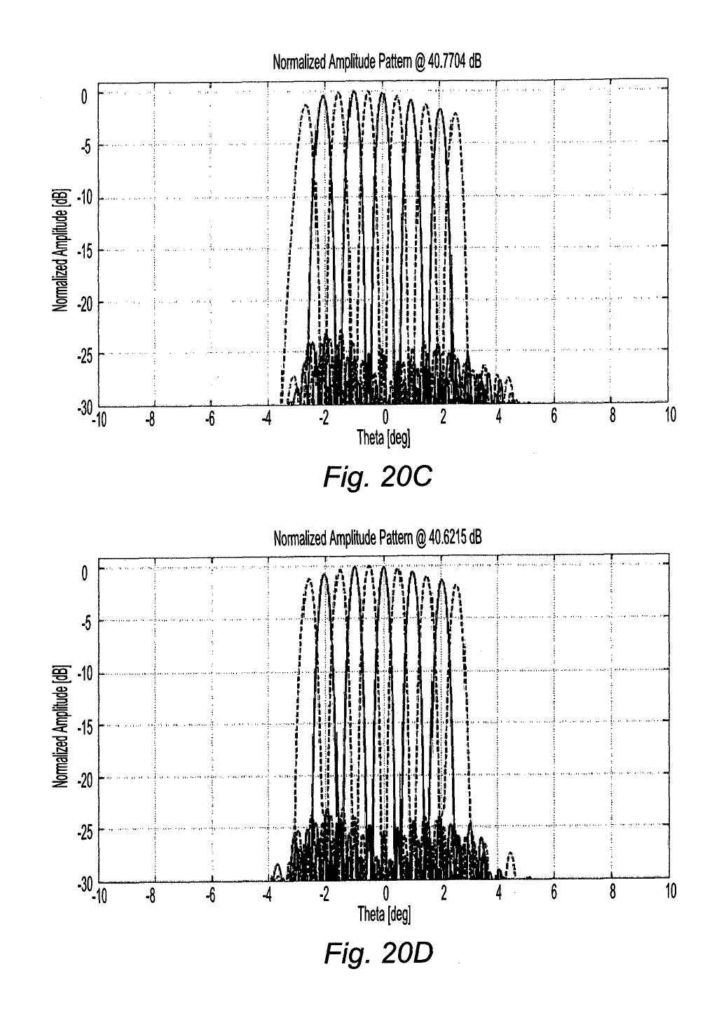

FIGS. 20A, 20B, 20C, 20D illustrate the beam patterns versus scanning angle when using a 394 elements sparse array in the respective cases: DRA (20A); imaging system fed by a planar sparse array (20B); imaging system fed by a conjugate sparse array (20C); imaging system fed by a conjugate sparse array with sub reflector axis tilt of 20° (20D);

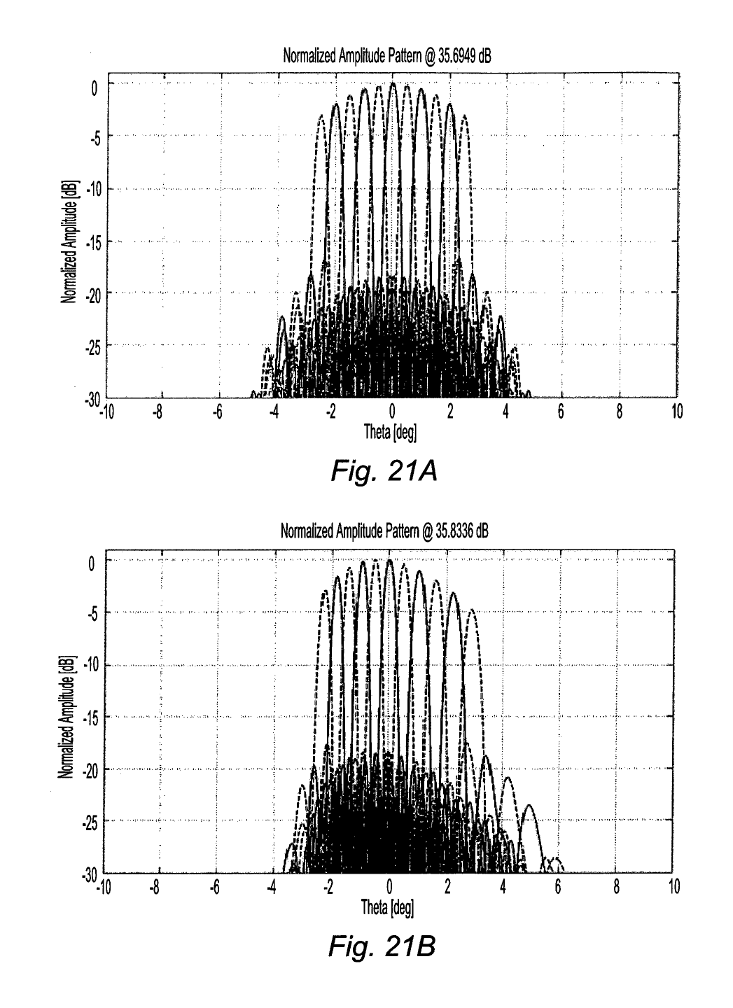

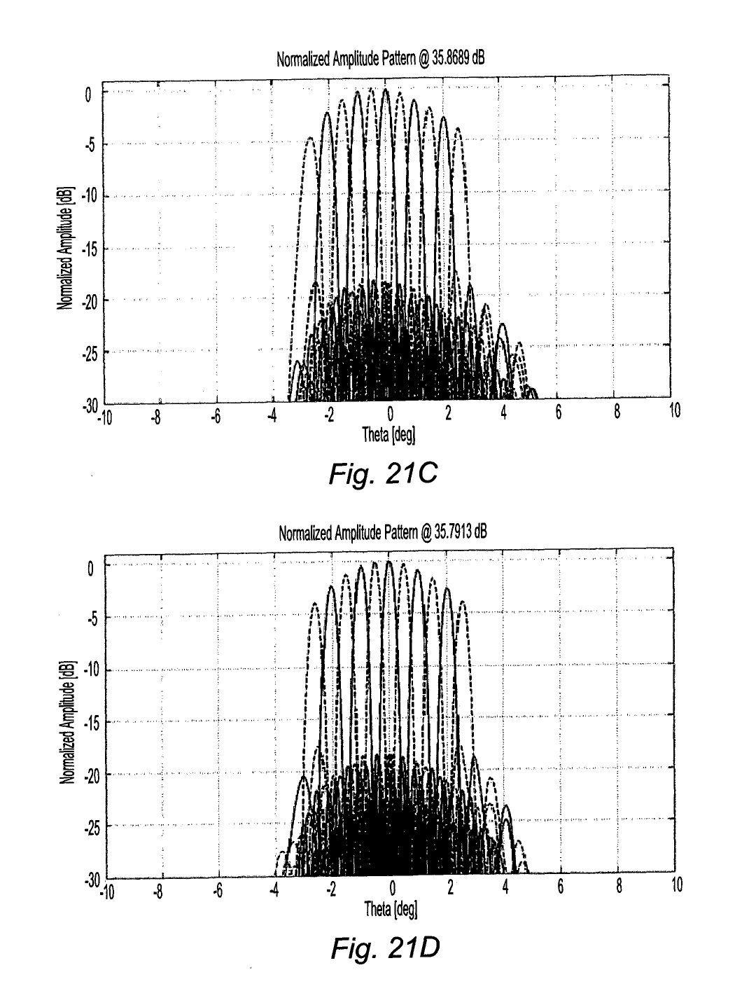

FIGS. 21A, 21B, 21C, 21D illustrate the beam patterns versus scanning angle when using a 116 elements sparse array in the respective cases: DRA (21A); imaging system fed by a planar sparse array (21B); imaging system fed by a conjugate sparse array (21C); imaging system fed by a conjugate sparse array with sub reflector axis tilt of 20° (21D);

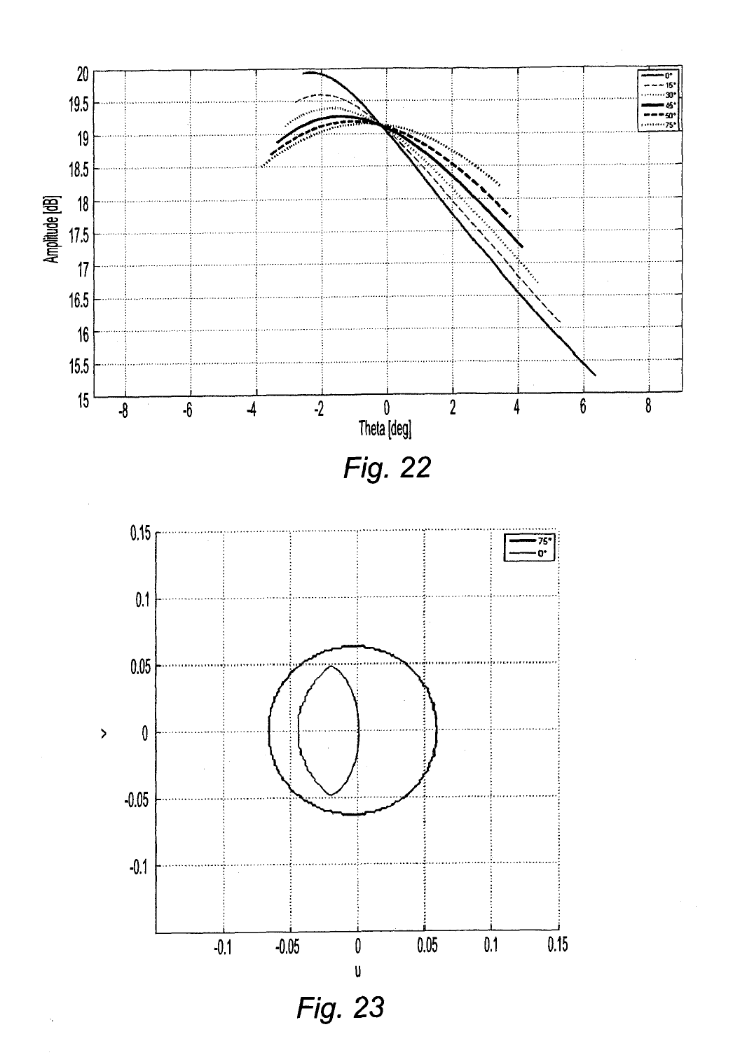

FIG. 22 illustrates SFE patterns of the imaging antenna system in the offset plane φ=0°;

FIG. 23 illustrates beam contour plots for φ=0° and φ=75° at −1 dB;

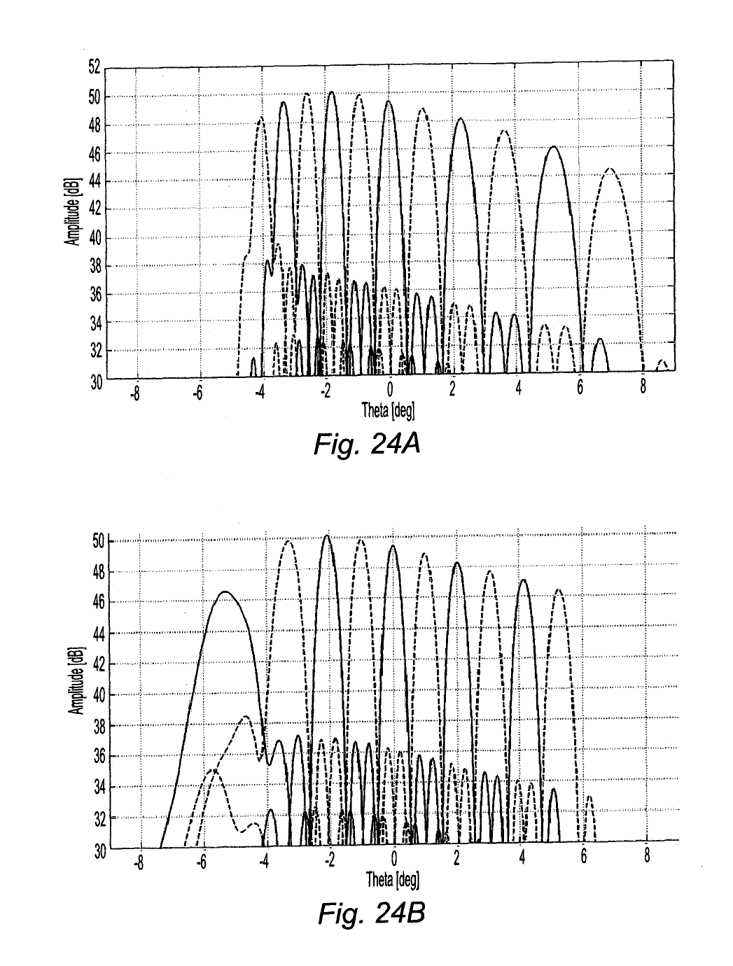

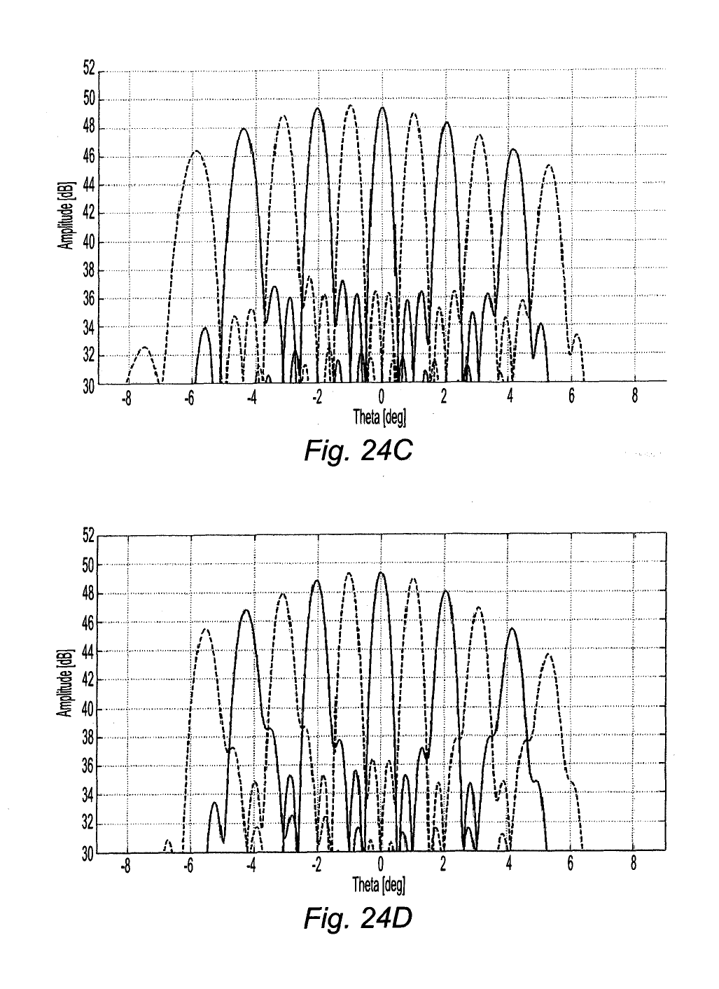

FIGS. 24 A-D are PO simulated beams for the imaging system with respectively: (24A) φᵣ=0° feeding by a planar array, (24B) φᵣ=0° feeding by a conformal array, (24C) φᵣ=30° feeding by a conformal array, (24D) φᵣ=45° feeding by a conformal array;

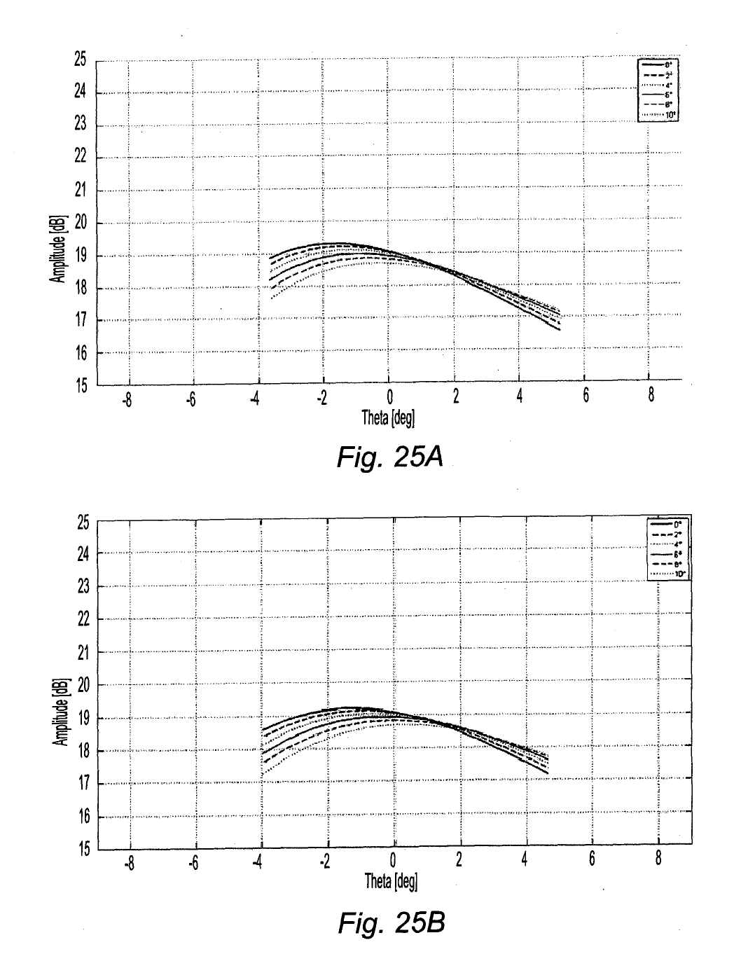

FIGS. 25A et 25B illustrate FE patterns as a function of γₑₗ for respectively φᵣ=30° (25A) and φᵣ=45° (25B);

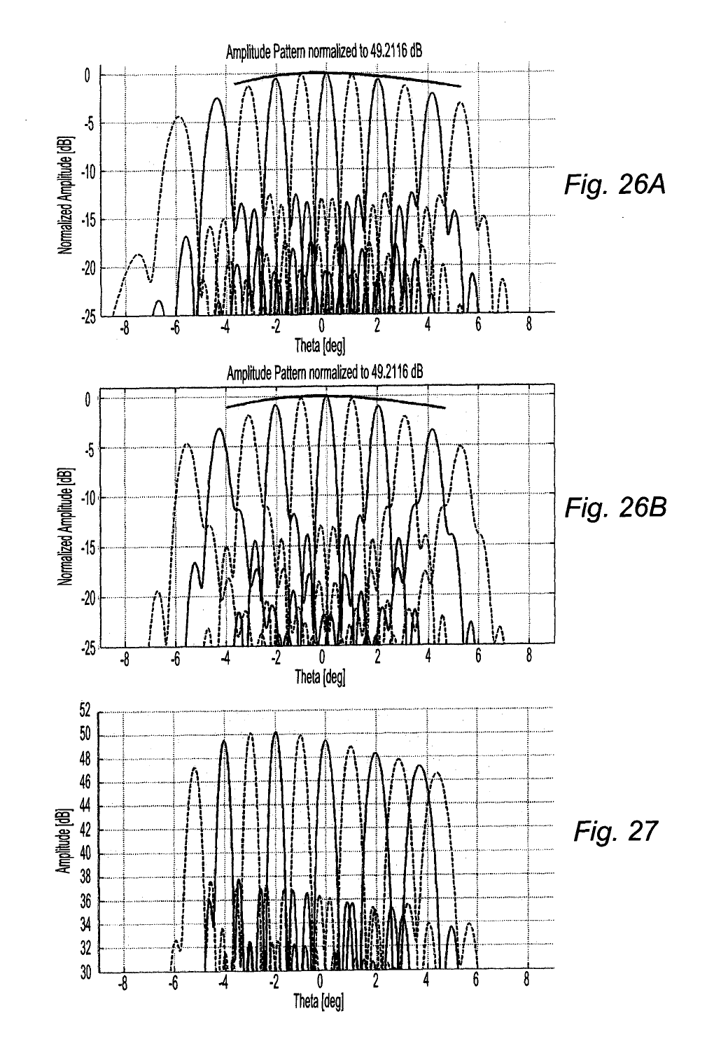

FIGS. 26A and 26B illustrate normalized beams and SFE patterns respectively for φᵣ=30° and γₑₗ=10° (26A) and φᵣ=45° and γₑₗ=6° (26B);

FIG. 27 illustrates beams of the reference case (φ_{R}=0°) imaging antenna system fed by a planar array after having applied the non-linear ISCA phase taper;

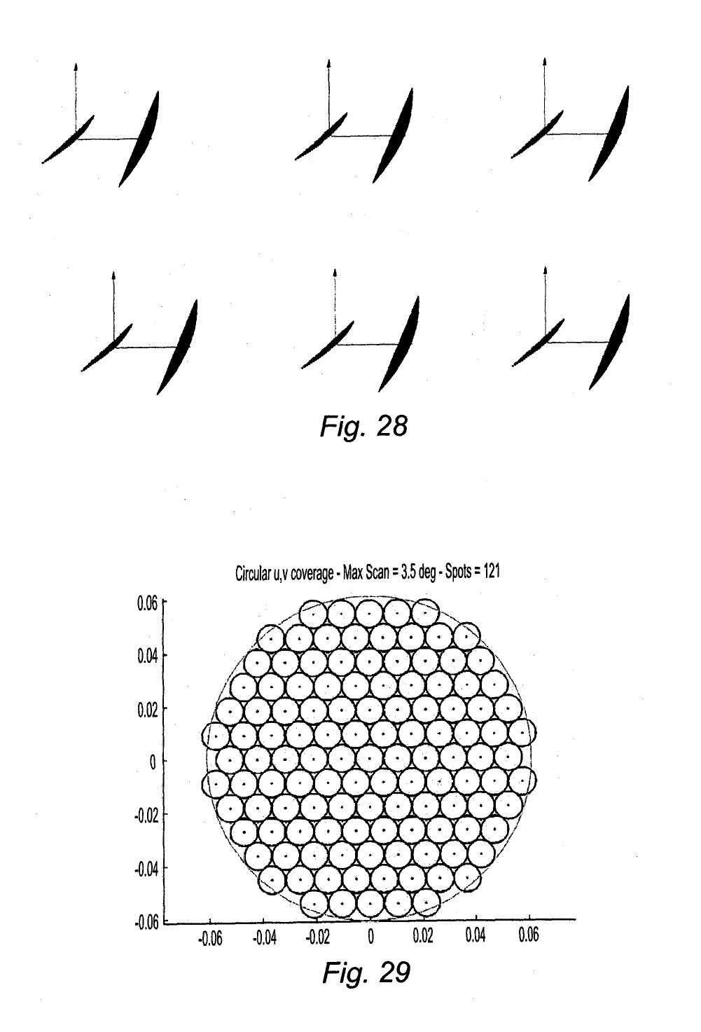

FIG. 28 is a set of sub-figures that illustrate several geometrical configurations of the antenna system with: upper sub-figures, from left to right, φ_{R}=0° and f/D respectively 1; 1.5; 2; lower sub-figures, from left to right, φ_{R}=40° and f/D respectively 1; 1.5; 2;

FIG. 29 is a view of a Earth continental coverage with a circular aperture of 3.5° as seen from GEO;

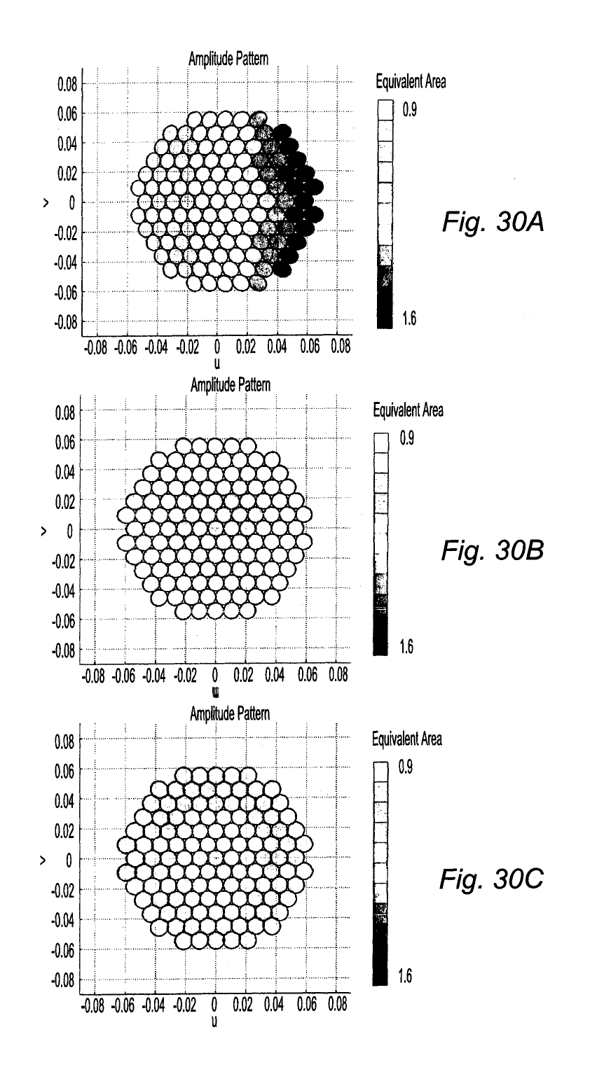

FIGS. 30A, 30B, 30C are respectively views of a planar array feeding a confocal and coaxial dual reflector (30A), a conformal array feeding a confocal and coaxial dual reflector (30B), a conformal array feeding a confocal dual reflector with tilted sub reflector.

In the following, the analysis of an imaging antenna system is described that adopts only a ray-tracing GO technique. According to [1-3] this technique provides a good approximation of the system performances and the theory of conjugate points can be exploited for improving the scanning performances.

Each feed position (x_{f},y_{f},z_{f}) refers to a common focus centred Cartesian reference system a shown in FIG. 4. A ray impinging along the axial direction \vec{ab} towards the sub reflector is reflected according to Snell's reflection law along the direction \vec{bc}, where \vec{bc}=\vec{ab}−2\hat{n}_{B}(\hat{n}_{B}·\vec{ab}) and \hat{n}_{B} is the local normal on the sub reflector surface at the reflection point. Along its path between a) the first reflection on the sub reflector, b) the common focal point of both reflectors and c) the second reflection point on the main reflector, a first ray focal point can be calculated by means of following relation:

$$\frac{1}{{l}_{1}} + \frac{1}{{l}_{2}} = \frac{1}{{r}_{s}} \qquad ( 1.1 )$$

where:
l₁=A̅B̅ is the distance between the feed position and the first reflection point;
l₂=B̅D̅ is the distance between the first reflection point and the first ray focal point D;
rₛ is the radius of curvature of the sub reflector at the first reflection point.

The ray continues towards the second reflection point on the main reflector and reflection will follow Snell's law as \vec{cd}=\vec{bc}−2\hat{n}_{C}(\hat{n}_{C}·\vec{bc}) where \hat{n}_{C} is the local normal on the main reflector surface at the reflection point. The relation between the first ray focal point and the second ray focal point, i.e. the conjugate point, is:

$$\frac{1}{{l}_{1}^{′}} + \frac{1}{{l}_{2}^{′}} = \frac{1}{{r}_{m}} \qquad ( 1.2 )$$

where:

l′₁=D̅C̅ is the distance between the ray focal point D and the second reflection point;

l′₂=C̅E̅ is the distance between the second reflection point and the conjugate point E;

rₘ is the radius of curvature of the main reflector at the second reflection point.

The reflector equations with respect to the common reference frame are:

$${z}_{m} = \frac{{x}_{m}^{2} + {y}_{m}^{2}}{4 {f}_{1}} - {f}_{1} \qquad ( 1.3 )$$

$${z}_{s} = {f}_{2} - \frac{{x}_{s}^{2} + {y}_{s}^{2}}{4 {f}_{2}} \qquad ( 1.4 )$$

representing respectively the main and the sub reflector parabolas. By combining the previous relations, the positions (x_{c},y_{c},z_{c}) of the conjugate points, characterized by the letter E in FIG. 4, are:

$$\begin{matrix} {x}_{c} = - {Mx}_{f} & ( 1.5 ) \\ {y}_{c} = - {My}_{f} & ( 1.6 ) \\ {z}_{c} = - {f}_{1} + \frac{\begin{matrix}{ρ}^{6} ( M + 1 ) \frac{M}{32 {f}_{2}^{3}} + {ρ}^{4} ( \frac{M}{8 {f}_{2}} ) ( 5 \frac{M}{2} + \frac{5}{2} - ( {f}_{2} - {z}_{f} ) \frac{M}{2 {f}_{2}} ) + \\ {ρ}^{2} ( ( M + 1 ) {f}_{1} - ( {f}_{2} - {z}_{f} ) \frac{{M}^{2}}{2} ) + {f}_{1} {f}_{2}^{2} + {z}_{0} {f}_{1}^{2}\end{matrix}}{\frac{{ρ}^{4}}{16 {f}_{2}^{2}} + \frac{{ρ}^{2}}{2} + {f}_{2}^{2}} & ( 1.7 )\end{matrix}$$

where M=f₁/f₂, ρ²=x_{f}²+y_{f}² and z₀ is the distance between the feed element and the first reflection point. The obtained relations show that in a dual-reflector system composed by two parabolic conic mirrors, the ray focal points [4] may be calculated as a function of the system geometry and from the knowledge of the feed positions.

Now, starting from the conjugate points description as a function of the imaging system's geometry it is possible to derive a non-linear phase compensation tapering to be superimposed to the feed excitations in order to reduce significantly the effect of phase aberrations during the scanning. This phase-only approach is described in this paragraph and will be denoted as Improved Scaled Array Approach (ISCA). A magnified direct radiating array whose phase centres coincide with the conjugate points produces a radiation pattern which can be represented by:

P(θ,φ)=P₀(θ,φ)AF(θ,φ) (2.1)

where:
P(θ, φ) is the array's power pattern;
P₀(θ, φ) the magnified element power pattern;
AF(θ, φ) the array factor.
   For simplicity the elements constituting the magnified array are considered identical with a uniform amplitude taper. For the array factor the following expression may be used:

AF(θ,φ)=Σ_{N}Aₙe^{-jk}^{_{c}}^{(sin θ-sin θ}^{₀}^{)[Δx}^{ₙ}^{(cos φ-cos φ}^{₀}^{)Δy}^{ₙ}^{(sin φ-sin φ}^{₀}^{)]}e^{-jδ} (2.2)

with δ=kΔzₙ(cos θ−cos θ₀). The equivalent array factor of a planar magnified array, as described within the SCA approach, is the following:

AF(θ,φ)=Σ_{N}Aₙe^{-jk}^{_{c}}^{(sin θ-sin θ}^{₀}^{)[Δx}^{ₙ}^{(cos φ-cos φ}^{₀}^{)Δy}^{ₙ}^{(sin φ-sin φ}^{₀}^{)]} (2.3)

Since this array factor is related to a planar array which is aberration-free when scanning beams, the term which is responsible for the quadratic aberrations superimposed on the linear law can be isolated as follows:

AF(θ,φ)=Σ_{N}Aₙe^{-jk}^{_{c}}^{(sin θ-sin θ}^{₀}^{)[Δx}^{ₙ}^{(cos φ-cos φ}^{₀}^{)Δy}^{ₙ}^{(sin φ-sin φ}^{₀}^{)]}e^{-jΦ(θ,θ}^{₀}⁾ (2.4)

The first exponential at second member is the same as in the ideal array factor, while the second exponential depends on the elevation angle and on the z position only and may be expanded as follows:

Φ(θ,θ₀)=k_{c}Δzₙ(cos θ−cos θ₀) (2.5)

Since this term is multiplicative within the array factor (2.5), i.e. producing an additive phase error, it can be compensated by deriving the complex conjugate quantity and adding this phase compensation value at BFN level. To have the array factor expression (2.4) equal to the SCA case expression (2.3), it is necessary that for each pointing direction the linear phase progression, applied to the feed array, is corrected by:

e^{-jk}^{_{c}}^{(cos θ′-1)Δz}^{ₙ} (2.6)

where:

$${θ}^{′} = \frac{{θ}_{o}}{M} \qquad ( 2.7 )$$

and θ₀ is the elevation angle applied to the array for scanning the beam across the sub reflector surface. The calculated phase compensation produces a notable improvement in the radiative properties reducing the imaging system's mispointing. If no scan is applied all rays emerging from a planar feed arrive on the main reflector focal plane with a constant phase value:

Φ_{ref}=k_{c}[2f₂(M+1)−z_{f}] (2.8)

where:
k_{c}=2π/λ is the propagation constant;
f₂ the sub reflector focal length;
M=f₁/f₂ the magnification ratio;
z_{f} the z-coordinate of the linear array.
   The total path length is:

PLₜₒₜ=A̅B̅+B̅C̅+C̅D̅ (2.9)

where:
A̅B̅ is the distance between the feed and the first reflection point on the sub reflector;
B̅C̅ is the distance between the sub reflector and the main reflector reflection points;
C̅D̅ is the distance between the main reflector reflection point and the arrival point.
   The total phase distribution on the aperture plane will be a superposition of the phase associated to the total path length (between the feed element and the aperture plane) and the linear phase progression applied for scanning the beams:

Φ_{sc}=k_{c}[PLₜₒₜ+xₐᵣ sin θ_{sc}] (2.10)

where:
xₐᵣ is the feed position on the array along the x-axis;
θ_{sc} the scan angle applied to the array.
   A first order estimation of phase aberrations can be obtained as the difference between the reference case phase value Φ_{ref} and the actual phase value, which is calculated for each n-th feed element as:

Φₙ=k_{c}PLₙ^{tot} (2.11)

The phase compensation value can be calculated as:

$${Φ}_{sa} = - {k}_{c} {z}_{cp} [ 1 - cos ( \frac{{θ}_{sc}}{M} ) ] \qquad ( 2.12 )$$

where z_{cp} is the z-coordinate of the conjugate point.

As an example, a two-dimensional imaging system with a main aperture of 100λ at Ka-band (20 GHz) has been simulated in Matlab® and a number of rays have been calculated for both an up-scan and down-scan direction of θ_{sc}=10° in the offset plane of the system, characterising the phase distributions on the focal plane of the main reflector. In FIG. 5 and FIG. 6, respectively for the down-scan and up-scan simulation cases, three phase distributions are presented:
one being the actual phase distribution due to both the linear phase applied to the array and the ray path lengths;
one being the ideal phase distribution, which should be expected for allowing beams to be tilted along the linear law of equation (0.2) and (0.3);
one being the corrected phase distribution obtained after having fed the array elements along the phase compensation law of the SCA approach.

As it can be seen, the expected linear phase tilt which applies in case of an ideal antenna is well approximated once the non-linear phase tapering law has been applied. The actual phase value (represented by a solid line in both figures) deviates from a linear law by an amount which is proportional to the phase aberration contribution with respect to the scanned angle, while the compensated phase value (represented by a dashed line) follows much better the ideal phase variation on the aperture plane (represented by a dashed and dotted line). Despite to the fact that phase aberrations are less pronounced in the down-scan case, there is less compliance in the phase aberrations estimation for the up-scan case as provided by the ISCA method. In practice, for both scan cases a major improvement in reducing the quadratic phase aberration component can be experienced by applying the non-linear phase compensation method. An even better compliance is obtained by improving the ISCA method by means of numerical refinement. Instead of assuming fixed positions for the conjugate points, the magnified array may be characterised by “best-fit” image points which are a function of the scanning angle. This approach has the drawback of requiring a GO analysis for determining the “best-fit” image points for every scanning angle, but still maintains the simplicity of deriving the phase compensation by means of the equivalent array factor on these “best-fit” phase centres as follows:

$${Φ}_{sa}^{′} = - {k}_{c} \{ {z}_{bf} [ 1 - cos ( \frac{{θ}_{sc}}{M} ) ] - Δ {x}_{bf} sin ( \frac{{θ}_{sc}}{M} ) \} \qquad ( 2.13 )$$

This equation has an additional degree of freedom represented by the x-coordinate dependence which provides a better approximation of the phase aberration estimation. Following the considerations that apply for the two-dimensional case, the same relations hold for the three-dimensional case, introducing a third degree of freedom represented by the y-coordinate dependence. “Best-fit” image points are the result of a numerical interpolation and coincide with conjugate points only in the boresight case. For every scan angle different from zero, the equivalent “best-fit” points move according to the caustic regions as a function of the scanning angle. To calculate these points, for each feed element of the array a small cone of rays with a small angular aperture are traced throughout the imaging system according to Snell's reflection laws and considering infinitely extended rays superimposed on the main reflector reflected rays. Caustic regions are formed both in front and (virtually) behind the main reflector surface. FIG. 7 show how “best-fit” points coincide with conjugate points if the boresight case is considered, while FIGS. 8 A, 8B show how “best-fit” points move away from conjugate points, when scanning the beams. The virtual arrays now produce different equivalent array factors for each angle of scan, which depend on both the variations along z and x. In Tables 1 and 2 the beam mispointing is quantified after having applied the ISCA method (ΔΦ_{SCA1}) and after having applied the numerically improved ISCA method (ΔΦ_{SCA2}).

TABLE 1
Phase divergence for the down-scan case θ_{SC} = −10°

| | | | | | | | | | | | |
|---|---|---|---|---|---|---|---|---|---|---|---|
| ΔΦ_{SCA1} | −18.68 | −14.23 | −10.13 | −6.38 | −2.99 | 0 | 2.59 | 4.76 | 6.50 | 7.79 | 8.61 |
| ΔΦ_{SCA2} | −9.79 | −7.37 | −4.83 | −2.79 | −1.19 | 0 | 0.84 | 1.37 | 1.64 | 1.69 | 1.56 |

TABLE 2
Phase divergence for the up-scan case θ_{SC} = 10°

| | | | | | | | | | | | |
|---|---|---|---|---|---|---|---|---|---|---|---|
| ΔΦ_{SCA1} | 38.70 | 31.12 | 23.45 | 15.72 | 7.94 | 0 | −8.17 | −15.99 | −23.91 | −31.54 | −39.00 |
| ΔΦ_{SCA2} | 31.16 | 24.61 | 18.17 | 11.90 | 5.83 | 0 | −5.54 | −10.73 | −15.54 | −19.91 | −23.77 |

As it can be seen, even if an improvement in phase aberration reduction is obtained for the numerically improved ISCA approach; the matching is higher for negative scan angles, than for positive scan angles, as already seen in the case of the purely deterministic ISCA approach. This shows that the proposed method provides very good performance if applied to the down-scan case, i.e. when the beam produced by the imaging system is scanned up-wards with respect to the main reflector axis.

A simulation has been done also by means of a three-dimensional imaging system with M=3 by means of the TICRA® GRASP simulation tool. In FIGS. 9 A-B a number of power patterns have been simulated in the offset plane by means of a PO approach. The array scans 11 beams along the sub reflector surface, one represented for each 3° of scan, evenly distributed around the boresight direction.

In the FIG. 9A only a linear phase progression is applied to the array, while in the FIG. 9B lower figure also the ISCA phase compensation method has been applied.
A comparison is drawn in Table 3 where the actual beam pointing angles are presented both without and with the ISCA correction.

TABLE 3
Pointing angles obtained without (up) and with (down) the application
of the ISCA phase compensation

| | Expected | | | | | | | | | | |
|---|---|---|---|---|---|---|---|---|---|---|---|
| | −5° | −4° | −3° | −2° | −1° | 0° | 1° | 2° | 3° | 4° | 5° |
| Case 1 | −4.2° | −3.44° | −2.66° | −1.84° | −0.96° | 0° | 1.04° | 2.19° | 3.46° | 4.87° | 6.42° |
| Case 2 | −5.1° | −4.01° | −2.99° | −1.99° | −1° | 0° | 0.99° | 1.98° | 2.93° | 3.82° | 4.64° |

As it can be seen, even if the beam still maintain strong asymmetries in terms of beamwidths as compared to the boresight directed beam, the pointing angles have been significantly corrected. The ISCA method shows that a phase-only correction at BFN level allows to correct the beam mispointing, while the beam deviation factor and the beam shape variation within scanning depend strongly on the asymmetric behaviour of the offset system.

Now, as a criterion denominated “Single Feed Element (SFE) pattern” for optimizing the system in terms of geometry is to analyse the system behaviour by means of the following approach.

Replacing the feed array by a single feed element only it is possible to obtain a clear insight of the beam forming behaviour of the system. The sub reflector is invested by a low directive source producing a spherical wave broad beam, providing high illumination efficiency on the sub reflector with low edge taper levels. This in turn produces a very directive beam reflected by the sub reflector pointing towards the main reflector centre and after a second reflection a very large beam is produced in the far field zone. This large pattern is representative of the scanning behaviour of the system in the sense that all beams produced by the system fed by a phased array feed will exhibit maximum directivity levels whose envelope coincide with the single element beam pattern described above.

The single feed element (SFE) pattern is representative of the antenna behaviour if the following conditions hold:

1) the feed element is positioned at the phased array centre;
2) the distance to the sub reflector is chosen such to have an image point lying in the main reflector centre;
3) both the sub reflector and the main reflector are not oversized.
Point (1) insures that the most symmetric illumination of the sub reflector is provided, allowing the edge taper levels on the reflector to be as uniform as possible. Point (2) insures to have maximum illumination efficiency of the main reflector, according to [3]. To meet this condition the distance between the sub reflector and the feed element must be calculated as by equation (0.5). Point (3) guarantees that the magnifying character of the imaging system is preserved, for which M=D₁/D₂. Only for a directive source as an array the system is characterized by frequency invariance (as reported by Fitzgerald in [2]) and therefore also fixing the frequency but oversizing the reflectors for accommodating scan capability of the system does not change substantially the produced beams, unless the focal lengths of the parabolas stay unchanged. Oversizing the system fed by an array is necessary to reduce spillover effects, which arise if the feeding phased array is intended to scan. The SFE pattern has revealed to be a very useful reference pattern for evaluating the system performance, as it will be shown in the following simulation cases. It provides a method numerically effective
a) to anticipate and summarize the beam scanning behaviour in a large field of view without evaluating the single isolated spot or shaped beams and
b) to estimate the angular field of view of the antenna.
   The SFE pattern produced by the setup of FIG. 9 A, removing the array plane and leaving a single feed element at the array's centre position, is presented in FIG. 10. Due to the broad beam and reduced illumination efficiency on the large main reflector aperture, a PO based simulation produces high ripples. It is more convenient to adopt a GO approximation of the produced pattern. FIG. 10 superposes the PO and GO obtained patterns. As it can be seen, the GO simulation provides a fair interpolation of the more accurate PO simulation result, removing the simulation noise.

As it will be shown later, this GO obtained simulation result provides a good interpolation to the obtained beam patterns and therefore will be used as a figure of merit of the system performance.

The GO obtained SFE pattern is representative of the system behaviour in the sense, that a normalized set of directive beams (produced by a phased array feeding the system) will follow the same envelope as provided by the single SFE pattern. If the patterns in the FIG. 9A are normalized with respect to the highest beam and the maximum directivity is set to 0 dB, the SFE pattern of FIG. 10 can be also normalized to 0 dB and superimposed to the beam pattern. The result can be seen in the FIG. 11A where the produced beams follow fairly well the SFE pattern envelope. An even better accomplishment between scanned directive beams and the broad SFE pattern can be obtained for a set of directive beams for which the beam mispointing has been reduced. This can be obtained by different techniques, as for example the previously introduced ISCA non-linear phase taper. The normalized superposition of phase corrected beams is represented in the FIG. 11B, together with the SFE pattern.

The FIG. 11B provides a better insight into the main limitation of the offset system. Indeed a phase law can correct the pointing angles which can be tuned to exact pointing angles by a purely numeric approach, as for example through conjugate matching [11], but the beam enlargement is proportional to the asymmetric behaviour of the optics as represented by the envelope SFE pattern, and this envelope (so the scanning losses versus the scanning angle) does not change just adopting the derived non linear phase tapering. In the next paragraphs a procedure to modify the scanning losses will be introduced. A drawback of the GO-based SFE approximation is provided by the limited extension of reflectors, which produces sharp cuts of the pattern at certain angles, which are still within the FOV. This means that not all scanned beams can be fitted within the SFE pattern envelope.

According to the invention, an improvement on the beam shape in terms of beamwidth stability can be obtained by acting on the feed positions as a function of a desired conjugate points distribution. According to Dragone [3] an (approximate) ideal behaviour of the system can be obtained along the SCA analysis for an equivalent array of magnified image feed elements lying on a plane crossing the main reflector centre and perpendicular to its axial direction. To obtain this situation it is necessary to use a conformal array with all feed elements positioned as to provide a planar distribution of image points after second reflection with a central image point coinciding with the main reflector centre, for the maximum illumination efficiency condition [3]. In the following a general law is described for calculating conjugate points as a function of feed elements. Reversing this relation and setting as a boundary condition to have all conjugate points lying on a plane crossing the main reflector centre, the exact positions of the conformal array can be determined. For a confocal and coaxial parabolic offset imaging system the parabola axes are parallel with opposite directions. This means that the sub reflector reference system is translated with respect to the main reflector reference system of the quantity f₁+f₂ having all its directions opposite in sign and having both parabolas' focal points overlapping, according to FIG. 12. Within this frame the main reflector can be described as:

$${z}_{M} = \frac{{ρ}_{M}^{2}}{4 {f}_{1}} \qquad ( 4.1 )$$

and the sub reflector as:

$${z}_{s} = \frac{{ρ}_{s}^{2}}{4 {f}_{2}} \qquad ( 4.2 )$$

where:

$$\begin{matrix}{ρ}_{M} = \sqrt{{x}_{M}^{2} + {y}_{M}^{2}} & ( 4.3 ) \\ {ρ}_{S} = \sqrt{{x}_{S}^{2} + {y}_{S}^{2}} & ( 4.4 )\end{matrix}$$

with (x_{M},y_{M}) and (x_{S},y_{S}) being respectively the coordinates of the plane perpendicular to the axial direction of main reflector and sub reflector and f₁ and f₂ being respectively the focal lengths of main reflector and sub reflector. For each point on the parabolic main reflector (x_{M},y_{M},z_{M}) the radius of curvature can be calculated as:

r_{M}=f₁+z_{M} (4.5)

The angle u subtending the local normal of the considered point and the parabola axis equals:

$$u = a tan ( \frac{{ρ}_{M}}{2 {f}_{1}} ) \qquad ( 4.6 )$$

Analysing the system by an optical system approximation according to Brueggemann [4], for each main reflector point, characterized by u an equivalent sub reflector point with v=u will exist, since both reflectors are confocal. For each u the dual reflection point of the sub reflector is:

ρ_{S}=2f₂ tan(v) (4.7)

with a radius of curvature equal to:

r_{S}=f₂[1+tan²(v)] (4.8)

Applying this set of equations to the relations an analytical description of the equivalent feed elements as a function of desired conjugate points of the system can be obtained. A plane of conjugate points can be described in terms of (xₙ,yₙ) at a distance z=c within the main reflector reference system, where c is a constant and represents the position of the main reflector centre point along the parabola axial direction. From the knowledge of these points the equivalent feed positions can be obtained combining the relations (1.1) and (1.2) with the radii of curvature of the reflectors leading to:

$${z}_{f} = \frac{2 {r}_{1}^{2} {r}_{2} + 2 {r}_{1} {r}_{2}^{2} - {f}_{2} {r}_{1}^{2} - {f}_{1} {r}_{2}^{2} - {z}_{n} {r}_{2}^{2}}{{r}_{1}^{2}} \qquad ( 4.9 )$$

The (x_{f},y_{f}) positions of the array will be the same positions of the reflection points on the sub reflector and may be related to the positions of conjugate points by:

$$\begin{matrix}{x}_{f} = \frac{{x}_{n}}{M} & ( 4.10 ) \\ {y}_{f} = \frac{{y}_{n}}{M} & ( 4.11 )\end{matrix}$$

According to this equation a conformal parabolic array of elements can be calculated by the only knowledge of the positions of conjugate points and the focal lengths of the two reflectors f₁ and f₂.

In the following simulation a confocal and coaxial imaging system has been simulated according to following constraints:
f/D=1
M=3
max. scan range of θ=18° into both φ=0° and φ=180° directions Two simulations have been carried out in TICRA® GRASP by:
   1) feeding the system with a planar array, set at a distance to have its centre element imaged in the main reflector centre
   2) feeding the system with a conformal array, chosen as to have all conjugate points lying on a plane crossing the main reflector centre
   For case (1) 11 beams are simulated within the scan range by applying a linear phase progression on the array. For case (2) the same number of beams is obtained by applying a linear phase progression plus an additional parabolic phase taper to provide a planar equi-phase surface perpendicular to the pointing direction, produced by the parabolic conformal array. The results of the simulations for cases (1) and (2) are represented respectively in the FIG. 13A and in FIG. 13B.

Following observations can be done:
for beams scanned into positive directions and a limited number of beams scanned into negative directions case (2) produces beams whose beamwidth changes less with respect to case (1);
the scan loss between beams is unvaried in both cases (for same pointing angles) and is strongly asymmetric with respect to the boresight beam;
at large negative angles beams of case (2) are smeared out and merge with the side lobe pattern.

These observations show that:

1) the new produced beams guarantee an improved stability in terms of HPBWs, according to the theory presented based on the SCA analysis [3], proving that the choice of a planar array of conjugate points is beneficial;
2) however, keeping unchanged the reflector's geometry the scan loss behaviour is not modified (i.e. the envelope curve containing the peak gain values of the beam does not change), as predicted by the SFE pattern presented in FIGS. 11 A-B;
3) the strong scan loss in beams pointing at large negative angles depends on the asymmetric conformal array which produces an asymmetric variation of its equivalent aperture as a function of the pointing direction, getting smaller for beams pointed towards positive angles and larger for beams pointed towards negative angles along a parabolic law.

Another drawback of a strongly parabolic conformal array is represented by the inter-element blockage. These effects have not been taken into account in the current simulations, because they depend on the array technology.

In general it can be stated, that:
blockage effects of a parabolic array can be reduced by optimizing the array in terms of feed element diameters and inter-element spacing;
larger f/D ratio can reduce the equivalent focal length of the array and, therefore, reduce the blockage effects (since the parabolic array is becoming less curved);
at the same way larger magnification ratios M can improve this performance;

These modifications need to be traded off as a function of the FOV and scan range to be accommodated. Indeed the degrees of freedom on which to act remain quite low, as long no modification is applied to the reflector geometry.

These trade-offs are not the aim of the present invention, which is intended to establish the design procedures of an optimum imaging array and therefore are not discussed.

According to FIG. 14 and a first embodiment of the invention, an offset imaging antenna system 2 with compensated optical aberrations comprises a main reflector 4, a first sub reflector 6, a first feeding array 8 to illuminate or to be illuminated by the first sub reflector 6. The offset imaging antenna system 2 is configured to scan a beam electronically in a limited field of view or to generate a multi-beam coverage in a limited field of view. The main reflector 4 and the first sub reflector 6 are offset in an offset plane which is the plane of the FIG. 14, and are confocal by sharing a common focal point F. The main reflector 4 has a paraboloid shape, a main aperture, a main optical centre C, and a main bore-sight axis as illustrated by the arrow 7. The first sub reflector 6 has a paraboloid shape, a first sub reflector optical centre B and a first sub reflector bore-sight axis.

The first feeding array 8 comprises an arrangement of first feed array elements 10. The first feeding array has a curved shape 8 that corresponds to a first equivalent array 12 of first magnified image feed elements 14 lying on a plane 14 crossing the main optical centre C and perpendicular to the main bore-sight axis 7.

All the first feed array elements 10 are positioned as to provide a first planar distribution of the positions of the image feed elements 14 onto the first equivalent array 12 after a second reflection by the main reflector 4 with a first central image point coinciding with the main reflector optical centre C under a maximum illumination condition.

This first embodiment implements the improvement on the beam shape in terms of beamwidth stability as described here above by acting on the feed positions as a desired conjugate points distribution.

In this first embodiment, the offset imaging antenna system 2 comprises only one sub reflector and one feeding array.

Now, a further improvement carried out by the invention is described by introducing a new degree of freedom which modifies the reflector's geometry. The aim of this approach is to:

1) provide a more symmetric beam distribution;
2) permit to accommodate a less conformal feeding array.

A necessary condition that allows to have an exactly anastigmatic optical system for planar wave incidence along the parabolas' axis directions is that both reflectors share the common focal point.

A simple but important property has been identified which can be beneficial to improve the radiative performance of confocal reflectors: two or more paraboloid reflectors remain confocal even when the axes of the reflectors do not coincide provided that the focal points remain coincident. Introducing a tilt angle between sub and main reflector axes of the confocal imaging system, it can be shown that it is possible to obtain better beam performances within a limited field of view.

By tilting the sub reflector and the feed array with respect to the main reflector, the following observations can be done:

1) maintaining the same scan range an additional scan loss needs to be traded-off versus a more symmetric beam distribution;
2) beam shapes stability, for instance in terms of HPBW values, is improved;
3) beam mispointing is significantly reduced without applying a corrective phase taper on the feeding array;
4) a less conformal and thus more feasible array (in terms of blockage considerations and practical realisation) can be realised, still providing a plane of conjugate points crossing the main reflector centre.

The considerations which are done in the following strongly depend on the FOV to be covered and the scan range (in terms of scanned beamwidths) to be accommodated within this FOV. Each scenario requires different trade-off solutions. Therefore the following design procedures provide rules of thumb with respect to which the system should be optimised. In addition the design procedures represent a starting point for a possible successive numerical optimization depending on the specific application. It will be shown that the main improvement which can be achieved by exploiting the additional degree of freedom associated to the tilt between the reflector axes, associated with a deterministic relation determining the feed positions along a conformal array, provide good results in terms of the system's symmetry in scan behaviour and beam shape degradation. Scan losses must be successively traded off as a function of the reflector's f/D ratio.

The novelties of the proposed method are:
the realization of a tilted antenna system does not notably increase system complexity,
a first performance optimization is obtained quasi in real time avoiding more expensive techniques (as, for example, reflector shaping or introducing mechanisms or other elements like additional reflectors or microwave lens) which can be considered for a successive optimization step.

The following design procedure relies on two steps:

1) a geometrical approach, providing a more symmetric system behaviour (as represented by means of the SFE pattern);
2) an optical approach, which makes use of the high frequency approximation to take advantage of conjugate points regularization.

For the geometrical approach the main parameters of the dual reflector system are described as follows. FIG. 15 presents the confocal system within two reference systems in the offset plane. The (z, x) reference system has its z-axis coinciding with the main reflector axis and the (z′, x′) reference system has its z′-axis coinciding with the sub reflector axis. Both reference systems share the same origin F and are tilted by an angle φᵣ. The feed is represented by a planar array of size D₀, whose centre lies in z′=z₀ and x′=−h₀. The sub reflector rim is also of size D₀, centred in x′=−h₀. Its vertex is in z′=f₂.

Point B′=(z′ₘᵢₙ,x′ₘᵢₙ) represents the lower edge of the sub reflector rim, being l′=|x′ₘᵢₙ| the sub reflector clearance, while point C′=(zₘᵢₙ,xₘᵢₙ) represents the lower edge of the main reflector rim, being l=|xₘᵢₙ| the main reflector clearance.
The main reflector rim is of size D₁, centred in x=h₁. Its vertex is in z=f₁.

Note that for the initial design procedure no oversize has been considered. The magnification factor can be expressed as M=f₁/f₀ only for the coaxial case, for all other cases wᵣ #0 the magnification factor will be M=D₁/D₀≠f₁/f₀.

Two rays are traced through the system according to Snell's reflection laws, starting from the upper and lower end of the array plane (respectively from points A′ and A″), reflecting first on the sub reflector (respectively in points B′ and B″), then on the main reflector respectively in points C′ and C″) and then arriving on the aperture plane (respectively in points E′ and E″).

Applying a GO approximation, a plane wave arriving from the feed plane and having its equi-phase surface parallel to the feed plane will be converted by the sub reflector parabola to a spherical wave, concentrating in the common focal point, expanding again towards the main reflector and propagating as a plane wave towards the aperture plane. The spherical conversion region is represented in terms of GO by a ray cone whose angular aperture is obtained connecting the points B′ and B″ and F in the (z′, x′) or the cone starting from F and reaching the main reflector points in the points C′ and C″. The cone angular aperture is represented by Δ.

The lower boundaries of both the ray cones are respectively inclined with respect to the main and sub reflector reference systems by respectively an angle α and β, being α≠β for all φᵣ≠0.

The following relationships can be established for sizing the system according to a tilt angle:
the points B′=(z′ₘₐₓ,x′ₘₐₓ) and B″=(z′ₘᵢₙ,x′ₘᵢₙ) are related to the design parameters by the equations:

$$\begin{matrix}{x}_{max}^{′} = - {h}_{0} + {D}_{0} / 2 & ( 5.1 ) \\ {z}_{max}^{′} = {f}_{2} - \frac{{x}_{max}^{′ 2}}{4 {f}_{2}} & ( 5.2 ) \\ {x}_{min}^{′} = - {h}_{0} - \frac{{D}_{0}}{2} & ( 5.3 ) \\ {z}_{min}^{′} = {f}_{2} - \frac{{x}_{min}^{′ 2}}{4 {f}_{2}} & ( 5.4 )\end{matrix}$$

the points C″=(Zₘₐₓ, Xₘₐₓ) and C′=(zₘᵢₙ,xₘᵢₙ) are related to the design parameters by the equations:

$$\begin{matrix}{x}_{max} = {h}_{1} + {D}_{1} / 2 & ( 5.5 ) \\ {z}_{max} = \frac{{x}_{max}^{2}}{4 {f}_{1}} - {f}_{1} & ( 5.6 ) \\ {x}_{min} = {h}_{1} - {D}_{1} / 2 & ( 5.7 ) \\ {z}_{min} = \frac{{x}_{min}^{2}}{4 {f}_{1}} - {f}_{1} & ( 5.8 )\end{matrix}$$

the main reflector clearance (depending on both offset and aperture size) equals:

x_{cl}=h₁−D₁/2 (5.9)
the sub reflector clearance equals:

x′_{cl}=−h₀+D₀/2 (5.10)
the angles subtending the GO ray cone depend on the reflector clearances and can be derived as follows:

α=a cos {(4f₁²−x_{cl}²)/(4f₁²+x_{cl}²)} (5.11)

β=a cos {(4f₂²−x′_{cl}²)/(4f₂²+x′_{cl}²)} (5.12)

α′=a cos {(4f₁²−[x_{cl}+D₁]²)/(4f₁²+[x_{cl}+D₁]²)} (5.13)

β′=a cos {(4f₂²−[x′_{cl}+D₀]²)/(4f₂²+[x′_{cl}+D₀]²)} (5.14)

These parameters permit to calculate following angles:

Δ=α′−α=β′−β′ (5.15)

θ=α+π (5.16)

depending on which the main reflector focal length f₁ and sub refector focal length f₂ can be calculated as follows:

$$\begin{matrix}{f}_{1} = \frac{{D}_{1}}{4} [ \frac{cos ( Δ ) - cos ( 2 θ + Δ )}{sin ( θ + Δ ) - sin ( θ ) + sin ( Δ )} ] & ( 5.17 ) \\ {f}_{2} = \frac{{D}_{0}}{2} [ 1 - tan ( \frac{β}{2} ) tan ( \frac{Δ}{2} ) ] / tan ( \frac{Δ}{2} ) [ {tan}^{2} ( \frac{β}{2} ) + 1 ] & ( 5.18 )\end{matrix}$$

Note that focal lengths f₁ and f₂ are respectively referred to the (z,x) and the (z′, x′) reference system. Once the focal lengths are known, the main reflector and sub reflector clearances can be calculated as:

$$\begin{matrix}{x}_{cl} = 2 {f}_{1} tan [ \frac{{ϕ}_{r}}{2} + a tan ( \frac{{h}_{0}}{2 {f}_{2}} ) ] - {D}_{1} / 2 & ( 5.19 ) \\ {x}_{cl}^{′} = - 2 {f}_{2} tan [ - \frac{{ϕ}_{r}}{2} + a tan ( \frac{{h}_{1}}{2 {f}_{1}} ) ] + {D}_{0} / 2 & ( 5.20 )\end{matrix}$$

All these relations may be turned into design constraints as presented here above.

Depending on the FOV and scan range to be synthesized together with accommodation, dimension, weight and feasibility considerations, two primary strategies may be exploited for sizing the system by means of an optimum scan range. These strategies are dual from a geometrical point of view, but each strategy admits a different physical interpretation, such that the final design criterion has to be traded off among these strategies as a function of the system design and performance requirements.

The two design strategies are the following:

1. For an assigned main reflector aperture (aperture size D₁, focal length f₁ and clearance x_{cl}), dimensioning the sub reflector in terms of focal length f₂, clearance x′_{cl} or aperture size D₀ by varying φᵣ.
2. For an assigned sub reflector aperture (aperture size D₀, focal length f₂ and clearance x′_{cl}), dimensioning the main reflector in terms of focal length f₁, clearance x_{cl} or aperture size D₁ by varying φᵣ.
These two strategies lead to following constraints:
Fixing the main reflector permits to maintain comparable scan losses, while either the clearance, the focal length or the aperture size of the sub reflector are modified as a function of φᵣ.
Fixing the sub reflector permits to maintain a comparable scan range for the antenna, while either the clearance, the focal length or the aperture size of the main reflector are modified as a function of φᵣ.

The FOV and scan range requirements influence the design parameters and trade-offs that can be done with respect to the reflector parameters, by taking into account that:
higher clearances introduce larger scan losses, which can be reduced by larger f/D ratios;
modifying one aperture size with respect to the other will modify the magnification ratio of the system;
for each design strategy either the main reflector or the sub reflector have each one degree of freedom which can be exploited for compensating unwanted effects as illumination efficiency reduction or scan range reduction (as shown in the following relations);
the magnification ratio M does not depend anymore on the focal length ratio, as long the rotation angle φᵣ is different from zero.

The presented design strategies rely on a purely geometrical approach, which now must be merged with the optical approach, exploiting conjugate points of the system.

### The aim is to:

provide an optimum system in terms of conjugate points and SCA analysis;
provide a blockage free condition;
permit to accommodate a given set of beamwidths within a required FOV optimizing the pattern symmetry according to scan loss requirements. In terms of the optical optimization approach two different directions can be exploited:
   1. conjugate points can be modified by acting on the tilt angle φᵣ by considering a given feeding array;
   2. optimum feeding array positions can be calculated as a function of conjugate points φᵣ by considering also the tilt angle as an additional variable.

An alternative would be to consider a possible optical design lying in between the two introduced directions, trading off the benefits of a compromise between a more convenient position of both conjugate points and feed elements as a function of the tilt angle. Some example trade-offs are presented in the following simulation sets. As long as the two reflectors remain confocal, the validity of optical relations (cfr. Brueggemann [4]) hold. This means that conjugate points can be calculated for a given tilted confocal dual-reflector system illuminated by a known array or, dually, feed positions can be derived by the knowledge of a desired conjugate points distribution on the main reflector aperture, by means of following equations. These equations are derived by applying conjugate points theory to complex coordinates in reflector theory, as used by Brickell [12] in Geometrical. Optics. All definitions apply to the reference systems as defined in FIG. 15, with the only difference that the z-axis of the sub reflector reference system is now tilted by an amount φᵣ with respect to the main reflector reference system z-axis, by intersecting in the common point F.

$$\begin{matrix}{w}_{k}^{f} = {x}_{k}^{f} + i \cdot {y}_{k}^{f} & ( 6.1 ) \\ {u}_{k}^{f} = \frac{{w}_{k}^{f}}{2 {f}_{2}} & ( 6.2 ) \\ q = tan ( \frac{{ϕ}_{r}}{2} ) & ( 6.3 ) \\ {( {u}_{k}^{cp} )}^{*} = \frac{{u}_{k}^{f} - q}{1 + q \cdot {u}_{k}^{f}} & ( 6.4 ) \\ {w}_{k}^{cp} = 2 {f}_{1} \cdot {u}_{k}^{cp} & ( 6.5 ) \\ {x}_{k}^{f} = Re \{ {w}_{k}^{cp} \} & ( 6.6 ) \\ {y}_{k}^{f} = I m \{ {w}_{k}^{cp} \} & ( 6.7 )\end{matrix}$$

where:
(xₖ^{f},yₖ^{f}) is the positions of the k-th feed element on the perpendicular plane with respect to the sub reflector axis;
(xₖ^{cp},yₖ^{cp}) is the positions of the k-th conjugate point on the aperture plane of the main reflector (perpendicular to the main reflector axis);

As a successive degree of freedom, which can be exploited in system design, a successive tilt angle can be introduced. If the sub reflector axis is tilted by an amount φᵣ with respect to the main reflector axis, i.e. in the offset plane, it can also be tilted by an amount σᵣ in a plane which is perpendicular to the offset plane. By doing this it is possible to think of accommodating more sub reflectors sharing all the same main reflector focal point. This means that still the validity of optical relations (cfr. Brueggemann [4]) hold. For introducing a second tilt angle σᵣ, perpendicular to φᵣ, equation (6.8) has to be modified as:

$${( {u}_{k}^{cp} )}^{*} = \frac{{u}_{k}^{f} - q}{1 + q \cdot {u}_{k}^{f}} {e}^{- {jσ}_{r}} \qquad ( 6.9 )$$

Using equation (6.9) both a tilt angle in elevation and azimuth can be introduced, which means that all possible orientations of the sub reflector by maintaining the same common focal point can be exploited. By means of these relations the conjugate points theory can be applied as follows. The reflection points on the sub reflector (x₂^{inc},y₂^{inc}) and main reflector (x₁^{inc},y₁^{inc}), as defined within the sub reflector and main reflector reference system (cfr. figure [FIG. 14]), coincide respectively with the previously calculated (xₖ^{f},yₖ^{f}) and (xₖ^{cp},yₖ^{cp}) positions. The z-coordinates can be derived as follows:

$$\begin{matrix}{z}_{2}^{inc} = \frac{{( {x}_{2}^{inc} )}^{2} + {( {y}_{2}^{inc} )}^{2}}{4 {f}_{2}} & ( 6.10 ) \\ {z}_{1}^{inc} = \frac{{( {x}_{1}^{inc} )}^{2} + {( {y}_{1}^{inc} )}^{2}}{4 {f}_{1}} & ( 6.11 )\end{matrix}$$

Due to the geometrical properties of a parabola, each reflection point's distance to the respective focal point can be calculated as:

r₂^{inc}=f₂+z₂^{inc} (6.12)

r₁^{inc}=f₁+z₁^{inc} (6.13)

By the knowledge of these relations, the conjugate points can be obtained:

$${z}_{k}^{cp} = \frac{2 {( {r}_{1}^{inc} )}^{2} {r}_{2}^{inc} + 2 {{r}_{1}^{inc} ( {r}_{2}^{inc} )}^{2} - {{f}_{2} ( {r}_{1}^{inc} )}^{2} - {{f}_{1} ( {r}_{2}^{inc} )}^{2} - {{z}_{k}^{f} ( {r}_{1}^{inc} )}^{2}}{{( {r}_{2}^{inc} )}^{2}} \qquad ( 6.14 )$$

where zₖ^{f} is the known position of the feed element along the sub reflector axis. Viceversa, if the feed element position is unknown and the desired z-coordinate of the conjugate point is given (for example the main reflector centre z-coordinate), equation (6.14) can be resolved for duality as a function of zₖ^{f}:

$${z}_{k}^{f} = \frac{2 {( {r}_{1}^{inc} )}^{2} {r}_{2}^{inc} + 2 {{r}_{1}^{inc} ( {r}_{2}^{inc} )}^{2} - {{f}_{2} ( {r}_{1}^{inc} )}^{2} - {{f}_{1} ( {r}_{2}^{inc} )}^{2} - {{z}_{k}^{cp} ( {r}_{2}^{inc} )}^{2}}{{( {r}_{1}^{inc} )}^{2}} \qquad ( 6.15 )$$

This proves that also in case confocal reflectors with a tilt angle between the reflectors axes, feed element positions can be calculated as a function of the reflector geometry only and are proportional to the tilt angle φᵣ as:

z_{f}=f₂+16f₁²{A+B+C−D−E}/(ρₙ²+4f₁²)² (6.16)

where

$$A = {z}_{n} {{f}_{2}^{2} [ {tan}^{2} [ a tan ( \frac{ρ n}{2 {f}_{2}} ) - \frac{{ϕ}_{r}}{2} ] + 1 ]}^{2} ;$$

$$B = {f}_{1} {{f}_{2}^{2} [ {tan}^{2} [ a tan ( \frac{ρ n}{2 {f}_{2}} ) - \frac{{ϕ}_{r}}{2} ] + 1 ]}^{2} ;$$

$$C = \frac{{{f}_{2} ( {ρ}_{n}^{2} + 4 {f}_{1}^{2} )}^{2}}{16 {f}_{1}^{2}} ;$$

$$D = \frac{{f}_{2} [ {tan}^{2} [ a tan ( \frac{ρ n}{2 {f}_{2}} ) - \frac{{ϕ}_{r}}{2} ] + 1 ] {( {ρ}_{n}^{2} + 4 {f}_{1}^{2} )}^{2}}{8 {f}_{1}^{2}} ;$$

$$E = \frac{{{f}_{2}^{2} [ {tan}^{2} [ a tan ( \frac{ρ n}{2 {f}_{2}} ) - \frac{{ϕ}_{r}}{2} ] + 1 ]}^{2} ( {ρ}_{n}^{2} + 4 {f}_{1}^{2} )}{2 {f}_{1}} ;$$

f₁ and f₂ are the focal lengths of, respectively, the main and sub reflector, ρₙ=\sqrt{xₙ²+yₙ²} the conjugate points polar coordinate with (xₙ,yₙ) the positions of the conjugate points on a perpendicular plane to the main reflector axial direction. If conjugate points are defined on a periodic lattice, the corresponding feeding array will not have a periodic lattice unless φᵣ=0. By the knowledge of ρₙ, the equivalent (x_{f},y_{f}) positions are obtained as:

$${ρ}_{f} = 2 {f}_{2} tan ( a tan ( \frac{ρ n}{2 {f}_{1}} ) - \frac{{ϕ}_{r}}{2} ) \qquad ( 6.17 )$$

with ρ_{f}=\sqrt{x_{f}²+y_{f}²}.

Some design procedures are described now with different strategies.

### Design Criterion for Strategy 1:

1. Main reflector characteristic parameters (D₁,x_{cl}, f₁) are selected according to the required FOV and beam characteristics.
2. Angles, according to FIG. 15 are derived as follows:

α=a cos {(4f₁²−x_{cl}²)/(4f₁²+x_{cl}²)} (7.1)

α′=a cos {(4f₁²−[x_{cl}+D₁]²)/(4f₁²+[x_{cl}+D₁]²)} (7.2)

Δ=α′−α (7.3)

3. The tilt angle between the reflectors' axes φᵣ shall be maximised, according to previous statement.
4. Angles subtending the projected rays impinging on the sub reflector edges are obtained by:

β=α−φᵣ (7.4)

β′=β+Δ (7.5)

5. The sub reflector characteristic parameters (D₀,x′_{cl}, f₂) can now be calculated according to three possible directions. In facts, since the angular relations (β,β′) relate the three sub reflector characteristic parameters to each other the resulting system is incomplete leaving one degree of freedom in system design. This degree of freedom can be chosen by the antenna designer according to FOV and scan range requirements, giving rise to three possible optimization directions:
a) Specifying a desired D₀
b) Specifying a desired x′_{cl}
c) Specifying a desired f₂
Optimizing the system along direction a) following relations hold:

$$\begin{matrix}{f}_{2} = [ ( \frac{{D}_{0}}{2} ) \sqrt{\frac{1 + cos ( {β}^{′} )}{1 - cos ( {β}^{′} )}} ] / [ 1 - \sqrt{\frac{1 + cos ( {β}^{′} )}{1 - cos ( {β}^{′} )}} \sqrt{\frac{1 - cos ( β )}{1 + cos ( β )}} ] & ( 7.6 ) \\ {x}_{cl} = [ {D}_{0} \sqrt{\frac{1 + cos ( {β}^{′} )}{1 - cos ( {β}^{′} )}} \sqrt{\frac{1 - cos ( β )}{1 + cos ( β )}} ] / [ 1 - \sqrt{\frac{1 + cos ( {β}^{′} )}{1 - cos ( {β}^{′} )}} \sqrt{\frac{1 - cos ( β )}{1 + cos ( β )}} ] & ( 7.7 )\end{matrix}$$

Optimizing the system along direction b) following relations hold:

$$\begin{matrix}{D}_{0} = {x}_{cl} [ 1 - \sqrt{\frac{1 + cos ( {β}^{′} )}{1 - cos ( {β}^{′} )}} \sqrt{\frac{1 - cos ( β )}{1 + cos ( β )}} ] / \sqrt{\frac{1 + cos ( {β}^{′} )}{1 - cos ( {β}^{′} )}} \sqrt{\frac{1 - cos ( β )}{1 + cos ( β )}} & ( 7.8 ) \\ {f}_{2} = \frac{{x}_{cl}}{2} \sqrt{\frac{1 + cos ( β )}{1 - cos ( β )}} & ( 7.9 )\end{matrix}$$

Optimizing the system along direction c) following relations hold:

$$\begin{matrix}{D}_{0} = 2 {f}_{2} [ 1 - \sqrt{\frac{1 + cos ( {β}^{′} )}{1 - cos ( {β}^{′} )}} \sqrt{\frac{1 - cos ( β )}{1 + cos ( β )}} ] \sqrt{\frac{1 - cos ( {β}^{′} )}{1 + cos ( {β}^{′} )}} & ( 7.10 ) \\ {x}_{cl} = 2 {f}_{2} \sqrt{\frac{1 - cos ( β )}{1 + cos ( β )}} & ( 7.11 )\end{matrix}$$

The design strategy 2, starting from a fixed sub reflector set of characteristic parameters and designing a main reflector according to a desired tilt angle, can be expressed as follows.

### Design Criterion for Strategy 2:

1. Sub reflector characteristic parameters (D₀,x′_{cl}, f₂) are selected according to the required FOV and beam characteristics.
2. Angles, according to FIG. 15 are derived as follows:

β=a cos {(4f₂²−x′_{cl}²)/(4f₂²+x′_{cl}²)} (7.12)

β′=a cos {(4f₂²−[x′_{cl}+D₀]²)/(4f₂²+[x′_{cl}+D₀]²)} (7.13)

Δ=β′−β (7.14)

3. The tilt angle between the reflectors' axes φᵣ shall be maximised, according to previous statement.
4. Angles subtending the projected rays impinging on the main reflector edges are obtained by:

α=β+φᵣ (7.15)

α′=α+Δ (7.16)

5. The main reflector characteristic parameters (D₁,x_{cl}, f₁) can now be calculated as according to three possible directions. In facts, since the angular relations (α,α′) relate the three sub reflector characteristic parameters to each other the resulting system is incomplete leaving one degree of freedom in system design. This degree of freedom can be chosen by the antenna designer according to FOV and scan range requirements, giving rise to three possible optimization directions:
a) Specifying a desired D₁
b) Specifying a desired x_{cl}
c) Specifying a desired f₁
Optimizing the system along direction a) following relations hold:

$$\begin{matrix}{f}_{1} = [ ( \frac{{D}_{1}}{2} ) \sqrt{\frac{1 + cos ( {α}^{′} )}{1 - cos ( {α}^{′} )}} ] / [ 1 - \sqrt{\frac{1 + cos ( {α}^{′} )}{1 - cos ( {α}^{′} )}} \sqrt{\frac{1 - cos ( α )}{1 + cos ( α )}} ] & ( 7.16 ) \\ {x}_{cl} = [ {D}_{1} \sqrt{\frac{1 + cos ( {α}^{′} )}{1 - cos ( {α}^{′} )}} \sqrt{\frac{1 - cos ( α )}{1 + cos ( α )}} ] / [ 1 - \sqrt{\frac{1 + cos ( {α}^{′} )}{1 - cos ( {α}^{′} )}} \sqrt{\frac{1 - cos ( α )}{1 + cos ( α )}} ] & ( 7.17 )\end{matrix}$$

Optimizing the system along direction b) following relations hold:

$$\begin{matrix}{D}_{1} = {x}_{cl} [ 1 - \sqrt{\frac{1 + cos ( {α}^{′} )}{1 - cos ( {α}^{′} )}} \sqrt{\frac{1 - cos ( α )}{1 + cos ( α )}} ] / \sqrt{\frac{1 + cos ( {α}^{′} )}{1 - cos ( {α}^{′} )}} \sqrt{\frac{1 - cos ( α )}{1 + cos ( α )}} & ( 7.19 ) \\ {f}_{1} = \frac{{x}_{cl}}{2} \sqrt{\frac{1 + cos ( α )}{1 - cos ( α )}} & ( 7.20 )\end{matrix}$$

Optimizing the system along direction c) following relations hold:

$$\begin{matrix}{D}_{1} = 2 {f}_{1} [ 1 - \sqrt{\frac{1 + cos ( {α}^{′} )}{1 - cos ( {α}^{′} )}} \sqrt{\frac{1 - cos ( α )}{1 + cos ( α )}} ] \sqrt{\frac{1 - cos ( {α}^{′} )}{1 + cos ( {α}^{′} )}} & ( 7.21 ) \\ {x}_{cl} = 2 {f}_{1} \sqrt{\frac{1 - cos ( α )}{1 + cos ( α )}} & ( 7.22 )\end{matrix}$$

Along these design strategies, and by taking into account of the properties of the previously described optical approach, a tilted configuration with an optimum tilt angle according to requirements can be dimensioned. The dimensioning criteria must take into account:
FOV and scan range requirements;
Accommodation requirements;
Blockage avoidance.

As stated previously the presented method represents a starting point and a rule of thumb collection for a successive numerical optimization of an imaging system as a function of all system and performance constraints to be considered. In the following a number of example simulations have been done by dimensioning the system along the specified design procedures to show how different requirements influence system design.

According to FIG. 16 and a second embodiment of the invention, an offset imaging antenna system 102 with compensated optical aberrations comprises identically as in FIG. 14, the main reflector 4 and the first sub reflector 6.

The offset imaging antenna system 102 of FIG. 16 differs from the offset imaging antenna system 2 of FIG. 14 in that the frame (z′, x′) of the first sub reflector 6 as described in FIG. 15 is rotated in the offset plane around the common focal point in respect of the frame (z, x) of the main reflector 4 along the clockwise direction by a first elevation tilt angle φᵣ.

The offset imaging antenna system 102 of FIG. 16 differs also from the offset imaging antenna system 2 of FIG. 14 in that it comprises a feeding array 108 to illuminate or to be illuminated by the first sub reflector 6 has a modified curved shape since the conjugation law has changed by modifying the relative orientation between the main reflector and the first sub reflector.

By choosing a suitable tilt angle φᵣ, the magnified array of the conjugated points is kept as flat as possible and, at the same time, the feeding array as perpendicular as possible to the axis of the sub reflector and as parallel as possible with respect to the surface of the sub reflector. Thus the degree of curvature of the first feeding array 108 is decreased, which improves the manufacturability of the first feeding array 108.

This second embodiment also implements the improvement on the beam shape in terms of beamwidth stability as described here above.

A tilting configuration between a main reflector and a first sub reflector according to the invention can be generalized as follows.

The main reflector has a main reference frame centered on the common focal point with a first main axis z defined by the main bore-sight axis, a second main axis x, contained in the plane including the main focal axis passing through the main optical centre and the common focal point, and directly perpendicular to the first main axis z, a third main axis y defined so as the first, second, third main axis (x,y,z) form a directly oriented frame.

The first sub reflector has a first sub reflector frame centered on the common focal point with a first first sub reflector axis z′ defined by the opposite of the first sub reflector bore-sight axis, a second first sub reflector axis x′, contained in the plane including the first sub reflector axis passing through the first sub reflector optical centre and the common focal point, and directly perpendicular to the first first sub reflector axis z′, a third first sub reflector axis y′ defined so as the first, second, third axis first sub reflector (x′,y′,z′) form a directly oriented frame.

while keeping the confocality between the main reflector and the first sub reflector, the main frame and the first sub reflector frame have different orientations, and the reciprocal relative orientation of the main and first sub reflector frames is determined so that the performance of the antenna is improved in terms of:
increasing the symmetry of the beam gain distribution while limiting an additional scan loss over a scan range, and/or,
increasing the beam shapes stability, and/or
reducing the beam mispointing without applying phase taper on the feeding array; and/or
decreasing the degree of curvature of the feeding array,
   in view of a reference configuration wherein the first, second, third main axis, x, y, z of the main reference frame and the first, second, third first sub reflector axis x′, y′, z′ of the first sub reflector frame are respectively the same.

As a first variant of the second embodiment, departing from the reference configuration as defined in FIG. 14, departing from the reference configuration, the first sub reflector has been tilted around the second main axis x by a second azimuth tilt angle σᵣ, defined as the relative angle between the first main reflector axis z and the first first sub reflector axis z′, and between the third main reflector axis y and the third first sub reflector axis y′, so that the reciprocal relative orientation of the main and first sub reflector frames is defined only by the second azimuth angle σᵣ.

As a second variant of the second embodiment, departing from the reference configuration as defined in FIG. 14, the first sub reflector has been firstly tilted around the third main axis y by a third elevation tilt angle φᵣ defined as the relative angle between the second main reflector axis x and the second first sub reflector axis x′, and successively tilted around the second main axis x by a fourth azimuth tilt angle σᵣ, defined as the relative angle between the third main reflector axis y and the third first sub reflector axis y′, so that the reciprocal relative orientation of the main reflector frame and the first sub reflector frame is defined by the third elevation tilt angle φᵣ and the fourth azimuth angle σᵣ.

According to FIG. 17A and a third embodiment an offset antenna system 302 comprises a main reflector 304, a first sub reflector 306, a second sub reflector 307, a first feeding array 308 to illuminate or to be illuminated by the first sub reflector 306, a second feeding array 309 to illuminate or to be illuminated by the second sub reflector 307.

The first sub reflector 306 and the second sub reflector 307 are offset in respect of the main reflector 304. All the reflectors are confocal by sharing a common focal point F. The main reflector 304 has a paraboloid shape, a main aperture, a main optical centre C, and a main bore-sight axis. The first sub reflector 306 has a paraboloid shape, a first sub reflector optical centre B1 and a first sub reflector bore-sight axis. The second sub reflector 307 has a paraboloid shape, a second sub reflector optical centre B2 and a second sub reflector bore-sight axis.

Here, departing from a same reference offset configuration, the first sub reflector and the second sub reflector are respectively tilted in azimuth apart the common offset plane in respect of the main frame as defined in FIG. 16.

The first sub reflector 306 and the first feed array 308 are configured for transmitting at a first frequency, while the second sub reflector 307 and the second feed array 309 are configured for receiving at a second frequency.

The first feeding array 308 comprises an arrangement of first feed array elements. The first feeding array 308 has a curved shape that corresponds to a first equivalent array of first magnified image feed elements lying on a plane crossing the main optical centre C and perpendicular to the main bore-sight axis.

All the first feed array elements are positioned as to provide a first planar distribution of the positions of the image feed elements onto the first equivalent array after a second reflection by the main reflector 304 with a first central image point coinciding with the main reflector optical centre C under a maximum illumination condition.

The second feed array 309 comprises an arrangement of second feed array elements. The second feeding array 309 has a curved shape that corresponds to a second equivalent array of first magnified image feed elements lying on the plane crossing the main optical centre C and perpendicular to the main bore-sight axis.

All the second feed array elements positioned as to provide a second planar distribution of the positions of the image feed elements onto the second equivalent array after a second reflection by the main reflector 304 with a first central image point coinciding with the main reflector optical centre C under a maximum illumination condition.

As an example, the first feed array 308 is configured here to generate a transmit coverage while the second feed array 309 is configured to generate a receive coverage.

More generally, an offset antenna system according to the third embodiment of the invention can be contemplated as having a main reflector, a plurality of sub reflectors offset in respect of the main reflector, and a plurality of feeding arrays associated on a one per one basis to a unique and different sub reflector, the shape of each feeding array following the design rules of the invention.

As a variant of the third embodiment and according to FIG. 17B, an offset antenna system 352 comprises a main reflector 354, a single sub reflector 356, a first feeding array 358 to illuminate or to be illuminated by the single share sub reflector 356 and a second feeding array 359 to illuminate or to be illuminated by the same sub reflector 356.

As an example, the first feed array 358 is configured to generate a transmit coverage while the second feed array 359 is configured to generate a receive coverage.

More generally, an offset antenna system according to the third embodiment of the invention and its variant can be contemplated as having a main reflector, at least one sub reflector offset in respect of the main reflector, and a plurality of feeding arrays associated to one or several sub reflectors, the shape of each feeding array following the design rules of the invention.

As a fourth embodiment, a confocal dual-reflector imaging antenna according to the invention can be fed by a sparse array for improving the SLL of the pattern. In the following simulations carried out in TICRA® GRASP the performance of an imaging setup is compared to a large DRA. In particular the imaging setup is considered either as classical confocal and coaxial imaging system, either by introducing the novelties related to conjugate points theory as explained in the following. The sparse arrays to be simulated are presented in FIGS. 18 A-B, their setup is based on design procedures presented in [13].

Both sparse arrays describe a circular aperture of 100λ with λ=0.015 m. In the first case illustrated in FIG. 18A, the array is composed of 394 feed elements with a diameter equal to 3λ, while in the second case illustrated in FIG. 18B the array is composed of 116 feed elements with a diameter equal to 6λ. For both arrays the power patterns have been evaluated by means of a PO simulation for 11 beams scanned evenly from −3° to 3° applying a linear phase progression on the array for the following cases:

I) An isolated planar direct radiating array (i.e. an array used without any reflector);
II) an imaging array with a magnification factor M=3 and illuminated by a planar sparse array with all sizes and dimensions reduced by a factor 3 with respect to the array isolated;
III) an imaging array with a magnification factor M=3 and illuminated by a conformal feeding array whose conjugate points coincide with the points defining the isolated planar sparse array on the aperture plane of the main reflector;
IV) same case as (III) by introducing also a tilt angle between the main reflector and sub reflector axis.

The imaging system has been sized to avoid blockage and forward spill over to occur, the f/D ratio of the main reflector has been chosen equal to 2 and the array has been positioned at a distance such to have the central conjugate point lying in the main reflector centre. The sparse isolated planar direct radiating arrays produce the following patterns when pointing at the boresight direction as shown in FIGS. 19 A-B.

FIGS. 20 A-D show respectively the pattern results for the 4 cases (I, II, III, IV) related to the sparse array of 394 elements and FIGS. 21 A-D are related respectively to the 4 cases (I, II, III, IV) with the 116 elements sparse array. The patterns are represented in the respective offset planes of the imaging systems. Although the isolated direct radiating array provides the lowest scan losses, the simulations show that by means of an imaging dual-reflector system the pattern which approximates most likely the performance of the DRA is the imaging system making use of a conformal array whose phase centres are chosen such to provide a planar equivalent magnified array on the main reflector aperture. In addition the degree of freedom of sub reflector tilt permits to better symmetrize the pattern. Tables 4 and 5 compare respectively the performances in terms of maximum directivity, half power beamwidth and pointing angle for the simulations with the 394 elements sparse array and the simulations with the 116 elements sparse array.

TABLE 4
Performance comparison for the 4 simulations of the 394 elements sparse array

| | Scan [°] | | | | | | | | | | |
|---|---|---|---|---|---|---|---|---|---|---|---|
| | −2.5 | −2 | −1.5 | −1 | −0.5 | 0 | 0.5 | 1 | 1.5 | 2 | 2.5 |
| Dₘₐₓ [dB] | 39.58 | 39.85 | 40.06 | 40.22 | 40.31 | 40.33 | 40.31 | 40.22 | 40.06 | 39.85 | 39.58 |
| HPBW [°] | 0.34 | 0.34 | 0.34 | 0.34 | 0.34 | 0.34 | 0.34 | 0.34 | 0.34 | 0.34 | 0.34 |
| Point [°] | −2.50 | −2.00 | −1.50 | −1.00 | −0.5 | 0.00 | 0.50 | 1.00 | 1.50 | 2.00 | 2.50 |
| Dₘₐₓ [dB] | 39.96 | 40.47 | 40.74 | 40.79 | 40.72 | 40.58 | 40.29 | 39.89 | 39.46 | 38.86 | 38.12 |
| HPBW [°] | 0.30 | 0.30 | 0.30 | 0.31 | 0.32 | 0.33 | 0.35 | 0.38 | 0.40 | 0.43 | 0.47 |
| Point [°] | −2.26 | −1.84 | −1.40 | −0.95 | −0.49 | 0.00 | 0.51 | 1.05 | 1.63 | 2.24 | 2.90 |
| Dₘₐₓ [dB] | 39.54 | 40.34 | 40.66 | 40.77 | 40.75 | 40.58 | 40.30 | 39.98 | 39.51 | 39.09 | 38.63 |
| HPBW [°] | 0.45 | 0.39 | 0.36 | 0.34 | 0.33 | 0.33 | 0.34 | 0.34 | 0.35 | 0.35 | 0.36 |
| Point [°] | −2.66 | −2.08 | −1.53 | −1.00 | −0.50 | 0.00 | 0.50 | 1.00 | 1.51 | 2.03 | 2.55 |
| Dₘₐₓ [dB] | 39.47 | 39.96 | 40.29 | 40.55 | 40.62 | 40.54 | 40.40 | 40.13 | 39.72 | 39.30 | 38.79 |
| HPBW [°] | 0.38 | 0.37 | 0.36 | 0.34 | 0.34 | 0.34 | 0.34 | 0.34 | 0.35 | 0.36 | 0.36 |
| Point [°] | −2.60 | −2.05 | −1.52 | −1.00 | −0.50 | 0.00 | 0.50 | 1.00 | 1.51 | 2.03 | 2.55 |

TABLE 5
Performance comparison for the 4 simulations of the 116 elements sparse array

| | Scan [°] | | | | | | | | | | |
|---|---|---|---|---|---|---|---|---|---|---|---|
| | −2.5 | −2 | −1.5 | −1 | −0.5 | 0 | 0.5 | 1 | 1.5 | 2 | 2.5 |
| Dₘₐₓ [dB] | 32.58 | 33.74 | 34.61 | 35.22 | 35.58 | 35.69 | 35.58 | 35.22 | 34.61 | 33.74 | 32.58 |
| HPBW [°] | 0.33 | 0.33 | 0.33 | 0.33 | 0.33 | 0.33 | 0.33 | 0.33 | 0.33 | 0.33 | 0.33 |
| Point [°] | −2.50 | −2.00 | −1.50 | −1.00 | −0.50 | 0.00 | 0.50 | 1.00 | 1.50 | 2.00 | 2.50 |
| Dₘₐₓ [dB] | 32.86 | 34.25 | 35.15 | 35.64 | 35.83 | 35.80 | 35.40 | 34.80 | 33.84 | 23.60 | 31.04 |
| HPBW [°] | 0.29 | 0.29 | 0.29 | 0.30 | 0.32 | 0.33 | 0.35 | 0.37 | 0.40 | 0.43 | 0.46 |
| Point [°] | −2.26 | −1.83 | −1.40 | −0.95 | −0.48 | 0.00 | 0.51 | 1.05 | 1.62 | 2.24 | 2.88 |
| Dₘₐₓ [dB] | 31.26 | 33.64 | 34.90 | 35.58 | 35.87 | 35.76 | 35.44 | 34.83 | 34.04 | 33.07 | 31.93 |
| HPBW [°] | 0.45 | 0.38 | 0.36 | 0.34 | 0.33 | 0.33 | 0.33 | 0.34 | 0.34 | 0.35 | 0.36 |
| Point [°] | −2.65 | −2.07 | −1.52 | −1.00 | −0.50 | 0.00 | 0.50 | 1.00 | 1.51 | 2.02 | 2.55 |
| Dₘₐₓ [dB] | 31.94 | 33.49 | 34.61 | 35.37 | 35.72 | 35.79 | 35.53 | 34.98 | 34.20 | 33.15 | 31.93 |
| HPBW [°] | 0.37 | 0.36 | 0.35 | 0.34 | 0.34 | 0.33 | 0.33 | 0.34 | 0.34 | 0.35 | 0.36 |
| Point [°] | −2.58 | −2.04 | −1.51 | −1.00 | −0.50 | 0.00 | 0.50 | 1.00 | 1.50 | 2.02 | 2.55 |

As a matter of comparison, a periodic array with a 100λ aperture produces grating lobes within the FOV at following angles with respect to the main beam direction:
at ca. 19.5° with a 3λ spacing
at ca. 9.6° with a 6λ spacing

One beam is shown every two beamwidths for a FOV extending from θ=−5° to θ=5° in the offset plane. The patterns shown for the isolated direct radiating array are equal in all planes due to the circular symmetry of the array. The grating lobe reduction provided by sparsity can be appreciated in the first graph of FIGS. 20 A-D and FIGS. 21 A-D. Grating lobes appear at ca. −30 dB with respect to the main beam in the boresight case and ca. −25 dB with respect to the main beam in the edge of coverage cases for the 394 elements array and at ca. −25 dB with respect to the main beam in the boresight case and ca. −15 dB with respect to the main beam in the edge of coverage cases for the 116 elements array. The same levels are maintained also for the imaging systems cases. While the conventional imaging antenna system shows typical asymmetries due to aberrations, a more symmetrical pattern is obtained by feeding the system by means of a conformal array. In addition the most symmetric case is obtained by exploiting also the additional degree of freedom provided by the sub reflector axis tilt. Comparing the graphs of FIGS. 20 A-D and FIGS. 21 A-D, it can be seen that exploiting both the degrees of freedom (i.e. conjugate points and rotation axis tilt between the sub reflector and main reflector axes) the produced pattern exhibits the best matching with the pattern of the isolated sparse direct radiating array. A higher scan loss is experienced, which can be quantified below 1 dB for both sparse array configurations on the beams at maximum scan angle, while in both cases the feeding array is exactly three times smaller as compared to the direct radiating array.

Some simulation technical results of performance of the offset imaging antenna system are now presented.

### Simulation 1:

The aim of this simulation is to show how the beam symmetry of an offset confocal dual-reflector system is increased by means of a reflector axes tilt. The simulation is carried out by means of a GO technique by simulating the system fed by a single feed element to obtain the SFE pattern. The system has been set-up along “strategy 1” (as presented in the previous chapter) by fixing the system magnification as a required constraint for a typical Ka-band Telecom scenario.

The fixed main reflector characteristic parameters are:
D₁=100λ
x_{cl}=150λ
f₁=100λ
   and the magnification constraint is M=3 which in turn fixes the sub reflector aperture:
D₀=D₁/M=33.33λ
   The feed elements of the array are ideal fundamental mode circular waveguides with radius:
r_{f}=λ/2
   The main reflector clearance x_{cl} is sufficiently large to permit to accommodate the entire tilt range, avoiding blockage for a range of tilt angles equal to:
0°<φᵣ<75°
   For each tilt angle φᵣ a new sub reflector focal length f₂ and clearance x′_{cl} are calculated along the previously introduced design criteria and the results are reported in Table 6. In addition the new feed element distance h_{f} from the sub reflector axis and the distance from the sub reflector l_{f} (as measured parallel to the sub reflector axis) are displayed for 6 cases within the specified tilt range. All distances are expressed in metres [m]. Each numerical value has been rounded to second decimal.

TABLE 6
Numerical results for the system design

φᵣ

| | 0° | 15° | 30° | 45° | 60° | 75° |
|---|---|---|---|---|---|---|
| f₂ | 0.5 | 0.63 | 0.75 | 0.85 | 0.93 | 0.96 |
| x′_{cl} | 0.75 | 0.71 | 0.6 | 0.44 | 0.22 | 0.06 |
| h_{f} | 1 | 0.97 | 0.86 | 0.7 | 0.5 | 0.34 |
| l_{f} | 1.33 | 1.33 | 1.33 | 1.32 | 1.32 | 1.32 |

According to these 6 cases the SFE patterns have been simulated in TICRA® GRASP by means of a GO analysis and are superposed in FIG. 22 along a spherical cut in the φ=0° (offset) plane.
The simulation results show that higher cp, values provide:
1) more symmetric SFE patterns with respect to boresight;
2) overall directivity reduction leading to a more equal power distribution along the offset plane;
3) maximum directivity moving towards boresight direction.
The comparison between numerical results within the two extreme cases φᵣ=0° (reference case) and φᵣ=75° (maximum tilt), shows that:
a maximum directivity reduction of less than 0.80 dB
an overall directivity variation measured at θ=3° with respect to maximum directivity of ca. 2.9 dB for φᵣ=0° and ca. 0.7 dB for φᵣ=75°
   The most important conclusions which can be done by means of these results are:
the reflector axes tilt angle provides no directivity increase, but a more symmetric power distribution;
a symmetric power distribution leads to less variations in terms of beam characteristics, i.e. more uniform beam shape and beam level distribution.

Representing the SFE patterns for φ=0° and φ=75° on a (u,v) grid in far zone permits to appreciate the symmetry increase offered by acting on the reflector's geometry. In FIG. 23, the two cases are overlapped by means of a beam contour plot at 1 dB below maximum directivity is shown. This shows that the system symmetry increase does not affect only the offset plane (v=0).

### Simulation 2:

The aim of this simulation is to show how for an imaging system with a planar conjugate points distribution on the main reflector aperture, the equivalent focal length of a parabolic conformal array can be significantly enlarged by tilting the reflector axes.
This provides an array with the following characteristics:
more feasible accommodation;
less equivalent aperture variation when scanning;
reduction of inter-element blockage effects.
   The main reflector characteristic parameters for this simulation are:
D₁=100λ
x_{cl}=120λ
f₁=100λ
   Three cases are simulated for:
φᵣ=0°
φᵣ=30°
φᵣ=45°
   and the system magnification has been fixed to M=3.
   The sub reflector has been sized along the previously presented design criteria and the desired conjugate points plane crosses the main reflector in its centre point. System data for the simulation is presented in Table 7. Both reflectors have been oversized to accommodate the entire scan range reducing spillover, according to a GO ray-tracing criterion as follows.
   For φᵣ=0°:
the main reflector dish has been oversized by 213.33%
the sub reflector dish has been oversized by 280%
   For φᵣ=30°:
the main reflector dish has been oversized by 173.33%
the sub reflector dish has been oversized by 280%
   For φᵣ=45°:
the main reflector dish has been oversized by 173.33%
the sub reflector dish has been oversized by 280%

TABLE 7
Imaging system setups of the simulations

| | | | |
|---|---|---|---|
| φᵣ | 0° | 30° | 45° |
| f₂ | 0.5 m | 0.7 m | 0.78 m |
| x′_{cl} | 0.6 m | 0.4 m | 0.23 m |
| central array | x = −0.85 m | x = −0.66 | x = −0.5m |
| element position | y = 0 m | y = 0 m | y = 0 m |
| | z = −1.01 m | z = −0.6 m | z = −0.45 m |
| central image | x = 2.55 m | x = 2.55 m | x = 2.55 m |
| point position | y = 0 m | y = 0 m | y = 0 m |
| | z = −0.42 m | z = −0.42 m | z = −0.42 m |

The simulation shows that in all cases the obtained conformal array follows a parabolic law whose equivalent focal length is proportional to the tilt angle f_{eq}∝φᵣ. This suggests that when considering the system in terms of conjugate points and corresponding conformal array, admitting a high frequency optical approximation, the tilt angle φᵣ shall be maximised. The equivalent focal lengths for the three arrays are:
φᵣ=0° in case of a conformal array with f_{0°}=0.19
φᵣ=30° in case of a conformal array with f_{30°}=0.35
φᵣ=45° in case of a conformal array with f_{45°}=0.44
   In FIGS. 24 A-D, the beam patterns of the three cases are compared to an equivalent confocal and coaxial imaging system with the same main reflector characteristic parameters, fed by a traditional planar array. 11 beams are simulated within a scan range of ±15° in the offset plane.
   The patterns show:
notable improvement in beam symmetry (beamwidth, beam level with respect to boresight) for higher tilt angles;
better beam performance for negative pointing angles for higher tilt angles;
   For φᵣ=0° the conformal array produces broad beams at negative scan angles due to the strong reduction of the equivalent focal length. As the results show, arrays with higher equivalent focal lengths are less sensible to aperture variation producing more regular beams.

### Simulation 3:

The aim of this simulation is to show how a further improvement in beam symmetry can be obtained by including an additional tilt angle γₑₗ at feed element level. Choosing a fixed γₑₗ with respect to which all feed elements of the array are tilted the overall power distribution can be modified as to produce an even more symmetric level of beams with respect to the boresight direction. To evaluate the effect of the feed element tilt angle, again the SFE patterns are simulated by means of a GO analysis.
The considered simulation setups are the same as in the precedent simulation (2) with:
φᵣ=30°
φᵣ=45°
   FIGS. 25 A-B shows a superposition of the obtained GO beam envelopes as a function of different tilt angles of the feed element with respect to the sub reflector axis direction for both simulation cases.
   The effects of an additional feed element tilt angle γₑₗ are:
a slight overall directivity reduction due to the less uniform sub reflector illumination;
an improved symmetrical distribution of the SFE pattern with respect to boresight.
   A higher reflector axes tilt angle φᵣ requires a lower additional feed element tilt angle γₑₗ. By inspection the optimum element tilt angles γₑₗ are chosen as:
γₑₗ=10° for the φᵣ=30° case;
γₑₗ=6° for the φᵣ=45° case.

As a second step the same scan ranges simulated in simulation (2) are repeated by introducing the respective values of γₑₗ and the obtained patterns are represented in FIGS. 26 A-B by normalizing them to maximum directivity and superimposing the SFE pattern.

The advantage of a higher symmetrical beam distribution needs to be traded off with higher scan losses which arise due to both:
the reflector tilt axis φᵣ;
the element tilt axis γₑₗ.
   For the current simulation:
Comparing φᵣ=0° with φᵣ=30° and γₑₗ=0° the maximum directivity is reduced of 0.56 dB;
Comparing φᵣ=0° with φᵣ=45° and γₑₗ=0° the maximum directivity is reduced of 0.74;
   Increasing the pattern's symmetry by introducing the feed element tilt:
additional 0.52 dB are lost in the φᵣ=30° case due to the γₑₗ=10° element tilt;
additional 0.14 dB are lost in the φᵣ=45° case due to the γₑₗ=6° element tilt.

Also by applying an additional element tilt γₑₗ the simulation results prove that it is convenient to maximise the reflector tilt angle φᵣ and adjust symmetry by means of a minimised element tilt angle γₑₗ. In addition to the beam symmetry increase, the beam mispointing has been notably reduced. Since the beam mispointing can be corrected also at array level, to provide a more significant numerical comparison between all the simulated cases with respect to the reference case which is characterized by strongly mispointed beams, the ISCA phase compensation technique has been applied. The obtained beam pattern is shown in FIG. 27. Numerical results are provided in Table 8 by comparing beam characteristics in the far field, as calculated on a spherical cut in the offset plane, for 11 scan directions.

TABLE 8
Beam characteristics as maximum directivity (Dₘₐₓ), half power beamwidth
(HPBW) and beam pointing angle are compared for all cases of simulation (2) and (3)

| Scan [°] | | | | | | | | | | |
|---|---|---|---|---|---|---|---|---|---|---|
| 15 | 12 | 9 | 6 | 3 | 0 | −3 | −6 | −9 | −12 | −15 |

Confocal and coaxial imaging system fed by a planar array

| | | | | | | | | | | | |
|---|---|---|---|---|---|---|---|---|---|---|---|
| Dₘₐₓ [dB] | 48.38 | 49.47 | 50 | 50.09 | 49.84 | 49.4 | 48.82 | 48.11 | 47.22 | 46.05 | 44.42 |
| HPBW [°] | 0.39 | 0.38 | 0.38 | 0.41 | 0.45 | 0.5 | 0.57 | 0.64 | 0.74 | 0.86 | 0.98 |
| Point [°] | −4.03 | −3.31 | −2.58 | −1.8 | −0.94 | 0 | 1.06 | 2.26 | 3.63 | 5.19 | 6.97 |

Confocal and coaxial imaging system fed by a planar array with ISCA correction

| | | | | | | | | | | | |
|---|---|---|---|---|---|---|---|---|---|---|---|
| Dₘₐₓ [dB] | 47.21 | 49.44 | 50.09 | 50.16 | 49.86 | 49.4 | 48.86 | 48.3 | 47.76 | 47.21 | 46.56 |
| HPBW [°] | 0.46 | 0.38 | 0.38 | 0.4 | 0.45 | 0.5 | 0.56 | 0.62 | 0.69 | 0.74 | 0.8 |
| Point [°] | −5.18 | −4.02 | −2.98 | −1.99 | −1 | 0 | 0.99 | 1.96 | 2.87 | 3.69 | 4.37 |

Confocal imaging system with φᵣ = 30° fed by a conformal array

| | | | | | | | | | | | |
|---|---|---|---|---|---|---|---|---|---|---|---|
| Dₘₐₓ [dB] | 46.41 | 47.95 | 48.82 | 49.34 | 49.53 | 49.39 | 48.96 | 48.28 | 47.42 | 46.41 | 45.26 |
| HPBW [°] | 0.89 | 0.69 | 0.59 | 0.54 | 0.5 | 0.5 | 0.51 | 0.52 | 0.54 | 0.57 | 0.6 |
| Point [°] | −5.87 | −4.37 | −3.13 | −2.03 | −1.01 | 0 | 1 | 2.02 | 3.06 | 4.15 | 5.264 |

Confocal imaging system with φᵣ = 30° and
γₑₗ = 10° fed by a conformal array

| | | | | | | | | | | | |
|---|---|---|---|---|---|---|---|---|---|---|---|
| Dₘₐₓ [dB] | 44.63 | 46.5 | 47.67 | 48.46 | 48.91 | 49 | 48.8 | 48.34 | 47.67 | 46.85 | 45.88 |
| HPBW [°] | 0.89 | 0.69 | 0.58 | 0.53 | 0.5 | 0.5 | 0.5 | 0.52 | 0.54 | 0.58 | 0.6 |
| Point [°] | −5.86 | −4.37 | −3.13 | −2.03 | −1 | 0 | 1 | 2.02 | 3.07 | 4.15 | 5.26 |

Confocal imaging system with φᵣ = 45° fed by a conformal array

| | | | | | | | | | | | |
|---|---|---|---|---|---|---|---|---|---|---|---|
| Dₘₐₓ [dB] | 45.47 | 46.78 | 47.91 | 48.8 | 49.31 | 49.35 | 48.92 | 48.07 | 46.85 | 45.37 | 43.6 |
| HPBW [°] | 0.69 | 0.62 | 0.56 | 0.53 | 0.5 | 0.5 | 0.5 | 0.52 | 0.55 | 0.59 | 0.65 |
| Point [°] | −5.53 | −4.26 | −3.1 | −2.03 | −1.01 | 0 | 1.01 | 2.03 | 3.08 | 4.16 | 5.29 |

Confocal imaging system with φᵣ = 45° and
γₑₗ = 6° fed by a conformal array

| | | | | | | | | | | | |
|---|---|---|---|---|---|---|---|---|---|---|---|
| Dₘₐₓ [dB] | 44.56 | 46.02 | 47.33 | 48.37 | 49.03 | 49.21 | 48.92 | 48.2 | 47.11 | 45.74 | 44.09 |
| HPBW [°] | 0.69 | 0.62 | 0.56 | 0.53 | 0.5 | 0.5 | 0.5 | 0.52 | 0.55 | 0.59 | 0.65 |
| Point [°] | −5.53 | −4.26 | −3.1 | −2.03 | −1.01 | 0 | 1.01 | 2.03 | 3.08 | 4.16 | 5.29 |

### Simulation 4:

This simulation is to show how system parameters and requirements shall be traded off when designing an optimum imaging system, addressing also the problem of scan losses. Precedent simulations have shown that the degree of freedom represented by the sub reflector axis tilt introduces a significant improvement in maintaining a good beamwidth stability over a relatively large field of view. The nice feature of not introducing any system complexity or modifying the shape of the reflectors by just relying on the combination of two approaches which combine geometrical aspects with the theory of optics indeed requires some prices to pay. The beam behaviour appears to be more symmetric with respect to a classical confocal and coaxial imaging system and the beam mispointing is decreased without applying any phase compensation technique at array level. However, requiring to maintain the reflectors unshaped and not adding any additional structures (as for example discrete lenses) into the system, it is necessary to find a compromise between the scan range to be accommodated and the scan loss to be accepted. An optimum trade-off between all system parameters can be obtained numerically by applying all the design criteria presented so far. A higher tilt angle between the main reflector axis and the sub reflector axis permits to obtain higher beam symmetry over the entire FOV in terms of beamwidth and less antenna mispointing. For given dimensions of the reflectors, a higher tilt angle leads to a less efficient illumination of the main reflector, since a region of the reflector is illuminated which moves away from the parabola vertex region as a function of the tilt angle. This leads both to an overall scan loss and a stronger additional scan loss when scanning beams away from boresight, as it can be seen by comparing the boresight beam directivity with the edge of coverage directivities. To reduce these scan losses it is necessary to enhance the f/D ratio of the system, which strongly depends on the scan range to be accommodated within a given FOV. In fact a higher scan range requests lower f/D values. For a tilted system the blockage provided by the array is critical. This means that the f/D ratio can be maximised up to a value permitting to have a blockage free path between the sub reflector and the main reflector for all beams to be scanned. Reducing the field of view permits enlarging the f/D ratio providing the same magnification ratio M.

An imaging system has been simulated in TICRA GRASP® with the following requirements:
typical continental coverage from a geostationary satellite (±3° with respect to boresight direction);
100λ main reflector aperture;
magnification ratio M=3.
   Three setups have been compared for three different f/D ratios.
   1) confocal and coaxial imaging system fed by a planar array;
   2) confocal and coaxial imaging system fed by a conformal array;
   3) confocal imaging system fed by a conformal array with a sub reflector axis tilt of 40°.
   In the cases 2 and 3 a conformal feeding array has been selected in order to have the magnified array of the conjugate points planar and passing through the main reflector centre point.
   The three simulation cases have been repeated for three different f/D ratios, being:
   a) f/D=1
   b) f/D=1.5
   c) f/D=2
   for a main reflector diameter of D₁=100λ at a wavelength λ=0.015 m.
   For each of the setups a further tilt axis has been introduced which is the single feed element axis tilt with respect to the sub reflector axis. This tilt angle has been chosen as to provide the most symmetric boresight beam, produced by a single feed element being the centre element of the array.
   For each simulation the patterns have been simulated in the most critical offset plane, which is the plane where the simulation case 3 tilt angle is located.

One beam has been scanned into the following directions from the array plane:

### I) θ=9°; φ=0°;

### II) θ=6°; φ=0°;

### III) θ=3°; φ=0°;

### IV) θ=0°; φ=0°;

### V) θ=3°; φ=180°;

### VI) θ=6°; φ=180°;

### VII) θ=9°; φ=180°;

To scan the beams a linear phase progression only has been applied to the planar array of case 1, while also a parabolic phase taper has been applied to the conformal arrays (cases 2 and 3) to provide a perpendicular equiphase surface into the scanned direction. The beams are simulated by means of a PO approach and are normalized with respect to the maximum directivity. Both reflectors have been oversized as to accommodate the entire scan range with low spill over loss by means of a GO ray-tracing criterion. In addition no inter-element blockage has been taken into account between single feeding elements and all feeding elements consist of ideal fundamental mode circular waveguides with a radius r=λ. Table 10 provides system data for each simulation. The design procedure which has been followed for setting up the tilted case system has been chosen according to strategy 1:

For given main reflector characteristic parameters (D₁, f₁,x_{ci}), the corresponding sub reflector focal length f₂ and clearance x′_{cl} are calculated, fixing the magnification ratio to M=3. The tilt angle between main reflector and sub reflector axis is denoted as φᵣ, while the tilt angle between the sub reflector axis direction and the single feed element axis is denoted as γₑₗ. The main reflector radius r₁ and the sub reflector radius r₂ take into account of the oversize of the reflectors. It is noted that the SFE pattern simulation has been carried out without oversizing neither the main, nor the sub reflector and oversize has been only taken into account in the PO simulations for accommodating the scan range. All values are rounded to the second significant figure. Table 11 presents the maximum directivity values of each simulation, to which the entire patterns are normalized (in dB). The obtained patterns show both the symmetry increase between beams around boresight direction and the higher beamwidth stability which is achieved. Characteristic beam data as the beams directivity, the half power beamwidth and the beam pointing angle (with respect to the main reflector aperture) have been numerically evaluated. The numerical simulation results cases are reported in Table 12. Table 13 gives a numerical glance on the effect of beam symmetry enhancement. The offset plane in which the beams are simulated is the plane where aberrations are mostly relevant while it's perpendicular plane sees a symmetric antenna configuration. In the following Tables 13 and 14 the ratio between peak directivity and the edge of coverage directivity is compared for all cases. The first table does not consider the single feed element tilt, while the second table considers also this tilt.

TABLE 10
Setup data

| | Planar array | Conformal array | Conformal array with tilt |
|---|---|---|---|
| f/D = 1 | φ_{R} = 0°; γ = 0°; M = 3 | φ_{R} = 0°; γ = 0°; M = 3 | φ_{R} = 40°; γ = 0°; M = 3 |
| Array centre: | D₁ = 1.5 m; D₂ = 0.5 m | D₁ = 1.5 m; D₂ = 0.5 m | D₁ = 1.5 m; D₂ = 0.5 m |
| Oversize: | f₁ = 1.5 m; f₂ = 0.5 m | f₁ = 1.5 m; f₁ = 0.5 m | f₁ = 1.5 m; f₁ = 0.71 m |
| | x_{cl} = 0.5 m; x′_{cl} = 0.17 m | x_{cl} = 0.5 m; x′_{cl} = 0.17 m | x_{cl} = 1.5 m; x′_{cl} = 0.17 m |
| | x = −0.42; y = 0; z = −0.36 | x = −0.42; y = 0; z = −0.36 | x = −0.43; y = 0; z = −0.39 |
| | r₁ = 0.85 m; r₂ = 0.5 m | r₁ = 0.85 m; r₂ = 0.5 m | r₁ = 0.85 m; r₂ = 0.5 m |
| f/D = 1 | φ_{R} = 0°; γ = 7°; M = 3 | φ_{R} = 0°; γ = 7°; M = 3 | φ_{R} = 40°; γ = 7°; M = 3 |
| Array centre: | D₁ = 1.5 m; D₂ = 0.5 m | D₁ = 1.5 m; D₂ = 0.5 m | D₁ = 1.5 m; D₂ = 0.5 m |
| Oversize: | f₁ = 1.5 m; f₂ = 0.5 m | f₁ = 1.5 m; f₂ = 0.5 m | f₁= 1.5 m; f₂ = 0.71 m |
| | x_{cl} = 0.5 m; x′_{cl} = 0.17 m | x_{cl} = 0.5 m; x′_{cl} = 0.17 m | x_{cl} = 1.5 m; x′_{cl} = 0.17 m |
| | x = −0.42; y = 0; z = −0.36 | x = −0.42; y = 0; z = −0.36 | x = −0.43; y = 0; z = −0.39 |
| | r₁ = 0.85 m; r₂ = 0.55 m | r₁ = 0.85 m; r₂ = 0.55 m | r₁ = 0.85 m; r₂ = 0.55 m |
| f/D = 1.5 | φ_{R} = 0°; Y = 0°; M = 3 | φ_{R} = 0°; γ = 0°; M = 3 | φ_{R} = 40°; γ = 0°; M = 3 |
| Array centre: | D₁ = 1.5 m ; D₂ = 0.5 m | D₁ = 1.5 m; D₂ = 0.5 m | D₁ = 1.5 m; D₂ = 0.5 m |
| Oversize: | f₁ = 2.25 m; f₂ = 0.75 m | f₁ = 2.25 m; f₂ = 0.75 m | f₁ = 2.25 m; f₂ = 0.99 m |
| | x_{cl} = 0.5 m; x′_{cl} = 0.17 m | x_{cl} = 0.5 m; x′_{cl} = 0.17 m | x_{cl} = 2 m; x′_{cl} = 0.14 m |
| | x = −0.42; y = 0; z = −0.39 | x = −0.42; y = 0; z = −0.39 | x = −0.40; y = 0; z = −0.42 |
| | r₁ = 0.85 m; r₂ = 0.5 m | r₁ = 0.85 m; r₂ = 0.5 m | r₁ = 0.85 m; r₂ = 0.5 m |
| f/D = 1.5 | φ_{R} = 0°; Y = 6°; M = 3 | φ_{R} = 0°; γ = 6°; M = 3 | φ_{R} = 40°; γ = 5°; M = 3 |
| Array centre: | D₁ = 1.5 m; D₂ = 0.5 m | D₁= 1.5 m; D₂ = 0.5 m | D₁ = 1.5 m; D₂ = 0.5 m |
| Oversize: | f₁= 2.25 m ; f₂ = 0.75 m | f₁ = 2.25 m ; f₂ = 0.75 m | f₁ = 2.25 m; f₂ = 0.99 m |
| | x_{cl} = 0.5 m; x′_{cl} = 0.17 m | x_{cl} = 0.5 m; x′_{cl} = 0.17 m | x_{cl} = 2 m; x′_{cl} = 0.14 m |
| | x = −0.42; y = 0; z = −0.39 | x = −0.42; y = 0; z = −0.39 | x = −0.40; y = 0; z = −0.42 |
| | r₁ = 0.85 m; r₂ = 0.55 m | r₁ = 0.85 m; r₂ = 0.55 m | r₁ = 0.85 m; r₂ = 0.55 m |
| f/D = 2 | φ_{R} = 0°: γ = 0°; M = 3 | φ_{R} = 0°; γ = 0°; M = 3 | φ_{R} = 0°; γ = 0°; M = 3 |
| Array centre: | D₁ = 1.5 m; D₂ = 0.5 m | D₁ = 1.5 m; D₂ = 0.5 m | D₁ = 1.5 m; D₂ = 0.5 m |
| Oversize: | f₁ = 3 m; f₂ = 1 m | f₁ = 3 m; f₂ = 1 m | f₁ = 3 m; f₂ = 1.29 m |
| | x_{cl} = 0.6 m; x′_{cl} = 0.2 m | x_{cl} = 0.6 m; x′_{cl} = 0.2 m | x_{cl} = 2.7 m; x′_{cl} = 0.19 m |
| | x = −0.45; y = 0; z = −0.45 | x = −0.45; y = 0; z = −0.45 | x = −0.45; y = 0; z = −0.52 |
| | r₁ = 0.85 m; r₂ = 0.5 m | r₁ = 0.85 m; r₂ = 0.5 m | r₁ = 0.85 m; r₂ = 0.6 m |
| f/D = 2 | φ_{R} = 0°; γ = 5°; M = 3 | φ_{R} = 0°; γ = 5°; M = 3 | φ_{R} = 0°; Y = 4°; M = 3 |
| Array centre: | D₁ = 1.5 m; D₂ = 0.5 m | D₁ = 1.5 m; D₂ = 0.5 m | D₁ = 1.5 m; D₂ = 0.5 m |
| Oversize: | f₁ = 3 m; f₂ = 1 m | f₁ = 3 m; f₂ = 1 m | f₁ = 3 m; f₂ = 1.29 m |
| | x_{cl} = 0.6 m; x′_{cl} = 0.2 m | x_{cl} = 0.6 m; x′_{cl} = 0.2 m | x_{cl} = 2.7 m; x′_{cl} = 0.19 m |
| | x = −0.45; y = 0; z = −0.45 | x = −0.45; y = 0; z = −0.45 | x = −0.45; y = 0; z = −0.52 |
| | r₁ = 0.85 m; r₂ = 0.6 m | r₁ = 0.85 m; r₂ = 0.6 m | r₁ = 0.85 m; r₂ = 0.65 m |

TABLE 11
Directivity normalization values to patterns

| | | |
|---|---|---|
| D = 47.76 dB | D = 47.79 dB | D = 47.56 dB |
| D = 47.39 dB | D = 47.35 dB | D = 47.34 dB |
| D = 47.65 dB | D = 47.65 dB | D = 47.57 dB |
| D = 47.41 dB | D = 47.35 dB | D = 47.42 dB |
| D = 47.62 dB | D = 47.59 dB | D = 47.56 dB |
| D = 47.44 dB | D = 47.40 dB | D = 47.45 dB |

TABLE 12
Numerical simulation results
${ϕ}_{R} = 0 ° ; γ = 0 ° ; \frac{f}{D} = 1 ; planar array$

| | | | | | | | |
|---|---|---|---|---|---|---|---|
| D | 47.61 | 47.76 | 47.74 | 47.58 | 47.26 | 46.80 | 46.25 |
| BW | 0.54 | 0.54 | 0.56 | 0.59 | 0.62 | 0.68 | 0.73 |
| Angle | −2.77 | −1.89 | −0.97 | 0 | 1.02 | 2.12 | 3.30 |

${ϕ}_{R} = 0 ° ; γ = 7 ° ; \frac{f}{D} = 1 ; planar array$

| | | | | | | | |
|---|---|---|---|---|---|---|---|
| D | 46.94 | 47.25 | 47.39 | 47.39 | 47.23 | 46.93 | 46.55 |
| BW | 0.54 | 0.54 | 0.56 | 0.59 | 0.63 | 0.68 | 0.73 |
| Angle | −2.77 | −1.89 | −0.97 | 0 | 1.02 | 2.12 | 3.30 |

${ϕ}_{R} = 0 ° ; γ = 0 ° ; \frac{f}{D} = 1 ; conformal array$

| | | | | | | | |
|---|---|---|---|---|---|---|---|
| D | 47.68 | 47.79 | 47.70 | 47.49 | 47.21 | 46.86 | 46.45 |
| BW | 0.65 | 0.62 | 0.6 | 0.6 | 0.61 | 0.62 | 0.62 |
| Angle | −3.07 | −2.02 | −1.01 | 0 | 1 | 2.01 | 3.02 |

${ϕ}_{R} = 0 ° ; γ = 7 ° ; \frac{f}{D} = 1 ; conformal array$

| | | | | | | | |
|---|---|---|---|---|---|---|---|
| D | 46.96 | 47.23 | 47.35 | 47.30 | 47.18 | 46.98 | 46.72 |
| BW | 0.65 | 0.62 | 0.6 | 0.6 | 0.61 | 0.62 | 0.62 |
| Angle | −3.07 | 2.02 | −1 | 0 | 1 | 2.01 | 3.02 |

${ϕ}_{R} = 40 ° ; γ = 0 ° ; \frac{f}{D} = 1 ; conformal array$

| | | | | | | | |
|---|---|---|---|---|---|---|---|
| D | 46.59 | 47.24 | 47.56 | 47.54 | 47.19 | 46.56 | 45.66 |
| BW | 0.65 | 0.62 | 0.6 | 0.6 | 0.61 | 0.62 | 0.62 |
| Angle | −3.05 | −2 | −0.99 | 0 | 0.99 | 2 | 3.02 |

${ϕ}_{R} = 40 ° ; γ = 7 ° ; \frac{f}{D} = 1 ; conformal array$

| | | | | | | | |
|---|---|---|---|---|---|---|---|
| D | 45.87 | 46.70 | 47.20 | 47.34 | 47.16 | 46.67 | 45.93 |
| BW | 0.65 | 0.62 | 0.6 | 0.6 | 0.61 | 0.62 | 0.62 |
| Angle | −3.05 | −2 | −0.99 | 0 | 0.99 | 2 | 3.02 |

${ϕ}_{R} = 0 ° ; γ = 0 ° ; \frac{f}{D} = 1.5 ; planar array$

| | | | | | | | |
|---|---|---|---|---|---|---|---|
| D | 47.45 | 47.63 | 47.65 | 47.55 | 47.32 | 46.97 | 46.51 |
| BW | 0.56 | 0.56 | 0.57 | 0.59 | 0.62 | 0.66 | 0.69 |
| Angle | −2.85 | −1.93 | −0.98 | 0 | 1.02 | 2.08 | 3.2 |

${ϕ}_{R} = 0 ° ; γ = 6 ° ; \frac{f}{D} = 1.5 ; planar array$

| | | | | | | | |
|---|---|---|---|---|---|---|---|
| D | 46.91 | 47.21 | 47.37 | 47.41 | 47.32 | 47.11 | 46.78 |
| BW | 0.56 | 0.56 | 0.58 | 0.59 | 0.62 | 0.65 | 0.69 |
| Angle | −2.85 | −1.93 | −0.98 | 0 | 1.02 | 2.08 | 3.2 |

${ϕ}_{R} = 0 ° ; γ = 0 ° ; \frac{f}{D} = 1.5 ; conformal array$

| | | | | | | | |
|---|---|---|---|---|---|---|---|
| D | 47.50 | 47.65 | 47.63 | 47.50 | 47.30 | 47.03 | 46.70 |
| BW | 0.62 | 0.6 | 0.6 | 0.59 | 0.59 | 0.6 | 0.61 |
| Angle | −3.04 | −2.01 | −1 | 0 | 1 | 2.01 | 3.02 |

${ϕ}_{R} = 0 ° ; γ = 6 ° ; \frac{f}{D} = 1.5 ; conformal array$

| | | | | | | | |
|---|---|---|---|---|---|---|---|
| D | 46.93 | 47.22 | 47.34 | 47.35 | 47.28 | 47.14 | 46.92 |
| BW | 0.62 | 0.61 | 0.6 | 0.59 | 0.6 | 0.61 | 0.61 |
| Angle | −3.04 | −2.01 | −1 | 0 | 1 | 2.01 | 3.02 |

${ϕ}_{R} = 40 ° ; γ = 0 ° ; \frac{f}{D} = 1.5 ; conformal array$

| | | | | | | | |
|---|---|---|---|---|---|---|---|
| D | 46.92 | 47.37 | 47.57 | 47.55 | 47.33 | 46.91 | 46.23 |
| BW | 0.62 | 0.61 | 0.6 | 0.59 | 0.6 | 0.61 | 0.61 |
| Angle | −3.02 | −2 | −1 | 0 | 0.99 | 2 | 3.01 |

${ϕ}_{R} = 40 ° ; γ = 5 ° ; \frac{f}{D} = 1.5 ; conformal array$

| | | | | | | | |
|---|---|---|---|---|---|---|---|
| D | 46.46 | 47.00 | 47.32 | 47.42 | 47.31 | 47.01 | 46.54 |
| BW | 0.62 | 0.61 | 0.6 | 0.59 | 0.6 | 0.61 | 0.61 |
| Angle | −3.02 | −2 | −1 | 0 | 1 | 2 | 3.01 |

${ϕ}_{R} = 0 ° ; γ = 0 ° ; \frac{f}{D} = 2 ; planar array$

| | | | | | | | |
|---|---|---|---|---|---|---|---|
| D | 47.38 | 47.58 | 47.62 | 47.54 | 47.34 | 47.03 | 46.66 |
| BW | 0.57 | 0.57 | 0.58 | 0.59 | 0.62 | 0.65 | 0.67 |
| Angle | −2.88 | −1.94 | −0.98 | 0 | 1.01 | 2.06 | 3.17 |

${ϕ}_{R} = 0 ° ; γ = 5 ° ; \frac{f}{D} = 2 ; planar array$

| | | | | | | | |
|---|---|---|---|---|---|---|---|
| D | 46.94 | 47.25 | 47.41 | 47.44 | 47.36 | 47.16 | 46.91 |
| BW | 0.57 | 0.57 | 0.58 | 0.59 | 0.61 | 0.65 | 0.67 |
| Angle | −2.88 | −1.94 | −0.98 | 0 | 1.01 | 2.06 | 3.17 |

${ϕ}_{R} = 0 ° ; {γ}_{el} = 0 ° ; \frac{f}{D} = 2 ; conformal array$

| | | | | | | | |
|---|---|---|---|---|---|---|---|
| D | 47.41 | 47.59 | 47.61 | 47.51 | 47.34 | 47.10 | 46.79 |
| BW | 0.62 | 0.61 | 0.6 | 0.59 | 0.59 | 0.6 | 0.61 |
| Angle | −3.02 | −2.01 | −1 | 0 | 1 | 2 | 3.02 |

${ϕ}_{R} = 0 ° ; {γ}_{el} = 5 ° ; \frac{f}{D} = 2 ; conformal array$

| | | | | | | | |
|---|---|---|---|---|---|---|---|
| D | 46.97 | 47.25 | 47.38 | 47.40 | 47.34 | 47.21 | 47.00 |
| BW | 0.62 | 0.61 | 0.6 | 0.59 | 0.59 | 0.6 | 0.62 |
| Angle | −3.02 | −2.01 | −1 | 0 | 1 | 2.01 | 3.02 |

${ϕ}_{R} = 40 ° ; {γ}_{el} = 0 ° ; \frac{f}{D} = 2 ; conformal array$

| | | | | | | | |
|---|---|---|---|---|---|---|---|
| D | 47.06 | 47.41 | 47.56 | 47.53 | 47.36 | 47.04 | 46.54 |
| BW | 0.62 | 0.61 | 0.6 | 0.59 | 0.6 | 0.61 | 0.62 |
| Angle | −3.02 | −2.01 | −1 | 0 | 1 | 2 | 3.02 |

${ϕ}_{R} = 40 ° ; {γ}_{el} = 4 ° ; \frac{f}{D} = 2 ; conformal array$

| | | | | | | | |
|---|---|---|---|---|---|---|---|
| D | 46.72 | 47.15 | 47.39 | 47.45 | 47.37 | 47.14 | 46.76 |
| BW | 0.62 | 0.61 | 0.6 | 0.59 | 0.59 | 0.6 | 0.61 |
| Angle | −3.02 | −2.01 | −1 | 0 | 1 | 2.01 | 3.02 |

TABLE 13
Peak to edge of coverage directivity ratio, no single feed element tilt

| | φ_{R} = 0° planar | φ_{R} = 0° conformal | φ_{R} = 40° conformal |
|---|---|---|---|
| f/D = 1 | 1.51 dB | 1.34 dB | 1.9 dB |
| f/D = 1.5 | 1.14 dB | 0.95 dB | 1.34 dB |
| f/D = 2 | 0.96 dB | 0.82 dB | 1.02 dB |

TABLE 14
Peak to edge of coverage directivity ratio, with single feed element tilt

| | φ_{R} = 0° planar | φ_{R} = 0° conformal | φ_{R} = 40° conformal |
|---|---|---|---|
| f/D = 1 | 0.84 dB | 0.63 dB | 1.47 dB |
| f/D = 1.5 | 0.63 dB | 0.43 dB | 0.96 dB |
| f/D = 2 | 0.53 dB | 0.43 dB | 0.73 dB |

Table 15 provides the overall scan loss introduced by tilting the feed elements, measured as ratio between maximum directivity values.

TABLE 15
Scan loss between peak directivities when tilting single feed elements

| | φ_{R} = 0° planar | φ_{R} = 0° conformal | φ_{R} = 40° conformal |
|---|---|---|---|
| f/D = 1 | 0.37 dB | 0.44 dB | 0.22 dB |
| f/D = 1.5 | 0.24 dB | 0.30 dB | 0.15 dB |
| f/D = 2 | 0.18 dB | 0.21 dB | 0.11 dB |

The results show that by substituting the planar array with a conformal one to have higher beam symmetry improves the peak to edge of coverage directivity ratio in all f/D cases while the 40° tilt angle suffers an additional scan loss which does not enhance this ratio with respect to the traditional confocal and coaxial system fed by a planar array. Indeed it can be seen in terms of a trend that the scan loss enhancement produced by tilting the system's axes is reduced as more the f/D ratio is increased. If this parameter is relevant in system design, it is necessary to setup a system choosing the right f/D ratio according to both FOV and system dimensions requirements or else reducing the tilt angle as to obtain a desired peak to edge of coverage directivity ratio as a function of a fixed f/D ratio, or magnification ratio M. It must be taken into account that reflector systems characterized by lower tilt angles and a planar distribution of conjugate points provide parabolic conformal arrays with higher equivalent focal length, which affects the array feasibility in terms of element sizes and spacings. An important result of both applying a conformal array and exploiting the reflectors' axes tilt angle is represented by pattern symmetry enhancement, which can be described in terms of larger beamwidth stability. Table 16 compares the maximum deviation of beamwidths between the narrowest beam and the broadest beam (at edge of coverage) produced by the patterns, comparing all cases for each f/D ratio not having applied any single feed element tilt. There is no significant difference in beamwidths between the case with and without single feed element tilt, since the values are the same in both cases.

TABLE 16
Beamwidth variation with respect to narrowest beam

| | φ_{R} = 0° planar | φ_{R} = 0° conformal | φ_{R} = 40° conformal |
|---|---|---|---|
| f/D = 1 | 35.19% | 8.33% | 8.33% |
| f/D = 1.5 | 23.21% | 5.08% | 5.08% |
| f/D = 2 | 17.54% | 5.08% | 5.08% |

As it can be seen by the results the strong improvement described before is provided mainly due to the regularization of the conjugate points. Both for the 0° degree tilt, as well as for the 40° tilt angle, the produced beams are more symmetric with respect to the boresight beam, either in terms of scan loss, either in terms of beamwidth, either in terms of pointing angle. For this simulation case, the continental coverage requires a limited scan range to ±3°. For larger scan ranges, the effect of the tilt angle is more. At the same time a larger scan range limits the possibility of accommodating large f/D ratios or, on the other side, requires to offset the system in a way that despite the beam symmetry increase, the absolute value of scan loss increases, which is an undesired effect. The previous simulation does not take into account of possible inter-element blockage when considering the conformal array. This kind of analysis should be drawn in a further step, when optimizing the system as a function of the known technology for realising the array feed elements. In the following Table 17 the equivalent focal lengths of the conformal arrays for φ_{R}=0° and φ_{R}=40° are compared for the three different f/D cases.

TABLE 17
Equivalent focal lengths of the conformal arrays

| Conformal Arrays | φ_{R} = 0° | φ_{R} = 40° |
|---|---|---|
| f/D = 1 | 0.19 | 0.24 |
| f/D = 1.5 | 0.28 | 0.34 |
| f/D = 2 | 0.38 | 0.45 |

Overall the sub reflector axis tilt permits to obtain parabolic shaped conformal arrays with an equivalent focal length which is between 120% and 130% larger as compared with the equivalent focal length of the conformal array in the confocal and coaxial case. This must be taken into account when designing a system which should fulfil specific FOV and blockage requirements and assessing the feasibility of the phased array design. In the FIG. 28 some conformal arrays, as dimensioned within TICRA GRASP®, are reported.

In FIG. 28, the feeding array and the sub reflector dish are represented together with a reference system whose centre is represented by the array central element. By comparing figures from left to right it can be seen how the focal length of the sub reflector is varied. While for the confocal case M=D₁/D₂=f₁/f₂, for maintaining the same magnification ratio in the case of sub reflector axis tilt it is necessary to apply a larger sub reflector focal length. Both the sub reflector focal length and the confocal parabolic array equivalent focal length are larger. On the one hand side the array feasibility is increased, on the other hand side the larger focal length of the sub reflector requires a larger offset to accommodate the same number of scanned beamwidths reducing blockage effects due to the array between the beam reflections on the sub reflector and on the main reflector. This is ultimately the reason which enhances scan losses when tilting the reflector's axes, since the equivalent illuminated region on the main reflector moves away from the parabolic vertex. Another advantage introduced by the regularization of conjugate points is the correction of the antenna mispointing. Table 18 compares maximum deviations with respect to the ideal pointing angles, which occur for beams at the edge of coverage. There is no significant variation introducing the single feed element tilt on the beam pointing.

TABLE 18
Maximum beam mispointing error

| | φ_{R} = 0° planar | φ_{R} = 0° conformal | φ_{R} = 40° conformal |
|---|---|---|---|
| f/D = 1 | 0.30° | 0.07° | 0.05° |
| f/D = 1.5 | 0.20° | 0.04° | 0.02° |
| f/D = 2 | 0.17° | 0.02° | 0.02° |

### Simulation 6:

Relying on the system design of simulation (5) three setups have been chosen for simulating a circular continental coverage. Simulation results are reported on (u,v)-grids giving the possibility to appreciate the beam behaviour also on other planes with respect to the offset plane. A circular area of 3.5° radius has been chosen and 121 beams have been scanned with three of the previously presented imaging systems.
Case 1: Planar array feeding the confocal and coaxial imaging system with f/D=1
Case 2: Conformal array feeding the confocal and coaxial imaging system with

$$\frac{f}{D} = 1$$

Case 3: Conformal array feeding the confocal imaging system with f/D=1 and 40° sub reflector axis tilt
The feed elements of the conformal arrays have been tilted, according to previous simulations, to provide a more symmetric system response, according to a GO based optimization criterion of the central element produced beam.
The produced beams are simulated over a spherical grid represented in a (u,v) reference system with u=sin θ cos φ and v=sin θ sin φ.
To establish the pointing directions a linear phase progression has been applied to the array to have each beam pointed along a triangular mesh as presented in FIG. 29.

The represented coverage represents the ideal coverage with all spots being equally spaced within a circular aperture of 3.5° as seen from GEO and equal in HPBW.

The beams are produced by the array by means of a constant amplitude and a linear phase progression. This to show the beam mispointing produced due to the phase aberrations of the system. In FIGS. 34 A-C the patterns produced by the three simulation cases are presented. Th Im Each beams HPBW contour plot is presented and it's contour is filled by a greyscale according to the equivalent area subtended by the spot. This gives a more thorough insight into the pattern symmetry. Each spot represents the co-polar component produced by the array whose feed elements are linearly polarized fundamental mode circular waveguides with an aperture diameter equal to λ, according to previously introduced simulation parameters.

Contour plots of the single beams are reported in terms of −3 dB half power beamwidth. Each contour is represented by a grey scale which is proportional to the subtended equivalent area (representative value, expressed in θ²). Both the conformal beams produce a pattern which is by far more symmetric than for the classical case. Both the coaxial case and the 40° tilted case are similar in beams distribution. It can be seen that for the 40° tilted case there is higher overlapping, due to the fact that the equivalent illuminated area on the main reflector is higher with respect to the parabola vertex leading to higher scan loss and a higher side lobe level. This effect can be appreciated most in the offset plane, by considering the beams on a spherical cut.

With respect to conventional imaging antennas the new offset imaging antenna system configuration according to the invention permits obtaining:
Reduced antenna complexity & cost or improved radiative performance: keeping a simple antenna optics based on metallic unshaped confocal reflectors but modifying their reciprocal orientation and the feeding array it may be guaranteed: a) a similar price but improved radiative performance with respect to a conventional imaging antenna composed by one or two confocal unshaped paraboloids or b) similar radiative performance but reduced price with respect to an imaging antenna composed by one or two confocal shaped paraboloids {saving in cost between 20% to 100% with respect to a shaped imaging antenna solution}. In terms of manufacturability, all the components used in the proposed antenna architecture can be based on already qualified space technologies;
Increasing the uniformity in the beam shape during the scanning, i.e. avoiding having beams becoming larger or thinner depending on the scanning direction; improving 20%-30% in the beamwidth stability, i.e. the beamwidth variation as compared to a conventional imaging antenna keeping similar field of view and magnification ratio;
Increasing the symmetry in the beam scanning losses with respect to the central boresight direction (i.e. removing the asymmetries in the up- and down-scanning typical of this type of offset antenna configurations). As a consequence it is possible a) to maintain a more uniform peak gain level during scanning (i.e. a reduced dynamic of the peak gain level versus the scanning angle) improving up to 50% with respect to the conventional imaging antenna keeping similar field of view and magnification ratio; b) increasing the minimum peak gain level achievable within an assigned field of view (typical improvement ranging from 1 to 2 dB);
Fast, accurate and well defined deterministic design procedure: I. Fast) Exploiting the positions of the conjugate points in the design of Imaging Antenna systems based on a single or dual confocal paraboloidal reflectors fed by an array is beneficial also in terms of computation burden: preliminary design can be obtained quasi in real time instead of spending several days. II. Clear Design Guidelines) Design guidelines are proposed, based on analytical equations, which permit to define the main reflector once the field of view, the sub reflector and the tilt angle are assigned or, vice-versa, to define the sub reflector once the field of view, the main reflector and the tilt angle are assigned. Repeatability of the design: any modification in the design changing any of the antenna parameters (frequency, reflector dimensions, focal distance, clearance, angular extension of the field of view, etc.). Ill. Design Refinement) The antenna configuration represents an excellent starting configuration for further optimizations based on numerical techniques (including the possibility of shaping, or adding additional elements as extra reflectors or lenses) if the designer wants to satisfy specific requirements. IV. clear physical insight) Antenna configuration and scanning properties with a clear physical insight. The design procedure for the imaging antenna system includes:
i. the definition of an envelope curve which permits a) summarizing the beam scanning behaviour in a large field of view without evaluating the single isolated spot or shaped beams and b) estimating the angular field of view of the antenna;
ii. analytical equations defining a non-linear phase tapering to apply to the feeding array in order to obtain pre-assigned arbitrary (regular or not) orientations for the antenna beams;
iii. analytical equations expressing the positions of the conjugated points of the antenna as a function of the positions of the feeding array elements and viceversa;
   Reduced number of elements in the feeding array (20 to 30% of saving) achievable exploiting the theory developed previously by ESA for the design of sparse planar arrays in combination with the theory developed here for imaging antenna systems.
   Reusing extremely accurate and mature design procedures available for planar (periodic or irregular) phased arrays. Another important justification to adopt the theory of conjugate points for the design is the following. Most of the existing design techniques for large antennas are available and valid for phased array antennas (in most of the cases flat and periodic arrays but they can be also conformal arrays and not periodic). Adopting these techniques, the most appropriate excitation function (characterized by an amplitude and a phase tapering) for an assigned magnified array may be derived. Adopting the theory of the conjugated points, it is trivial to back-trace this assigned tapering to the corresponding feeding array. The feeding array with the tapering obtained with this back-tracing together with the Imaging Antenna (constituted by one or more reflector) guarantees the best approximation (in terms of Geometrical Optics, GO) of the radiative performance obtainable with the stand alone magnified array with assigned tapering;
   Only one main aperture reflector combined with more arrays. Using a single main paraboloid reflector in combination with two or more arrays and sub reflectors to combine more antenna functionalities (as a Transmitting and a Receiving functionality, or a Transmitting functionality on two or more frequency bandwidths, or a Receiving functionality on two or more frequency bandwidths, etc.). This can be obtained keeping the corresponding feeding arrays (and associated beam forming networks) completely separated, partially overlapped or completely overlapped, partially interleaved or completely interleaved.

### REFERENCES

[1] N. C. Albertsen, S. B. Sorensen, K. Pontoppidan, “New concepts in Multireflector antenna analysis, Imaging systems”, EUROPEAN SPACE AGENCY (ESA-ESTEC) Contract 5193/82/NL/GM, February 1987
[2] W. D. Fitzgerald, “Limited Electronic Scanning with an Offset-Feed Near-Field Gregorian System”, Lincoln Laboratory—Massachusetts Institute of Technology, 1971
[3] C. Dragone and M. J. Gans, “Imaging reflector arrangements to form a scanning beam using a small array,” Bell Syst. Tech. J., vol. 58. pp. 501-515, February 1979
[4] H. P. Brueggemann, “Conic Mirrors”, Focal Press, New York, 1968
[5] Dragone, C.; “Use of imaging with spatial filtering in reflector antennas,” Antennas and Propagation, IEEE Transactions on, vol. 35, no. 3, pp. 258-267, March 1987
[6] Rao, J.; “Bicollimated Gregorian reflector antenna,” Antennas and Propagation, IEEE Transactions on, vol. 32, no. 2, pp. 147-154, February 1984
[7] R. A. Pearson: “An Array-Fed Dual Reflector Antenna”—PhD Thesis, 1988.
[8] Martinez-Lorenzo, J. A.; Garcia-Pino, A.; Gonzalez-Valdes, B.; Rappaport, C. M.; “Zooming and Scanning Gregorian Confocal Dual Reflector Antennas,” Antennas and Propagation, IEEE Transactions on, vol. 56, no. 9, pp. 2910-2919, September 2008
[9] Pearson, R.; EI-Shirbini, E.; Smith, M.; “Electronic beam scanning using an array-fed dual offset reflector antenna,” Antennas and Propagation Society International Symposium, 1986, vol. 24, no., pp. 263-266, 8-13 Jun. 1986
[10] Gatti N., Catalani A., Russo L., Rinous P., Toso G., “Shaped Confocal Antenna Fed by Active Sparse Array for Multibeam Satcom Applications”, 34th ESA Antenna Workshop, Noordwijk, The Netherlands, 2012.
[11] Arun K. Bhattacharyya, “Phased Array Antennas: Floquet Analysis, Synthesis, BFNs and Active Array Systems”, John Wiley & Sons, 2006
[12] F. Brickell et al, “The geometrical optics design of reflectors using complex coordinates”; 1977 J. Phys. A: Math. Gen
[13] G. Toso, P. Angeletti, “A method of designing and manufacturing an array antenna”; European Patent EP2090995 (filed on 18 Feb. 2008, published on 19 Aug. 2009) and U.S. Pat. No. 7,797,816 (granted on 21 Sep. 2010).

1. An offset imaging antenna system with compensated optical aberrations able to scan a beam electronically in a limited field of view or to generate a multi-beam coverage in a limited field of view, and comprising:
a main reflector having a paraboloid shape, a main aperture, a main optical centre, and a main bore-sight axis,
a first sub reflector having a paraboloid shape, a first sub reflector optical centre and a first sub reflector bore-sight axis,
a first feeding array to illuminate or to be illuminated by the first sub reflector comprising an arrangement of first feed array elements,
the main reflector and the first sub reflector being offset in an offset plane and confocal by sharing a common focal point,
wherein
the first feeding array has a curved shape that corresponds to a first equivalent array of first magnified image feed elements lying on a plane crossing the main optical centre and perpendicular to the main bore-sight axis,
all the first feed array elements being positioned as to provide a first planar distribution of the positions of the image feed elements onto the first equivalent array after a second reflection by the main reflector with a first central image point coinciding with the main reflector optical centre under a maximum illumination condition.

2. The offset imaging antenna system of claim 1, wherein the planar distribution of the positions of the image feed elements onto the first equivalent array is periodic.

3. The offset imaging antenna system of claim 1, wherein the planar distribution of the positions of the image feed elements onto the first equivalent array is a distribution of a sparse array.

4. The offset imaging antenna system of claim 1, wherein
the main bore-sight axis and the first sub reflector bore-sight axis are parallel and opposite, and
the main focal axis, defined as the axis passing through the main optical centre point and the common focal point, and the first sub reflector focal axis, defined as the axis passing through the first sub reflector optical centre point and the common focal point, are parallel and opposite.

5. The offset imaging antenna system of claim 1, wherein
the main reflector has a main reference frame centered on the common focal point with:
a first main axis z defined by the main bore-sight axis,
a second main axis x, contained in the plane including the main focal axis passing through the main optical centre and the common focal point, and directly perpendicular to the first main axis z,
a third main axis y defined so as the first, second, third main axis (x,y,z) form a directly oriented frame;
the first sub reflector has a first sub reflector frame centered on the common focal point with:
a first first sub reflector axis z′ defined by the opposite of the first sub reflector bore-sight axis,
a second first sub reflector axis x′, contained in the plane including the first sub reflector axis passing through the first sub reflector optical centre and the common focal point, and directly perpendicular to the first first sub reflector axis z′,
a third first sub reflector axis y′ defined so as the first, second, third axis first sub reflector (x′,y′,z′) form a directly oriented frame, and
while keeping the confocality between the main reflector and the first sub reflector, the main frame and the first sub reflector frame have different orientations, and the reciprocal relative orientation of the main and first sub reflector frames is determined so that the performance of the antenna is improved in terms of
increasing the symmetry of the beam gain distribution while limiting an additional scan loss over a scan range, and/or,
increasing the beam shapes stability, and/or
reducing the beam mispointing without applying phase taper on the feeding array; and/or
decrease the degree of curvature of the feeding array,
in view of a reference configuration wherein the first, second, third main axis of the main reference frame and the first, second, third first sub reflector axis of the first sub reflector frame are respectively the same.

6. The offset imaging antenna system of claim 5, wherein
either, departing from the reference configuration, the first sub reflector has been tilted around the third main axis y by a first elevation tilt angle φᵣ, defined as the relative angle between the first main reflector axis z and the first first sub reflector axis z′, and between the second main reflector axis x and the second first sub reflector axis x′, so that the reciprocal relative orientation of the frames is defined only by the first elevation tilt angle φᵣ; or
departing from the reference configuration, the first sub reflector has been tilted around the second main axis x by a second azimuth angle σᵣ, defined as the relative angle between the first main reflector axis z and the first first sub reflector axis z′, and between the third main reflector axis y and the third first sub reflector axis y′, so that the reciprocal relative orientation of the main and first sub reflector frames is defined only by the second azimuth angle σᵣ.

7. The offset imaging antenna system of claim 6, wherein
either, for an assigned main reflector aperture characterized by its main aperture size, main reflector focal length and main reflector clearance, the first sub reflector is dimensioned in terms of first sub reflector focal length, first sub reflector clearance, or first sub reflector aperture size by varying the first elevation tilt angle φᵣ or the second azimuth angle σᵣ; or, for an assigned first sub reflector aperture characterized by its first sub reflector main aperture size, first sub reflector focal length and first sub reflector clearance, the main reflector is dimensioned in terms of main reflector focal length, main reflector clearance, or main reflector aperture size by varying the first elevation tilt angle φᵣ or the second azimuth angle σᵣ.

8. The offset imaging antenna system of claim 5, wherein
departing from the reference configuration the first sub reflector has been firstly tilted around the third main axis y by a third elevation angle φᵣ defined as the relative angle between the second main reflector axis x and the second first sub reflector axis x′, and
successively tilted around the second main axis x by a fourth azimuth angle σᵣ, defined as the relative angle between the third main reflector axis y and the third first sub reflector axis y′,
so that the reciprocal relative orientation of the main reflector frame and the first sub reflector frame is defined by the third elevation angle φᵣ and the fourth azimuth angle σᵣ.

9. The offset imaging antenna system of claim 1, comprising further at least:
one second feeding array to illuminate or to be illuminated by the first sub reflector comprising an arrangement of second feed array elements,
the main reflector, the first sub reflector being offset and confocal by sharing a common focal point F,
the second feeding array having a curved shape that corresponds to a second equivalent array of a second magnified image feed elements lying on a plane crossing the main optical centre and perpendicular to the main bore-sight axis,
all the second feed array elements being positioned as to provide a second planar distribution of the positions of the second image feed elements onto the second equivalent array after a second reflection by the main reflector with a second central image point coinciding with the main reflector optical centre under a maximum illumination condition.

10. The offset imaging antenna system of claim 9, wherein
the first sub reflector and the first feed array are configured for transmitting at a first frequency, and
the first sub reflector and the second feed array are configured for receiving at a second frequency.

11. The offset imaging antenna system of claim 1, comprising further at least:
one second sub reflector having a paraboloid shape, a second sub reflector optical centre and a second sub reflector bore-sight axis,
one second feeding array to illuminate or to be illuminated by the second sub reflector comprising an arrangement of second feed array elements,
the main reflector, the first sub reflector, the at least one second sub reflector being offset and confocal by sharing a common focal point F,
the second feeding array having a curved shape that corresponds to a second equivalent array of a second magnified image feed elements lying on a plane crossing the main optical centre and perpendicular to the main bore-sight axis,
all the second feed array elements being positioned as to provide a second planar distribution of the positions of the second image feed elements onto the second equivalent array after a second reflection by the main reflector with a second central image point coinciding with the main reflector optical centre under a maximum illumination condition.

12. The offset imaging antenna system of claim 11, wherein
the second planar distribution of the positions of the second image feed elements onto the second equivalent array is periodic, or
the second planar distribution of the positions of the second image feed elements onto the second equivalent array is a distribution of a sparse array.

13. The offset imaging antenna system of claim 11, wherein
the second sub reflector has a second sub reflector frame centered on the common focal point with
a first second sub reflector axis z′₂ defined by the opposite of the second sub reflector bore-sight axis,
a second second sub reflector axis x′₂, contained in the plane including the second sub reflector axis passing through the second sub reflector optical centre and the common focal point, and directly perpendicular to the first second sub reflector axis z′₂,
a third second sub reflector axis y′₂ defined so as the first, second, third second sub reflector axis (x′₂,y′₂,z′₂) form a directly oriented frame, and
while keeping the confocality between the main reflector, the first sub reflector and the second sub reflector, the main frame, the first sub reflector frame, the second sub reflector frame have different orientations, and the reciprocal relative orientation of the main frame and the second sub-frame is determined so that the performance of the antenna is improved in terms of:
increasing the symmetry of the beam gain distribution while limiting an additional scan loss over a same scan range, and/or,
increasing the beam shapes stability, and/or
reducing the beam mispointing without applying phase taper on the feeding array; and/or
decrease the degree of curvature of the second feeding array,
in view of the reference configuration wherein the first, second, third main axis of the main reference frame and the first, second, third second sub reflector axis of the second sub reflector frame are respectively the same.

14. The offset imaging antenna system of claim 13, wherein
either departing from the reference configuration the second sub reflector has been tilted around the second main axis x by a fifth elevation tilt angle φᵣ₂, defined as the relative angle between the first main reflector axis z and the first second sub reflector axis z′₂, and between the second main reflector axis x and the second second sub reflector axis x′₂, so that the reciprocal relative orientation of the main frame and the second sub reflector frame is defined only by the fifth elevation tilt angle φᵣ₂; or
departing from the reference configuration, the second sub reflector has been tilted around the second main axis x by a sixth azimuth tilt angle σᵣ₂, defined as the relative angle between the first main reflector axis z and the first second sub reflector axis z′₂, and between the third main reflector axis y and the third second sub reflector axis y′₂, so that the reciprocal relative orientation of the main reflector frame and the second sub reflector frame is defined only by the sixth azimuth tilt angle σᵣ₂.

15. The offset imaging antenna system of claim 13, wherein
departing from the reference configuration, the second sub reflector has been firstly tilted around the third main axis y by a seventh elevation tilt angle φᵣ₂, defined as the relative angle between the second main reflector axis x and the second second sub reflector axis x′₂, and
successively tilted around the second main axis x by an eighth azimuth tilt angle σᵣ₂, defined as the relative angle between the third main reflector axis y and the third second sub reflector axis y′₂, so that the reciprocal relative orientation of the main reflector frame and the second sub reflector frame is defined by the seventh elevation tilt angle φᵣ₂ and the eighth azimuth tilt angle σᵣ₂.

16. The offset imaging antenna system of claim 11, wherein
the first sub reflector and the first feed array are configured for transmitting at a first frequency, and
the second sub reflector and the second feed array are configured for receiving at a second frequency.

17. A method for designing and manufacturing an offset imaging antenna system with compensated optical aberrations able to scan a beam electronically in a limited field of view or to generate a multi-beam coverage in a limited field of view, wherein the offset imaging antenna system comprises:
a main reflector having a paraboloid shape, a main aperture, a main optical centre, and a main bore-sight axis,
a first sub reflector having a paraboloid shape, a first sub reflector optical centre and a first sub reflector bore-sight axis,
a first feeding array with a conformal curved shape to illuminate or to be illuminated by the first sub reflector comprising an arrangement of first feed array elements, and
the main reflector and the first sub reflector being offset and confocal by sharing a common focal point,
the method comprising:
a first step of determining a general law for calculating conjugate points as a function of first feed array elements, and
a second step of determining the exact positions of the first feed array elements by reversing the determined function and setting as a boundary condition to have all the conjugate points lying on a plane crossing the main reflector centre.

18. The method for designing and manufacturing an offset imaging antenna system of claim 17,
comprising further a third step carried out between the first step and the second step wherein a target imaging array is defined as a planar sparse array on the aperture plane of the main reflector, and
wherein in the second step the exact positions of the first feed array elements are determined so that the conjugate points of the first feed array elements coincide with the points of the planar sparse array forming the target imaging array.

19. The method for designing and manufacturing an offset imaging antenna system of claim 17, comprising a fourth step carried out either before the first step or after the second step wherein while keeping the confocality between the main reflector and the first sub reflector, the first sub reflector bore-sight axis of the first sub reflector is tilted in respect of the main bore-sight axis of the main reflector according to a rotation that improve the performance of the antenna in terms of:
increasing the symmetry of the beam gain distribution while limiting an additional scan loss over a scan range, and/or
increasing the beam shapes stability, and/or
reducing the beam mispointing without applying phase taper on the feeding array; and/or
decreasing the degree of curvature of the first conformal feeding array,
in view of a reference confocal configuration wherein the main bore-sight axis and the first sub reflector bore-sight axis are parallel and opposite.
